(19) United States
(12) Patent Application Publication
(10) Pub. No.: US 2025/0114266 A1
(43) Pub. Date: Apr. 10, 2025

(54) WEARABLE COMPRESSIVE DEVICE FOR FLUID MOBILIZATION

(71) Applicant: CORNELL UNIVERSITY, Ithaca, NY (US)

(72) Inventors: Hsin-Liu Kao, Ithaca, NY (US); Heather Jin Hee Kim, Ithaca, NY (US); Joan Stilling, New York, NY (US); Michael O'Dell, New York, NY (US)

(21) Appl. No.: 18/629,892

(22) Filed: Apr. 8, 2024

Related U.S. Application Data
(60) Provisional application No. 63/494,927, filed on Apr. 7, 2023.
(60) Provisional application No. 63/495,276, filed on Apr. 10, 2023.

(51) Int. Cl. A61H 9/00; D04B 15/66; D04B 27/00

(52) U.S. Cl. CPC A61H 9/0092; A61H 9/0007; D04B 15/66; D04B 27/00; A61H 2201/1635; A61H 2201/165; A61H 2201/5005; A61H 2201/5007; A61H 2205/065; A61H 2205/067

(57) ABSTRACT

Wearable compression systems, which may comprise one or more or a plurality of actuator(s) embedded within a textile structure and may be configured to provide a compression function to a therapy target of an individual. Wearable compression systems may comprise a circuit or the like. Methods of operating a wearable compression system. Methods of designing (e.g., automatically designing) wearable compression systems. Methods of designing may comprise receiving a set of measurements, generating default dimensions, default number of actuators, and/or default actuator locations for a wearable compression system and/or a graphical representation of same, optionally modifying default dimensions, default number of actuators, and/or default actuator locations, updating the wearable compression system and/or graphical representation of same, and generating an instruction file. Methods of treating edema or symptoms of edema.

### CROSS REFERENCE TO RELATED APPLICATIONS

This application claims priority to U.S. Provisional Application No. 63/494,927, filed on Apr. 7, 2022, and to U.S. Provisional Application No. 63/495,276, filed on Apr. 10, 2022, the entire disclosures of which are hereby incorporated by reference.

### BACKGROUND OF THE DISCLOSURE

Electronic devices have undergone dramatic transformations over the last several decades. Form factors have been developed that use the human skin as an interface to facilitate human-computer interactions (“HCl”). Conventional on-skin interfaces are created through digital fabrication approaches including laser-cutting, lamination, and inkjet printing, or through craft techniques such as screen-printing and stenciling. The expressive and material qualities of conventional on-skin interfaces are largely limited to color and graphic customization.

Conventional on-skin interfaces may be silicone based, such as Polydimethylsiloxane (“PDMS”). However, PDMS is not breathable. PDMS covers the skin surface completely such that air and/or moisture cannot pass through, which creates discomforts to users, especially when larger on-skin interfaces are applied. In addition, thin PDMS structures, which may afford a user more comfort, are typically not re-usable and lack in the sturdiness and stability to withstand regular wear and tear for longer periods. Further, conventional on-skin interfaces may include tactile interfaces. While tactile interfaces have utilized skin as an area for haptic input, bulky form factors and complicated mechanical systems have hindered wider utilization of body locations. Moreover, complexity in mechanical design allows little compatibility across different tactile feedback, encumbering both user and designers. Conventional methods for high-resolution tactile outputs are often bulky and not body conformable. Conventional methods often require rigid devices (i.e., pumps or compressors), which may not be wearable and can constrain the use of conventional on-skin interfaces to certain body locations. Each tactile output often requires distinct actuation mechanisms, making it challenging to combine different techniques for designing richer haptic sensations. The lack of skin conformity and versatile actuation mechanism in current tactile devices limits their expressiveness.

Additionally, interactive devices in HCl have predominantly been static or fixed in one location. Mobility in conventional devices is enabled by rigid appendages such as grippers, magnetic wheels, and spikes, and accordingly are not suitable for on-skin application. Conventional mobile interface devices lack the use of pliable materials.

The emergence of digital fabrication has resulted in remarkable design and material adaptations, offering opportunities for the HCl community to create products towards customized and personalized ends. These technological advancements play an important role in facilitating the creation of textiles that are not only tailored to individual preferences and needs but also functional applications.

The current process for the development of medical devices is characterized by certain limitations. First, it focuses on the production of monolithic and inflexible devices through 3D printing technology, which restricts applications to rigid devices for orthotics or rigid contraceptives. Inflexible and clunky medical contraceptives are not well suited for treating conditions that manifest in the body parts with intricate shapes (e.g., fingers), which necessitate soft and malleable devices. Second, certain medical conditions, such as edema, exhibit varying appearances and traits depending on individuals. It can be challenging for current medical-making approaches to meet the demand for customized designs, leading to reliance on one-size-fits-all solutions. The current framework does not demonstrate the capacity to customize devices, a crucial feature for addressing medical conditions, such as acute edema, scoliosis, and Duchenne muscular dystrophy, that manifest with extensive variability across individuals. Third, current medical making lacks adaptability and clinician-led design input during the fabrication process, resulting in repetitive refinement processes at the cost of wasting both clinicians' and patients' resources and time. The cumulative effect of these limitations restricts material choices to rigid 3D-printable ones, lacks customization, and delays the delivery of medical devices.

Various disorders can cause edema to manifest with different presentations on the body. Prolonged hand edema can affect the range of motion, active movement, and everyday human functional ability. Hand edema is caused by an abnormal buildup of interstitial fluid and can occur throughout the hand. Current edema treatment or management is provided in clinical settings, often requiring manual massage by physical or occupational therapists (PT/OT) for mobilizing edematous fluid. While manual massage can be customized to individual patient needs, the cost of highly trained personnel providing labor-intensive treatment has deterred a scalable and widely applicable strategy.

Literature identifies common treatment regimens as active compression and manual edema mobilization (MEM). Active compression involves electrical components that exert forces on the body to move interstitial fluid through the lymphatic system. Intermittent pneumatic compression (IPC) is one of the most widely applied devices of this sort, in which pneumatic chambers wrap around the limb, compressing it as the chambers inflate. However, the sheer size and bulkiness of IPC devices make them difficult to treat granular parts of the body, such as fingers or hands. Moreover, the uniform form factors of IPC prevent treatment from catering to individual body shapes. Another prominent method to reduce edema is manual edema mobilization (MEM), or retrograde massage therapy, which involves therapists applying light traction on the skin along lymphatic pathways. However, MEM therapy can be difficult to perform without trained therapists.

Outside common treatment regimens, there are other ways to reduce swelling in the extremities. Fluidotherapy is one, which involves fine solid particles flying in a hot dry whirlpool to stimulate the body. Analogous to IPC, fluidotherapy requires tethered devices that take up space and are not readily available outside clinics. There are also compression garments, and Kinesiotaping, or taping, for passive compression.

Edema in the hands and feet, presents additional challenges as they are at the distal end of the lymphatic system, and have varying shapes. The current standard treatment for hand edema lacks personalized therapy, relying on labor-intensive retrograde massage or standardized pneumatic devices.

Hand edema not only varies in degrees and progressions but also encompasses diverse hand shapes. 3D-printed devices cannot effectively compress edematous hands, and clinicians' input to address variability and personalize therapy is required for hand edema. Nonetheless, the existing method of treating edema lacks personalization, leaning heavily on pre-made pneumatic compression devices.

The literature recommends various primary treatments, including elevation, active movements, retrograde massage, and compression. While effective when combined with other treatments, elevation alone yields negligible effects. Active movements play a role in enabling muscles to contract and pump out edematous fluid. However, conditions such as muscle spasticity accompanied by edema can limit hand movement. Compression, a widely used treatment, can be delivered passively or through active therapies. Passive compression employs specialized gloves with tight fabric structures to apply force to the hand. Active compression therapy for the hand differs from therapies for arms or legs, which employ intermittent pneumatic compression. Active compression therapy for hands requires tools like strings, short-stretch bandages, or kinesiotapes attached to finger digits, the palmar area, and the dorsal sides of the hand.

The literature highlights retrograde massage, namely manual edema massage (MEM), as a highly effective therapy. Therapists or patients themselves conduct massages from distal to proximal sites in the hand, promoting upstream fluid drainage. It is stressed that minimal traction should be applied to prevent the collapse of lymphatic vessels.

Cost-effective, customizable, and portable edema treatment strategies for use outside a hospital or clinic setting are needed. Also, considering the diverse nature of edema and the shortcomings of existing treatments, there is a pressing need for personalized approaches to address the wide variability in this condition.

### SUMMARY OF THE DISCLOSURE

The present disclosure provides, inter alia, wearable compression systems. In various examples, a wearable compression system comprises a textile-based, wearable on-skin interface device. In various examples, a wearable compression system comprises one or more or a plurality of actuator(s) embedded within (e.g., integrated into, or the like) a textile structure and configured to provide a compression function (e.g., sequential compression function, or the like) to a therapy target (e.g., a location on an individual). In various examples, a wearable compression system comprises a circuit or the like.

The present disclosure provides methods of operating a wearable compression system of the present disclosure. In various examples, a method comprises receiving one or more or all of a compression intensity input (e.g., for one or more actuator(s)), a compressive force duration (e.g., for one or more actuator(s)), and a sequential compression function duration (e.g., for one or more actuator(s) arranged in sequence). In various examples, a method comprises initiating a compression function (e.g., based on a compression intensity input, compressive force duration, sequential compression function duration, or the like, or any combination thereof). In various examples, initiating a compression function comprises one or more contracting motion(s) of one or more actuator(s) of a wearable compression system.

The present disclosure provides methods for designing (e.g., automatically designing) a wearable compression system. In various examples, a method comprises receiving a set of measurements, generating default dimensions, default number of actuators, and/or default actuator locations for a wearable compression system and/or a graphical representation of same, optionally modifying default dimensions, default number of actuators, and/or default actuator locations, updating the wearable compression system and/or graphical representation of same, and generating an instruction file.

The present disclosure provides methods for treating edema or symptoms of edema. In various examples, a method comprises receiving a set of measurements of the therapy target; designing, and optionally, fabricating, a wearable compression system based on the set of measurements, wherein the use of the wearable compression system temporarily, partially, or fully ameliorates the edema or the symptoms of edema.

### BRIEF DESCRIPTION OF THE FIGURES

For a fuller understanding of the nature and objects of the disclosure, reference should be made to the following detailed description taken in conjunction with the accompanying figures.

FIG. 1 is a block diagram depicting a wearable device system.

FIG. 2 is a block diagram depicting a wirelessly charged wearable device system.

FIG. 3 is a block diagram depicting a computing machine and a module.

FIGS. 4a-b display an embodiment of KnitDema, which consists of a machine-knit semi-glove and hardware (a) to compress edematous hands sequentially. The device covers the index finger (b) and uses embedded shape memory alloy (SMA) bands to mobilize edema fluid from the fingertip to the base (from 1 to 6 in c). A human-subject case study demonstrates the feasibility and potential efficacy of the device.

FIG. 5 displays an example of a finger portion of a KnitDema semi-glove. The device uses embedded shape memory alloy (SMA) bands to mobilize edema fluid from the fingertip to the base (from 1 to 6).

FIGS. 6a-c displays an embodiment of the present disclosure, FIG. 6a displays a KnitDema system in which the finger sleeve is knit with a combination of (i) tubular jacquard, (ii) shaping, and (iii) interlock structure. The tubular structure creates “channels” to incorporate SMA springs. The substrate also uses a shaping structure to conform the substrate to the rest of the fingers. FIG. 6b displays an embodiment of a KnitDema finger sleeve device worn on a hand. FIG. 6c displays an embodiment of a future implementation of a full-hand KnitDema device.

FIGS. 7a-c displays each band in all configurations uses three SMAs. As load throughput depends on the resistance of SMA, FIG. 7a is deemed the most efficient, followed by FIG. 7b and FIG. 7c.

FIG. 8 displays a setup to simulate compression parameters. Pressure applied to the mock-up finger drains the water out of the finger and into the burette.

FIG. 9 displays that the result is most effective without any intervals, meaning when SMA applies pressure incessantly.

FIG. 10 displays the influence of the duration of each SMA compression on water displacement. Three SMA bands compressed the finger prototype from 15 seconds to 165 seconds each. 105 seconds of compression mobilized 2.8% of water.

FIG. 11 displays a simulation of the impact of SMA number on water displacement. The number of SMA bands in one substrate varied from 3 to 10, as labeled in the legend. All SMA bands ran their course three times, thus resulting in different numbers of compression instances in total. For instance, 7 SMA bands would result in 21 instances in total by the end of the operation; 5 SMA bands, 15 instances. The labels denote the end of each sequence (e.g., 1st denotes the end of 1st sequence). When six SMA bands ran the full three sequences, they displaced the most fluid, more than 9% (see label 3rd of line 6).

FIG. 12 displays a user study timeline and patient assignment to compression levels. Pulse width modulations (PWM) determines the voltage's duty cycle and the compression's intensity.

FIG. 13a-c displays (a) volume measure, (b) circumference measurement, and (c) range of motion (ROM), as explained in Example 1. ROM measures the internal angle of flexion.

FIGS. 14a-c displays photographs of a participant's hand before (a), and after (b) the intervention (c). Marks from intervention indicate that the pressure is palpable and the device fits the finger snugly.

FIG. 15 displays graphical representation of changes in the finger volume before and after the intervention, labeled by participant code. Red indicates an increase, and green indicated a decrease in the volume.

FIG. 16 displays graphical representation of changes in the circumference of the DIP, PIP, and base, before and after the intervention. Red indicates an increase, and green indicates a decrease in the measurement.

FIG. 17 displays graphical representation of changes in the range of motion in degrees (°) before and after the intervention, labeled by participant code. Red indicates an increase, and green indicates a decrease in the internal angle of flexion.

FIG. 18 displays a schematic of the pattern design for embodiments disclosed herein.

FIGS. 19a-c displays an embodiment of the MediKnit which consists of (a) a design tool for creating active compression gloves and (b) a designed device with actuators that can be programmed to meet individual needs and address hand edema. An embodiment of a MediKnit device being used by a patient is shown in (c).

FIGS. 20a-c displays an embodiment of the present disclosure. Specifically, FIG. 20a an embodiment of the MediKnit system that consists of a knitted substrate, 13 shape memory actuators, and hardware. FIG. 20a(i) shows the substrate creating “channels” for actuators; the configuration shown in FIG. 20a(ii) accommodates swelling in the prominent direction, and FIG. 20a(iii) covers hand corners. FIG. 20b displays the 13 actuators are designed based on lymphatic vessels distribution. FIG. 20c displays the MediKnit device on participants with hand edema. Superimposed pictures show visible compression marks.

FIG. 21 displays an embodiment of the configuration of the present disclosure. The figure on the left is adapted with permission. Deep finger web lymph vessels (DFWLV) run from the palmer side of the hand and turn their courses to the dorsum side of the hand. These vessels run short after crossing the web spaces. Similarly, one or two of the superficial palmar arch lymph vessels (SPALV) also flip their courses as they run past the web space between the index finger and thumb. In contrast to the other vessel groups, deep palmar arch lymph vessels (DPALV) run horizontally toward the thumb, penetrating the adductor pollicis (i.e., the thick muscle attached to the palmar side of the thumb). With a̅₁̅b̅₁̅b̅ₙ̅a̅ₙ̅ and a̅₁̅c̅₁̅c̅ₙ̅a̅ₙ̅, the coverage of these lymphatic vessel groups is ensured.

FIGS. 22a-b displays embodiments and a test set up described in Example 3. FIG. 22a displays experimental setup to observe backflow displacement of fluid from the fingers to the hand. The sponges utilized exhibited uniform porosity. The image on the right shows no discernible displacement of pigment from the onset (left). FIG. 22b displays a setup to characterize compression bands in the palm. The silicone mock hand was positioned flat embedded with 12 SMA compression bands.

FIG. 23a-d displays an embodiment of the MediKnit design tool which provides: (a) visual guidance for hand measurements for customization, (b, c) generates the glove's template, and allows the therapists to adjust the glove's template and SMA channels. (d) Finally, the design interface creates a machine-readable file.

FIG. 24 displays the technician-led design workflow.

FIG. 25 displays the clinician-led design workflow.

FIG. 26 displays a visual representation of machine-readable knitting files showcasing the default design generated by the MediKnit design tool (utilized in W2, labeled in yellow) and the modified design by therapists labeled in green.

FIG. 27a-d display graphical representation of results discussed in Example 3. Specifically, (a) displays the volumetry indicated a decrease in volume after the intervention in the descriptive data. (b) 9HPT showed a notable difference in the two activities: putting 9 pegs into the holes (trial: in) and taking them out (trial: out). (c) In the figure of eight, all participants showed a descriptive decrease after the intervention. (d) In ROM, the downward shift of lines from pre to post was deemed favorable, indicating a greater range of motion.

FIG. 28 displays an embodiment of the 2D software platform discussed in Example 4.

FIG. 29 displays an embodiment of the 3D software platform discussed in Example 4.

### DETAILED DESCRIPTION OF THE DISCLOSURE

Although claimed subject matter will be described in terms of certain examples, other examples, including examples that do not provide all of the benefits and features set forth herein, are also within the scope of this disclosure. Various structural, logical, process step, and electronic changes may be made without departing from the scope of the disclosure.

As used herein, unless otherwise stated, “about,” “approximately,” “substantially,” “˜,” or the like, when used in connection with a measurable variable such as, for example, a parameter, an amount, a temporal duration, or the like, are meant to encompass variations of, for example, a specified value including, for example, those within experimental error (which can be determined by for example, a given data set, an art accepted standard, and/or with a given confidence interval (e.g. 90%, 95%, or more confidence interval from the mean), such as, for example, variations of +/−10% or less, +/−5% or less, +/−1% or less, and +/−0.1% or less of and from the specified value) or to encompass alternatives to the members of the list that would be recognized by one of ordinary skill in the art as alternatives, where the members and the alternatives may define a genus or sub-genus, insofar as such variations are appropriate to perform in the context of the disclosure. As used herein, unless otherwise stated, the terms “about,” “approximate,” “at or about,” “substantially,” and “˜” can mean that the amount or value in question can be the exact value or a value that provides equivalent results or effects as recited in the sample claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error, and the like, and other factors known to those of skill in the art such that, for example, equivalent results, effects, or the like are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” “at or about,” or “˜” is used before a quantitative value, the parameter also includes the specific quantitative value itself, unless specifically stated otherwise.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5%, but also, unless otherwise stated, include individual values (e.g., 1%, 2%, 3%, and 4%) and the sub-ranges (e.g., 0.5% to 1.1%; 0.5% to 2.4%; 0.5% to 3.2%, and 0.5% to 4.4%, and other possible sub-ranges) within the indicated range. It is also understood (as presented above) that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about, it will be understood that the particular value forms a further disclosure. For example, if the value “about 10” is disclosed, then “10” is also disclosed.

The present disclosure provides, inter alia, wearable compression systems and methods of using same. The present disclosure also provides methods for automatically designing wearable compression systems. The present disclosure also provides methods for treating edema or symptoms of edema.

In an aspect, the present disclosure provides wearable compression systems. In various examples, a wearable compression system comprises a textile-based, wearable on-skin interface device. In various examples, a wearable compression system comprises one or more or a plurality of actuator(s) embedded within (e.g., integrated into, or the like) a textile structure and configured to provide a compression function (e.g., sequential compression function, or the like) to a therapy target (e.g., a location on an individual). In various examples, a wearable compression system comprises a circuit or the like.

A textile structure can comprise various fabrics. In various examples, a fabric structure or the like (e.g., of a textile structure) comprises a knitted fabric structure, woven fabric structure, embroidered fabric structure, sewn fabric structure, silicone casted structure, polymer casted structure, or the like, or any combination thereof. In various examples a fabric (e.g., a fabric structure) comprises a plurality of fibers (e.g., in the form of yarn or thread). In various examples, fibers comprise natural material, synthetic material, or the like, or any combination thereof. In various examples, fibers comprise desirable properties (e.g., stretch or absence of stretch). In various examples, a fabric exhibits desirable properties (e.g., stretch, such as, for example, 2-way stretch, 4-way stretch, or the like, or the absence of stretch, or the like).

In various examples, a textile structure comprises a knitted structure (e.g., comprising knitted fabric). In various examples, a knitted fabric (e.g., a knitted structure comprising a knitted fabric) is fabricated by a knitting machine (e.g., from an instruction file). In various examples, a knitted structure comprises one or more tube(s), channel(s), or the like (e.g., tubular channels or the like) embedded in a textile structure. In various examples, tubular channels comprise (or are) a jacquard tubular structure. In various examples, the textile structure comprises a knitted textile structure with one or more channel(s) within the knitted structure.

In various examples, a woven structure comprises single, double, triple, or more woven open and/or closed tubes or the like.

In various examples, an embroidered structure, a sewn structure, or the like comprises integration of one or more embroidered, sewn, or the like tube(s), channel(s), or the like. In various examples, tubes are embedded into a textile structure (e.g., a fabric of a textile structure). In various examples, one or more actuator(s) are inserted into the one or more tube(s), channel(s), or the like. In various examples, one or more actuator(s) are stitched or sewn onto the textile structure.

In various examples, a silicone casted structure, a polymer casted structure, or the like comprises one or more casted tube(s), channel(s), or the like. In various examples, one or more tube(s), channel(s), or the like are embedded within the silicone casted structure, polymer-casted structure, or the like.

In various examples, a textile structure comprises channels (e.g., tubular channels, which may be, for example, tubular jacquard channels). In various examples, a tubular structure comprises one or more tubular channel(s) or the like. In various examples, a tubular structure (e.g., a tubular jacquard structure) comprises hollow pockets or the like. In various examples, the hollow pockets or the like are configured to receive and encase one or more actuator(s).

A textile structure may have desirable properties. In various examples, a textile structure provides passive compression (e.g., compression provided by the textile structure alone, such as, for example, without actuation of any actuators). In various examples, the textile structure is configured to apply a passive and/or compressive pressure to the therapy target. In various examples, the passive and/or compressive pressure based on one or more or all of fiber properties, fabric structure (e.g., knit loop length, or the like), fit of the textile structure to the therapy target, or the like, or any combination thereof. In various examples, the passive and/or compressive pressure comprises a pressure in a range of about 15.0 mmHg to 20.0 mmHg, including all 0.1 mmHg values and ranges therebetween (e.g., about 15.0 mmHG to 16.0 mmHg, about 15.0 mmHg to 17.5 mmHg, about 15.0 mmHg to 19.0 mmHg, or the like).

In various examples, components of a wearable compression system are embedded within or attached to a textile structure (e.g., embedded within or attached to one or more tubular channel(s), pockets, sleeves, or the like, of a textile structure).

A textile structure can comprise various shapes. In various examples, a shape of a textile structure corresponds to a therapy target or a portion of a therapy target of an individual.

In various examples, the textile structure is a wearable garment configured to (e.g., suitable to) partially, substantially, or completely cover, or to partially, substantially, or completely encase, a therapy target. In various examples, a textile structure is configured to partially, substantially, or completely cover, or to partially, substantially, or completely encase a portion or portions of the hand (e.g., including one or more finger(s), a palm, and/or a wrist). In various examples, a textile structure comprises a glove (e.g., with one or more or all finger coverings, a palm covering, a wrist covering, and/or the like) or the like.

In various examples, the textile structure is a wearable garment suitable to substantially cover or completely cover the therapy target. In various examples, the textile structure comprises (or is) a portion of or all of a body suit, a shirt, pants, a sleeve (such as, for example, a sleeve configured to substantially cover or completely cover a foot, an ankle, a leg, or an arm of the user), a sock (such as, for example, a sock with one or more or all toe covering(s), a sole covering, an ankle covering, or the like), or the like.

In various examples, the textile structure is a woven textile structure with one or more layers of interlaced materials. In various examples, weaving enables circuitry to be incorporated into the textile structure for electrical connections between the layers while maintaining a slim form. In various examples, weaving provides two- and/or three-dimensional structural capabilities, which may provide for integration of complex circuit typology with a broad selection of materials and diverse textures. In various examples, components of the wearable compression system are embedded within layers of the interlaced materials.

In various examples, a wearable compression system is configurable for various types of skin topographies. In various examples, a compression function is customized according to an underlying skin topography or body landmark. In various examples, a wearable compression system is designed for placement on planar body parts (e.g., back of a hand or the like), cylindrical body parts (e.g., fingers, forearm, or the like), protruded body joints (e.g., elbow, knees, knuckles, or the like), concave body locations (e.g., the purlicue, armpit, Achilles tendon arch, or the like), or the like, or any combination thereof.

A wearable compression system can be used with various therapy targets. In various examples, a therapy target comprises (e.g., or is) an appendage, limb, body part, or the like (e.g. appendage, limb, body part, or the like of an individual or user), or any portion thereof, or any combination thereof. In various examples, a therapy target is or is located on a location on an individual or user.

In various examples, a therapy target comprises (e.g., or is) a neck, a torso, one or more toe(s), foot/feet, ankle(s), leg(s), thigh(s), knee(s), calf/calves, shin(s), arm(s), elbow(s), hand(s), wrist(s), finger(s), or the like, or any portion thereof, or any combination thereof. In various examples, a therapy target comprises a hand and one or more finger(s). In various examples, a therapy target comprises a wrist, hand, and one or more finger(s).

In various examples, a therapy target comprises (e.g., or is) a portion of an individual. In various examples, an individual is a human or non-human animal. Non-limiting examples of non-human animals (which may be mammals) include cows, pigs, sheep, mice, rabbits, cats, dogs, and other agricultural animals, pets (such as, for example, dogs, cats, and the like), service animals, and the like.

In various examples, a wearable compression system comprises (or is) a garment configured to be affixed to a therapy target of a user (e.g., an individual). In various examples, a wearable compression system is affixed to a therapy target by compression, such as, for example, passive compression (e.g., without any additional fasteners, clips, buckles, ties, or the like). In various examples, a wearable compression system comprises fasteners, clips, buckles, ties, or the like, or other suitable mechanisms).

In various examples, a therapy target has or has symptoms of an edema or the like, such as, for example, swelling, fluid collection (e.g., fluid collection in one or more tissue(s) or the like), or the like, or any combination thereof. In various examples, a wearable compression system is configured to mobilize fluid (e.g., mobilize fluid within or from one or more tissue(s) (e.g., tissue(s) in a therapy target)). In various examples, fluid comprises interstitial fluid, or the like. In various examples, the mobilization is via a lymphatic system, or the like, of the user. In various examples, the mobilization of fluid reduces symptoms of edema, or the like.

In various examples, a wearable compression system (e.g., a textile structure of a wearable compression system) is configured (e.g., by shape, size, scale, proportions, and the like, and any combination thereof) to fit a therapy target. In various examples, a wearable compression system (e.g., a textile structure of a wearable compression system) is configured to fit a therapy target by a wearable compression system (e.g., a textile structure of a wearable compression system) being fabricated (e.g., bespoke or personalized fabrication) according to the dimensions (e.g., shape, size, scale, proportions, and the like, and any combination thereof) of the therapy target. In various examples, a wearable compression system has dimensions (e.g., shape, size, scale, proportions, and the like, and any combination thereof) such that it encases a therapy target to a desired conformation relative to the dimensions of the therapy target (e.g., tight-fitting, close-fitting, loose-fitting, or the like). In various examples, a desired conformation of a wearable compression system is given by calculating the dimensions of a wearable compression system from the dimensions of a therapy target (e.g., whereby one or more dimension(s) of the wearable compression system are the same or different from one or more dimension(s) of the therapy target).

A wearable compression device can comprise one or more or a plurality of actuator(s). In various examples, a wearable compression device comprises one or more actuator(s) arranged in various configurations.

Various actuators can be used. In various examples, an actuator comprises a spring, wire, rod, or the like, or any combination thereof. In various examples, an actuator is a shape memory alloy (e.g., a shape memory alloy spring, wire, rod, or the like, or any combination thereof).

In various examples, the plurality of actuators are numbered as actuator 1 through actuator n. In various examples, n is an integer value of actuators. In various examples, n is any integer value of actuators suitable to provide the compression function based on a size, a shape, a length, or the like of the location on the user.

In various examples, the plurality of actuators are configured to (e.g., enabled to) provide a compression function such that, upon actuation, the plurality of actuators impart compression to the location (e.g., body part or the like) onto which the textile structure is affixed.

In various examples, the plurality of actuators and the one or more conductor(s) disposed within and/or throughout the textile structure and applying compression conformal to the location on the user.

In various examples, the plurality of actuators and the one or more conductor(s) not being directly exposed to an inner surface and/or an outer surface of the textile structure.

In various examples, the configuration comprises a substantially cylindrical or cylindrical configuration, a substantially conical or conical configuration, a substantially ovoid or ovoid configuration, a substantially rectangular prism or rectangular prism configuration, or the like.

In various examples, the configuration substantially correlates or correlates to one or more or all portion(s) of the user, such as, for example, a hand, wrist, one or more finger(s), a palm, a foot, one or more toe(s), an ankle, a knee, a leg, a neck, a torso, an arm, or the like of the user, or any combination thereof.

In various examples, the plurality of actuators may be disposed in a configuration such as a configuration depicted in the illustrations a, b, and c below, or the like, or any combination of thereof. In various examples, the plurality of actuators or a subset thereof are disposed in a substantially parallel configuration.

In various examples, the plurality of actuators are disposed within circumferential channels in the textile structure to circumscribe the location (e.g., body part of the like) on which the textile structure is affixed (e.g., worn or the like).

In various examples, the SMA is a SMA wire with a range of compatible SMA specifications including: inner diameter about 0.3-5.0 mm, wire diameter about 0.2-0.25 mm, and transition temperature about 43° C.-45° C.

In various examples, the quantity n of the actuators varies based upon a length of the location on the user to which the wearable device is affixed.

In various examples, actuators of the plurality of actuators are numbered as actuator 1 through actuator n. In various examples, n is an integer value of actuators. In various examples, n is any integer value of actuators suitable to provide the compression function based on a size, a shape, a length, or the like of the location on the user.

A wearable compression system can comprise a circuit (e.g., a circuit in electrical communication with one or more actuator(s)) comprising various components. In various examples, a circuit comprises a computing device.

In various examples, a wearable compression system (e.g., a circuit of a wearable compression system) comprises one or more or all of one or more conductor(s), a printed circuit board (“PCB”), a microcontroller, a microprocessor, a memory, or a power supply.

In various examples, the one or more conductor(s) are operatively connected to each of the plurality of actuators.

In various examples, the computing device is configured to output instructions to each of the plurality of actuators via the one or more conductor(s) to selectively actuate a selected actuator or selected actuators.

In various examples, the power supply comprises a battery (such as, for example, a replaceable battery, a rechargeable battery, or the like), a power receiver for near field communication (“NFC”) wireless charging, a triboelectric nanogenerator, a spring wound with a gravity powered rotor, or the like, or any combination thereof.

In various examples, the one or more or all of a printed circuit board (“PCB”), a microcontroller, a microprocessor, a memory, a power supply, or the like are enclosed in a case such as, for example, a hard case, a hard snap-fit case (e.g., a 3D printed hard snap-fit case or the like). In various examples, the case may be designed on CAD software or the like.

In various examples, the receiving steps, and initiating are carried out by a computing device (such as, for example, a processor or the like) of a textile structure.

In various examples, the wearable on-skin interface device comprises embedded and/or attached circuitry and components including one or more of power source(s), memor(ies), microprocessor(s), actuator(s), or the like. In various examples, the wearable on-skin interface device does not comprise a battery and is configured for wireless charging (such as, for example, by near field communication (“NFC”) capabilities or the like). In various examples, the components are interconnected by one or more conductor(s) to create a circuit.

In various examples, the microprocessor is configured to receive inputs and to use the inputs to initiate a response function from the actuators in a health care related application.

A wearable compression system can be configured to provide a compression function. In various examples, a compression function provides a compressive force to at least a portion of a therapy target.

In various examples, the compression function imparting compression to the location in addition to the textile structure passive and/or compressive pressure.

In various examples, the compression function comprising a pressure of at least about 5 mmHg, at least about 10 mmHg, at least about 15 mmHg, at least about 20 mmHg, at least about 25 mmHg, at least about 30 mmHg, at least about 35 mmHg or more, or the like.

In various examples, the compression function generates a compressive force through the initiation of the contracting motion of the plurality of actuators. In various examples, the compression function is a sequential compression function with the contracting motion beginning with actuator 1 and proceeding continuously from actuator 1 through actuator n. In various examples, the sequential compression function may involve a subset of the plurality of actuators, such as, for example, a subset comprising a portion of even numbered actuators, a subset comprising a portion of odd numbered actuators, a subset comprising at least 2 adjacent actuators, a subset comprising at least 3 adjacent actuators, a subset comprising at least 4 adjacent actuators, etc. continuing until at least n−1 adjacent actuators, or the like, or any combination thereof. In various examples, the subset may comprise one or more or all of the plurality of actuators.

In various examples, the compressive force comprises one or more or all of a radial force, a tangential force, a normal force, or the like.

In various examples, the compression function generates movement of the fluid (e.g., the fluid of the user, or the like) from the distal position towards the proximal position based on the contracting motions of the plurality of actuators (such as, for example, based on the contracting motions of actuator 1 through actuator n, or the like).

In various examples, the compression function is initiated via the circuit of the wearable system.

In various examples, initiating the compression function comprises transmitting, by the computing device one or more signal(s) (e.g., instructions or the like) to the plurality of actuators.

In various examples, the compression intensity input and the compressive force duration input are controlled by adjusting one or more or all of a pulse width modulation (“PWM”) duration, a PWM duty cycle, or the like via a microcontroller, printed circuit board, or the like (e.g., an Arduino or the like) and associated software (e.g., Arduino Integrated Development Environment (“IDE”) or the like) used to control the PWM duration, PWM duty cycle, or the like using a serial input from 0 to 255.

In various examples, the compression function generates a compressive force through the initiation of the contracting motion of the plurality of actuators. In various examples, the compression function is a sequential compression function with the contracting motion beginning with actuator 1 and proceeding continuously from actuator 1 through actuator n. In various examples, the sequential compression function may involve a subset of the plurality of actuators, such as, for example, a subset comprising a portion of even numbered actuators, a subset comprising a portion of odd numbered actuators, a subset comprising at least 2 adjacent actuators, a subset comprising at least 3 adjacent actuators, a subset comprising at least 4 adjacent actuators, etc. continuing until at least n−1 adjacent actuators, or any combination thereof. In various examples, the subset may comprise one or more or all of the plurality of actuators.

In various examples, the compressive force comprises one or more or all of a radial force, a tangential force, a normal force, or the like.

In an aspect, the present disclosure provides methods (e.g., methods of operating a wearable compression system). In various examples, a method comprises receiving one or more or all of a compression intensity input (e.g., for one or more actuator(s)), a compressive force duration (e.g., for one or more actuator(s)), and a sequential compression function duration (e.g., for one or more actuator(s) arranged in sequence). In various examples, a method comprises initiating a compression function (e.g., based on a compression intensity input, compressive force duration, sequential compression function duration, or the like, or any combination thereof). In various examples, initiating a compression function comprises one or more contracting motion(s) of one or more actuator(s) of a wearable compression system.

In an aspect, the present disclosure provides methods for designing (e.g., automatically designing) a wearable compression system. In various examples, a method comprises receiving a set of measurements (e.g., measurements corresponding to dimensions, such as, for example, shape, size, scale, proportions, and the like, and any combination thereof) of a therapy target. In various examples, default dimensions, default number of actuators, and/or default actuator locations (e.g., for a wearable compression system or a graphical representation of a wearable compression system) are generated (e.g., generated and displayed in a display interface). In various examples, a method optionally comprises modifying default dimensions, default number of actuators, and/or default actuator locations. In various examples, a method comprises generating an instruction file (e.g., for fabrication of a wearable compression system). In various examples, an instruction file is based on the default or modified dimensions, default or modified number of actuators, and/or default or modified actuator locations.

In various examples, a method comprises displaying a design interface on a display. In various examples, a design interface comprises a graphical representation of a wearable compression system. In various examples a graphical representation further comprises one or more actuator(s) (e.g., a graphical representation of one or more actuator(s) in, for example, an overlay).

In various examples, default dimensions of a wearable compression system (or graphical representation of same), default number and locations of actuators in a wearable compression system (or graphical representation), or the like, or any combination thereof, are pre-determined according to set parameters (e.g., by a program, algorithm, formula, or calculation). In various examples, default dimensions of a wearable compression system (or graphical representation of same), default number and locations of actuators in a wearable compression system (or graphical representation), or the like, or any combination thereof, are determined by factors including, for example, a severity, location, cause, etiology, physiology (e.g., drainage physiology) of an edema or symptoms of an edema.

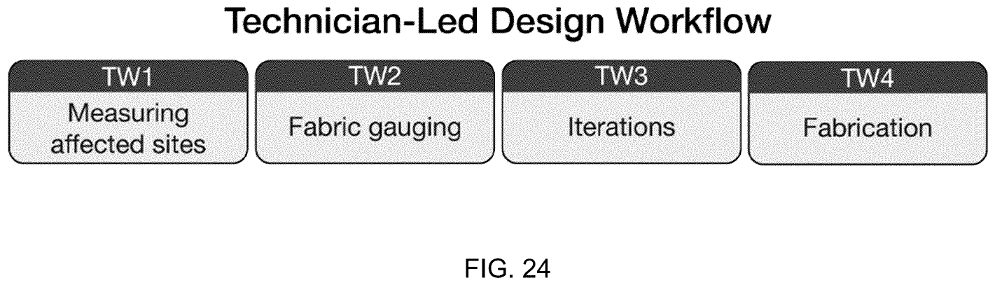

In various examples, a method is at least partially carried out by a technician (e.g., a garment fabrication technician, such as, for example, a knitting technician). In various examples, a technician modifies one or more default dimension(s) of a wearable compression system, or modifies a default number and/or one or more default actuator location(s) for a wearable compression system. In various examples, a method performed by a technician comprises various steps, such as, for example, steps shown in FIG. 24. In various examples, a technician modifies one or more default dimension(s) of a wearable compression system, or modifies a default number and/or one or more default actuator location(s) for a wearable compression system based on various parameters. Non-limiting examples of such parameters include fabric gauging (e.g., gauging and swatching), iterative fabrication and adjustments (e.g., generating fabric according to a predetermined gauge and adjusting an expected gauge (e.g., of a desired yarn or fiber and/or fabrication technique) based on any deviations from expected values), tailoring techniques, fit techniques, and the like, and any combination thereof.

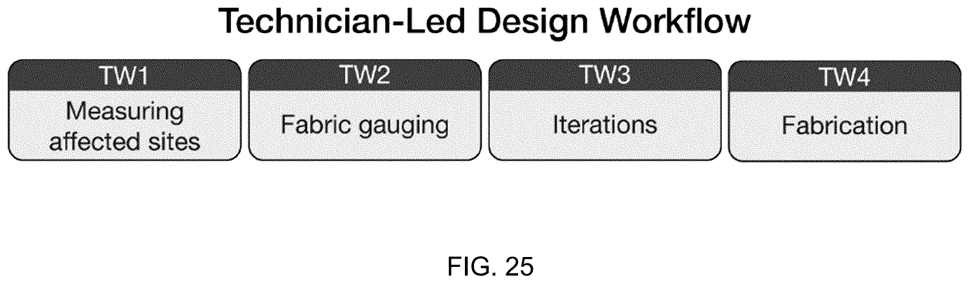

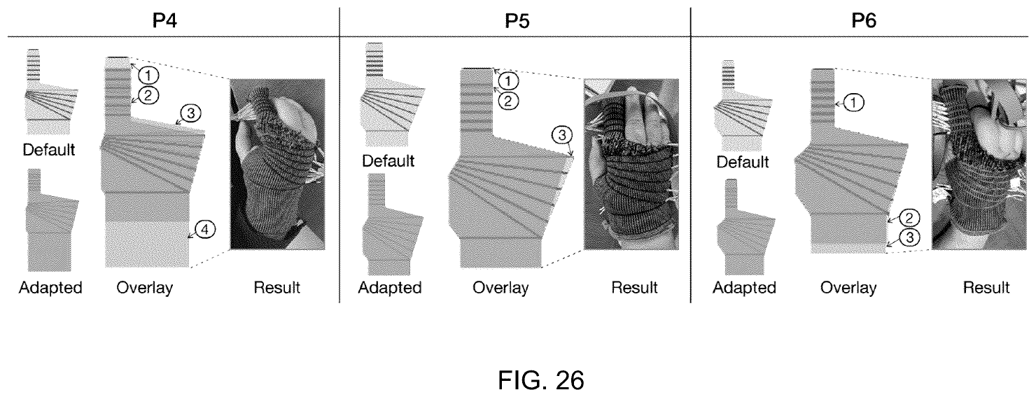

In various examples, a method is at least partially carried out by a clinician (e.g., a medical clinician, such as, for example, a physician, a physiotherapist, a physical therapist, a nurse, a nurse practitioner, a physician's assistant, a medical resident, a medical student, a clinical researcher, a clinical scientist, a massage therapist, an occupational therapist, or any other suitable clinician, or the like). In various examples, a clinician modifies one or more default dimension(s) of a wearable compression system, or modifies a default number and/or one or more default actuator location(s) for a wearable compression system. In various examples, a method performed by a clinician comprises various steps, such as, for example, steps shown in FIG. 25. In various examples, a clinician modifies one or more default dimension(s) of a wearable compression system, or modifies a default number and/or one or more default actuator location(s) for a wearable compression system based on various parameters. Non-limiting examples of such parameters include a fit test of a fabricated physical textile structure without actuators, position of joints, position, location, severity, and cause of edema or symptoms of edema, user feedback, user comfort, any clinical concerns (e.g., concerns regarding potential damage or discomfort from a compression function of a wearable compression system or the like), or the like, or any combination thereof.

In various examples, a technician, clinician, or other entity carrying out a method, modifies one or more default dimension(s) of a wearable compression system, or modifies a default number and/or one or more default actuator location(s) for a wearable compression system based on various parameters (e.g., various parameters disclosed herein or the like). Non-limiting examples of additional parameters include irregular distribution of actuators, dense distribution of actuators in areas corresponding to fleshy parts of a therapy target, sparse distribution or absence of actuators in areas corresponding to joints, bones, or ligaments of a therapy target, overlapping compression duration between actuators, increments in duration of compression in a cycle of compression (e.g., sequential compression).

In an aspect, the present disclosure provides methods for treating edema or symptoms of edema. In various examples, a method comprises receiving a set of measurements of the therapy target; designing, and optionally, fabricating, a wearable compression system based on the set of measurements, wherein the use of the wearable compression system temporarily, partially, or fully ameliorates the edema or the symptoms of edema.

In various examples, designing further comprises: displaying a design interface on a display, the design interface comprising a graphical representation of a wearable compression system for the therapy target having an overlay of a default number of one or more actuator(s), each actuator having a default location, wherein the wearable compression system and/or the graphical representation of the wearable compression system have/has default dimensions, and wherein the default dimensions of the wearable compression system and/or the default dimensions of the graphical representation of the wearable compression system, the default number of one or more actuator(s), and the default location of each actuator are based on the set of measurements; optionally, receiving one or more modified dimension(s) of the wearable compression system, a modified number of actuator(s), one or more modified location(s) of the one or more actuator(s), or any combination thereof; updating the graphical representation according to, if present, one or more or all of the modified dimension(s) of the wearable compression system, the modified number of actuator(s), and the modified location(s) of the actuator(s); and generating an instruction file for automated fabrication of the wearable compression system based on the graphical representation or the updated graphical representation.

These and other aspects, objects, features, and advantages of the disclosed technology will become apparent to those having ordinary skill in the art upon consideration of the following detailed description of illustrated examples.

### Example System Architecture

Turning now to the drawings, in which like numerals indicate like (but not necessarily identical) elements throughout the figures, examples of the technology are described in detail.

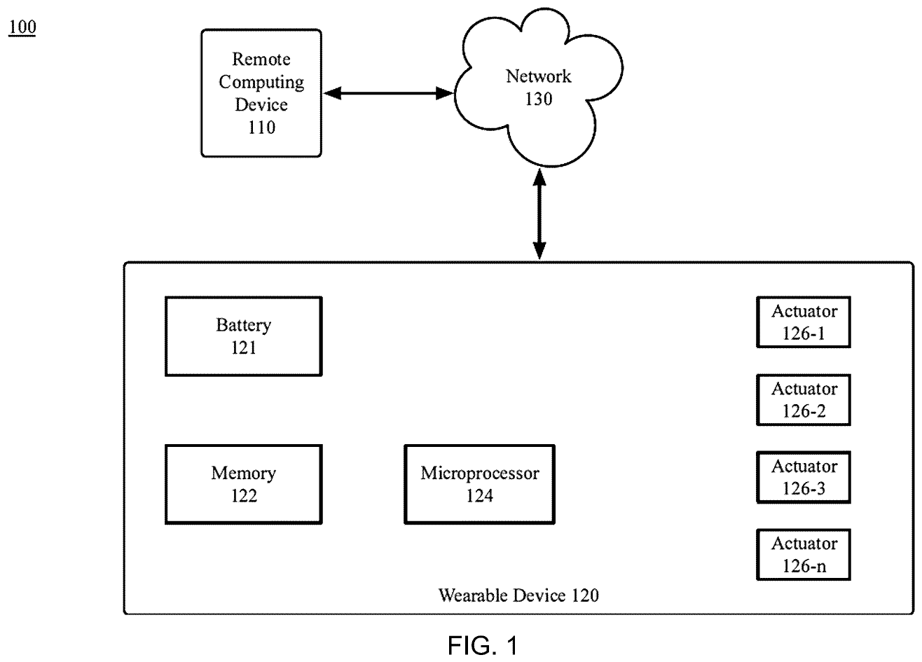

FIG. 1 is a block diagram depicting a wearable device system 100, in accordance with certain examples. As depicted in FIG. 1, the wearable device system 100 comprises a remote computing device 110 and a wearable device 120. Remote computing device 110 and wearable device 120 are configured to communicate via a network 130.

In example embodiments, network 130 includes one or more wired or wireless telecommunications systems by which network devices may exchange data. For example, the network 130 may include one or more of a local area network (LAN), a wide area network (WAN), an intranet, an Internet, a storage area network (SAN), a personal area network (PAN), a metropolitan area network (MAN), a wireless local area network (WLAN), a virtual private network (VPN), a cellular or other mobile communication network, a BLUETOOTH® wireless technology connection, a near field communication (NFC) connection, any combination thereof, and any other appropriate architecture or system that facilitates the communication of signals, data, and/or messages.

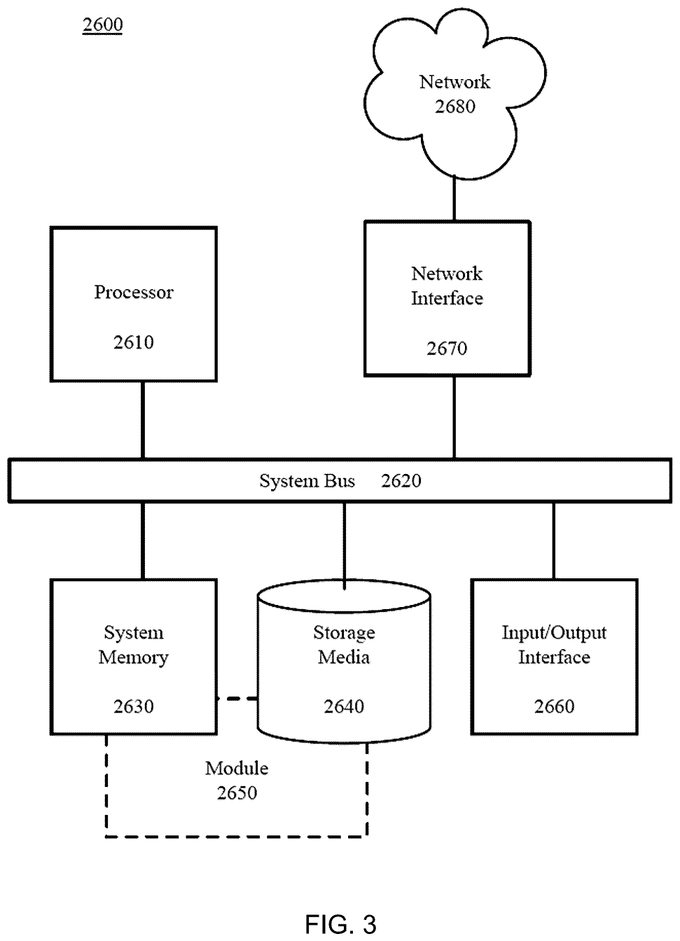

Remote computing device 110 may be any type of computing machine, such as, but not limited to, those discussed in more detail with respect to FIG. 3. For example, remote computing device 110 can include any suitable processor-driven device.

Wearable device 120 comprises a battery 121, a memory 122, a microprocessor 124, and actuators 126. In various examples, battery 121, memory 122, microprocessor 124, and actuators 126 are interconnected by one or more conductor(s) within and/or connected to wearable device 120 such that a circuit is formed. In various examples, wearable device 120 is a textile structure comprising components that function to provide a response in accordance with one or more input(s) to wearable device system 100. In an example, wearable device 120 is configured as a wearable garment or any wearable textile.

In an example, the textile structure is a knitted textile structure with one or more channel(s) within the knitted structure. In various examples, battery 121, memory 122, microprocessor 124, and actuators 126 of wearable device 120 may be embedded within the channels of the knitted structure or otherwise affixed to wearable device 120. In various examples, the knitted textile structure comprises knit free-form integrated channels through tubular jacquard. Tubular jacquard is a jacquard technique where a composition is knitted in a double system alternating between the front and back bed. If one material is stitched on a technical front, the other material knits on a technical back. The alternation of stitches creates tubular pockets between the two layers, which can be manipulated depth-wise (z-axis) and width length-wise (x- and y-axes) to construct a variety of channels. In various examples, the tubular spaces are not limited in shape, and therefore can serve as a pocket or channel and accommodate materials of different sizes. Variations of the technique may be used to create channels and junctions where different materials cross paths.

In various examples, wearable device 120 is configured as wearable garment that slides onto the user such that the wearable device is affixed to the user by compression. Wearable device 120 may comprise fasteners, clips, or any other suitable mechanism to affix wearable device 120 to the user. Wearable device 120 may be a garment or other article that is wearable by a user. For example, wearable device 120 is a shirt, pants, glove, sock, or any other suitable garment or article wearable by a user.

In various examples, wearable device 120 comprises battery 121. Battery 121 functions to provide power to the components of wearable device 120. While FIG. 1 depicts a single battery 121, wearable device 120 may comprise one or more batteries 121 to provide power to the components of wearable device 120. In various examples, battery 121 has a small form factor battery such that battery 121 can be embedded within the one or more channel(s) of wearable device 120. In an example, battery 121 provides power to the components of wearable device 120 via one or more conductor(s) embedded within or attached to wearable device 120, not depicted in FIG. 1. In an example, battery 121 is a lithium polymer battery. In an example, wearable device 120 is configured such that battery 121 may be replaced. In an example, battery 121 is a rechargeable battery. Battery 121 may be charged by a connection to a charging station or battery 121 may be wirelessly charged. Battery 121 may be any battery suitable to provide power to the components of wearable device 120. In an alternate example, wearable device 120 may comprise a triboelectric nanogenerator to provide power to the components of wearable device 120.

Wearable device 120 comprises memory 122. Memory 122 functions to store data associated with inputs to wearable device system 100. In an example, memory 122 has a small form factor such that memory 122 may be embedded within or attached to the one or more channel(s) of wearable device 120. In an example, memory 122 may be stacked on top of battery 121. In an example, memory 122 may be a removable memory such as a Secure Digital (“SD”) card. Memory 122 may be any suitable memory capable of storing data associated with inputs to wearable device system 100.

Wearable device 120 comprises microprocessor 124. In various examples, microprocessor 124 is configured to monitor and control the operation of the components in the wearable device 120. Microprocessor 124 may be a general purpose processor, a processor core, a multiprocessor, a reconfigurable processor, a microcontroller, a printed circuit board (“PCB”), a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. Microprocessor 124 may be a single processing unit, multiple processing units, a single processing core, multiple processing cores, special purpose processing cores, co-processors, or any combination thereof. Microprocessor 124 may be powered by battery 121.

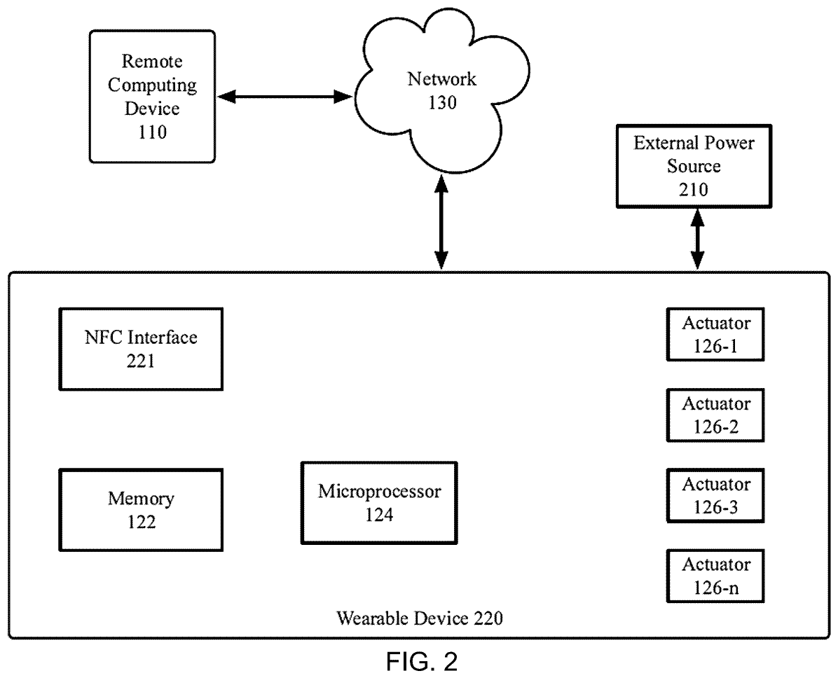

In an example, microprocessor 124 has a small form factor such that microprocessor 124 may be embedded within or attached to the one or more channel(s) of wearable device 120. In an example, microprocessor 124 comprises one or more serial peripheral interfaces (“SPI”) for communications with NFC interface 221 (discussed herein with reference to FIG. 2) and memory 122. In an example, microprocessor 124 is configured to communicate with external computing systems or other computing devices by a radio frequency identification (“RFID”) signal, for example, remote computing device 110. In an example, microprocessor 124 is configured to communicate with external computing systems or other computing devices via Bluetooth, for example, remote computing device 110.

In various examples, microprocessor 124 is configured to receive inputs to wearable device system 100 for processing. In an example, microprocessor 124 receives inputs to wearable device system 100 and uses the inputs to initiate a response function from actuators 126. For example, microprocessor 124 transmits a signal to one or more actuator(s) 126 to initiate the response function.

Wearable device 120 comprises actuators 126-1 through 126-n. Actuators 126 may also be referred to as functional devices. In various examples, actuators 126 are components of wearable device 120 configured to provide a response function based on one or more signals from microprocessor 124. Wearable device 120 may comprise a single actuator 126 or a plurality of actuators 126. In an example, each actuator 126 has a small form factor such that actuators 126 may be embedded within or attached to the one or more channel(s) of wearable device 120. As used herein, an actuator comprises a device configured to change from a first state to a second state responsive to a first input. In some aspects, the actuator is further configured to change from the second state back to the first state responsive to a second input, which could be the same input as the first input or a different input than the first input. In some aspects, the actuator is configured to change from a first state to a particular one of a plurality of available states responsive to an input corresponding to that particular one of a plurality of available states. In some examples, the actuator is configured to cycle between a first state and a second state responsive to one or more inputs. In some examples, the actuator is biased toward a first state so that, following actuation of the actuator to change state from the first state to the second state, the actuator will automatically return to the first state under action of the bias. In some examples, actuators 126, in accord with at least some aspects of the present concepts, includes one or more of a haptic feedback component, a shape-memory alloy (“SMA”) device, a spring, a wire, a rod, or any other suitable functional device. In various examples, the response function of actuators 126 comprises one or more of a force (e.g., a compressive force, a radial force, a tangential force, a normal force, or the like), a motion, a shrinking movement, a deformation movement, or any other suitable response function. For example, the haptic feedback component is a SMA actuator configured to apply a force, or a motion (e.g., a contracting motion or the like). The SMA device may comprise SMA micro-springs configured to apply a compressive force.

In various examples, when current flows through SMA micro-springs, the SMA micro-springs contract and become shorter, shifting the channels in which the SMA micro-springs are embedded. In various examples, when wearable device 120 is affixed to a location on a user, the corresponding skin regions experience a compressive force. The actuation of the SMA micro-springs can deform the interface between the wearable device 120 and the corresponding skin regions of the user resulting in circumferential or lateral contraction of the interface. Circumferential contraction results in a compressive force being applied to the location on the user.

In various examples, the one or more channel(s) of wearable device 120, such as knitted channels, afford high degrees of freedom for integrating active materials such as actuators 126. In various examples, channels can be constructed in linear lines, free-form curves, or closed curves. Multiple channels may intersect or traverse the structure independently. By having the channels constructed within the wearable device 120 or 220 textile structure, the force generated by the SMA micro-spring is transmitted to the shape of channels, displacing the channels in tandem with SMA micro-spring movement.

FIG. 2 is a block diagram depicting a wirelessly charged wearable device system 200, in accordance with certain examples. As depicted in FIG. 2, the wearable device system 200 comprises a remote computing device 110, an external power source 210, and a wearable device 220. Remote computing device 110 and wearable device 220 are configured to communicate via a network 130. Remote computing device 110 and network 130 were previously described herein with reference to FIG. 1.

Wirelessly charged wearable device system 200 comprises external power source 210. External power source 210 comprises an NFC transceiver such that external power source 210 may transmit power via RFID transmissions or other suitable transmission means to an NFC enabled device, such as wearable device 220.

Wearable device 220 comprises an NFC interface 221, a memory 122, a microprocessor or microcontroller 124, and actuators 126. Memory 122, microprocessor 124, and actuators 126 were previously described herein with reference to FIG. 1. Wearable device 220 has the same functionality as wearable device 120, previously described herein with reference to FIG. 1, with the exception that wearable device 220 has an NFC interface 221 to enable wireless charging capabilities. In an example, NFC interface 221 is an NFC coil embedded within the textile structure. NFC interface 221 enables wireless charging capabilities by functioning as an NFC transponder and receiving power from external power source 210. In an example, external power source 210 is a smart watch or similar electronic device coupled with or comprising an NFC transceiver to enable wireless charging for wearable device 220. With wireless charging capabilities, wearable device 220 is capable of long-term continuous wear without battery replacement or a physical connection to a battery charging station.

### Other Examples

FIG. 3 depicts a computing machine 2600 and a module 2650 in accordance with certain examples. The computing machine 2600 may correspond to any of the various computers, servers, mobile devices, embedded systems, or computing systems presented herein. The module 2650 may comprise one or more hardware or software elements configured to facilitate the computing machine 2600 in performing the various methods and processing functions presented herein. The computing machine 2600 may include various internal or attached components such as a processor 2610, system bus 2620, system memory 2630, storage media 2640, input/output interface 2660, and a network interface 2670 for communicating with a network 2680.

The computing machine 2600 may be implemented as a conventional computer system, an embedded controller, a laptop, a server, a mobile device, a smartphone, a set-top box, a kiosk, a router or other network node, a vehicular information system, one or more processors associated with a television, a customized machine, any other hardware platform, or any combination or multiplicity thereof. The computing machine 2600 may be a distributed system configured to function using multiple computing machines interconnected via a data network or bus system.

The processor 2610 may be configured to execute code or instructions to perform the operations and functionality described herein, manage request flow and address mappings, and to perform calculations and generate commands. The processor 2610 may be configured to monitor and control the operation of the components in the computing machine 2600. The processor 2610 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2610 may be a single processing unit, multiple processing units, a single processing core, multiple processing cores, special purpose processing cores, co-processors, or any combination thereof. The processor 2610 along with other components of the computing machine 2600 may be a virtualized computing machine executing within one or more other computing machines.

The system memory 2630 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2630 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2630. The system memory 2630 may be implemented using a single memory module or multiple memory modules. While the system memory 2630 is depicted as being part of the computing machine 2600, one skilled in the art will recognize that the system memory 2630 may be separate from the computing machine 2600 without departing from the scope of the subject technology. It should also be appreciated that the system memory 2630 may include, or operate in conjunction with, a non-volatile storage device such as the storage media 2640.

The storage media 2640 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2640 may store one or more operating systems, application programs and program modules such as module 2650, data, or any other information. The storage media 2640 may be part of, or connected to, the computing machine 2600. The storage media 2640 may also be part of one or more other computing machines that are in communication with the computing machine 2600 such as servers, database servers, cloud storage, network attached storage, and so forth.

The module 2650 may comprise one or more hardware or software elements configured to facilitate the computing machine 2600 with performing the various methods and processing functions presented herein. The module 2650 may include one or more sequences of instructions stored as software or firmware in association with the system memory 2630, the storage media 2640, or both. The storage media 2640 may therefore represent machine or computer readable media on which instructions or code may be stored for execution by the processor 2610. Machine or computer readable media may generally refer to any medium or media used to provide instructions to the processor 2610. Such machine or computer readable media associated with the module 2650 may comprise a computer software product. It should be appreciated that a computer software product comprising the module 2650 may also be associated with one or more processes or methods for delivering the module 2650 to the computing machine 2600 via the network 2680, any signal-bearing medium, or any other communication or delivery technology. The module 2650 may also comprise hardware circuits or information for configuring hardware circuits such as microcode or configuration information for an FPGA or other PLD.

The input/output (“I/O”) interface 2660 may be configured to couple to one or more external devices, to receive data from the one or more external devices, and to send data to the one or more external devices. Such external devices along with the various internal devices may also be known as peripheral devices. The I/O interface 2660 or any peripheral device may comprise (or be) a serial peripheral interface (“SPI”), an I²C protocol, or the like. The I/O interface 2660 may include both electrical and physical connections for operably coupling the various peripheral devices to the computing machine 2600 or the processor 2610. The I/O interface 2660 may be configured to communicate data, addresses, and control signals between the peripheral devices, the computing machine 2600, or the processor 2610. The I/O interface 2660 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2660 may be configured to implement only one interface or bus technology. Alternatively, the I/O interface 2660 may be configured to implement multiple interfaces or bus technologies. The I/O interface 2660 may be configured as part of, all of, or to operate in conjunction with, the system bus 2620. The I/O interface 2660 may include one or more buffers for buffering transmissions between one or more external devices, internal devices, the computing machine 2600, or the processor 2610.

The I/O interface 2660 may couple the computing machine 2600 to various input devices including mice, touch-screens, scanners, electronic digitizers, sensors, receivers, touchpads, trackballs, cameras, microphones, keyboards, any other pointing devices, or any combinations thereof. The I/O interface 2660 may couple the computing machine 2600 to various output devices including video displays, speakers, printers, projectors, tactile feedback devices, automation control, robotic components, actuators, motors, fans, solenoids, valves, pumps, transmitters, signal emitters, lights, and so forth.

The computing machine 2600 may operate in a networked environment using logical connections through the network interface 2670 to one or more other systems or computing machines across the network 2680. The network 2680 may include WANs, LANs, intranets, the Internet, wireless access networks, wired networks, mobile networks, telephone networks, optical networks, or combinations thereof. The network 2680 may be packet switched, circuit switched, of any topology, and may use any communication protocol. Communication links within the network 2680 may involve various digital or an analog communication media such as fiber optic cables, free-space optics, waveguides, electrical conductors, wireless links, antennas, radio-frequency communications, and so forth.

The processor 2610 may be connected to the other elements of the computing machine 2600 or the various peripherals discussed herein through the system bus 2620. It should be appreciated that the system bus 2620 may be within the processor 2610, outside the processor 2610, or both. Any of the processor 2610, the other elements of the computing machine 2600, or the various peripherals discussed herein may be integrated into a single device such as a system on chip (“SOC”), system on package (“SOP”), or ASIC device.

Examples may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing examples in computer programming, and the examples should not be construed as limited to any one set of computer program instructions. Further, a skilled programmer would be able to write such a computer program to implement an example of the disclosed examples based on the appended flow charts and associated description in the application text. Therefore, disclosure of a particular set of program code instructions is not considered necessary for an adequate understanding of how to make and use examples. Further, those skilled in the art will appreciate that one or more aspects of examples described herein may be performed by hardware, software, or a combination thereof, as may be embodied in one or more computing systems. Moreover, any reference to an act being performed by a computer should not be construed as being performed by a single computer as more than one computer may perform the act.

The examples described herein can be used with computer hardware and software that perform the methods and processing functions described herein. The systems, methods, and procedures described herein can be embodied in a programmable computer, computer-executable software, or digital circuitry. The software can be stored on computer-readable media. Computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The systems, methods, and acts described in the examples presented previously are illustrative, and, alternatively, certain acts can be performed in a different order, in parallel with one another, omitted entirely, and/or combined between different examples, and/or certain additional acts can be performed, without departing from the scope and spirit of various examples. Accordingly, such alternative examples are included in the scope of the following claims, which are to be accorded the broadest interpretation so as to encompass such alternate examples.

Although specific examples have been described above in detail, the description is merely for purposes of illustration. It should be appreciated, therefore, that many aspects described above are not intended as essential elements unless explicitly stated otherwise. Modifications of, and equivalent components or acts corresponding to, the disclosed aspects of the examples, in addition to those described above, can be made by a person of ordinary skill in the art, having the benefit of the present disclosure, without departing from the spirit and scope of examples defined in the following claims, the scope of which is to be accorded the broadest interpretation so as to encompass such modifications and equivalent structures.

The following Statements describe various examples of wearable devices and methods of making and using same that are not intended to be limiting in any manner.

Statement 1. A wearable system, comprising:
a textile structure configured to be affixed to a location on a user, the textile structure comprising:
a plurality of actuator devices embedded within (e.g., integrated into, or the like) the textile structure and enabled to provide a compression function (e.g., sequential compression function, or the like), and
one or more conductor(s) disposed (e.g., embedded, integrated, or the like) within the textile structure connecting the plurality of actuator devices; and
a circuit configured to receive an input from a computing device and to output signals to the plurality of actuator devices to initiate the compression function.

Statement 2. A wearable system according to Statement 1, the compression function comprising each actuator device of the plurality of actuator devices initiating a contracting motion or the like.

Statement 3. A wearable system according to Statement 2, the compressive force applied by each actuator device being applied for a programmed duration of time and/or at a programmed compression intensity.

Statement 4. A wearable system according to any of Statements 1-3, the wearable system disposed (e.g., positioned, or the like) on the user with actuator device 1 positioned at a distal position and/or actuator device n positioned at a proximal position relative to the location on the user.

Statement 5. A wearable system according to Statement 4, the compression function generating movement of a fluid.

Statement 6. A wearable system according to any of Statements 2-5, the compression function comprising repeating the contracting motions from actuator device 1 through actuator device n for a programmed period of time.

Statement 7. A wearable system according to any of Statements 1-6, the computing device configured to perform one or more or all of the following:
receive one or more input(s) (e.g., one or more input(s) to define the compression function or the like);
provide power to the wearable system;
connect to one or more external device(s) by a wired and/or wireless connection;
or any combination thereof.

Statement 8. A wearable system according to any of Statements 1-7, the computing device configured to perform one or more or all of the following:
receive one or more or all of:
a compression intensity input for the plurality of actuator devices,
a compressive force duration input for the plurality of actuator devices, and/or
a sequential compression function duration input; and
based on one or more or all of the compression intensity input, the compressive force duration input, and/or the sequential compression function duration input, initiate the compression function.

Statement 9. A wearable system according to Statement 8, the computing device controlling the compression intensity input and the compressive force duration input by adjusting one or more or all of a pulse width modulation (“PWM”) duration, a PWM duty cycle, or the like.

Statement 10. A wearable system according to any of Statements 1-9, the computing device comprising one or more or all of a printed circuit board (“PCB”), a microcontroller, a microprocessor, a memory, a power supply, or the like.

Statement 11. A wearable system according to any of Statements 1-10, wherein one or more portion(s) of the textile structure comprises a configuration with the plurality of actuator devices spaced (such as, for example, substantially equally, equally spaced, or the like) along one or more ax(es) (such as, for example, a longitudinal axis or the like) and/or spaced about one or more plane(s) of the configuration.

Statement 12. A wearable system according to Statement 11, the one or more portion(s) of the textile structure comprising the configuration affixed to the location on the user with the plurality of actuator devices positioned about a circumference of the location and configured to provide the compression function by exerting forces in one or more or all of radial, tangential, normal, or the like directions relative to the location on the user.

Statement 13. A wearable system according to any of Statements 1-12, the plurality of actuator devices comprising one or more or all of springs, wires, rods, or the like.

Statement 14. A wearable system according to any of Statements 1-13, the plurality of actuator devices comprising one or more shape memory alloy(s) (“SMA”) or the like, or any combination thereof.

Statement 15. A wearable system according to Statement 14, the one or more shape memory alloy(s) comprising one or more or all of a SMA spring(s), a SMA wire(s), a SMA rod(s), or the like.

Statement 16. A wearable system according to any of Statements 1-15, the plurality of actuator devices comprising one or more or all of nickel-titanium (“NiTi”) yarn(s), Kevlar yarn(s) coupled to a direct current (“DC”) motor, fluidic fiber actuator(s) (e.g., pneumatic artificial muscle(s) (Mckibben actuator(s)), inverse pneumatic artificial muscle(s) (“IPAM”), hydro-muscle actuator(s), or the like), liquid crystal elastomer(s), aligned amorphous polymer(s) (e.g., polymer product(s), fishing line, nylon thread, or the like), conductive polymer(s), dielectric elastomer(s), carbon nanotube fiber(s), or the like.

Statement 17. A wearable system according to any of Statements 1-16, the textile structure comprising a knitted structure, a woven structure, an embroidered structure, a sewn structure, a silicone casted structure, a polymer casted structure, or the like.

Statement 18. A wearable system according to Statement 17, the knitted structure comprising a tubular jacquard structure or the like.

Statement 19. A wearable system according to any of Statements 1-18, the textile structure configured to exert a passive and/or compressive force on the location on the user.

Statement 20. A wearable system according to any of Statements 1-19, the location comprising one or more or all of a portion(s) of a hand and/or wrist of the user.

Statement 21. A wearable system according to Statement 20, the textile structure comprising a full-hand structure to cover the hand of a user (e.g., a glove or the like).

Statement 22. A wearable system according to any of Statements 1-21, the location comprising one or more or all of a portion(s) of a foot, one or more toe(s), an ankle, a leg, a neck, a torso, or an arm of the user, or any combination thereof.

Statement 23. A wearable system according to any of Statements 1-22, the textile structure conformable to the location on the user.

Statement 24. A wearable system according to any of Statements 1-22, wherein n is 1-10000 actuator devices, including all integer values and ranges therebetween (e.g., 1, 2, 3, 4, 5, 6, 7, 8, 9, 10, 11, 12, 13, 14, 15, 16, 17, 18, 19, 20, 21, 22, 23, 24, 25, 1-50, 1-100, 1-250, 1-500, 1-1000, 1-2500, 1-5000, or 1-7500).

Statement 25. A method, comprising:
receiving one or more or all of:
a compression intensity input for a plurality of actuator devices, the plurality of actuator devices (e.g., a wearable system of the present disclosure (such as, for example, a wearable disclosure of any of the preceding Statements or the like),
a compressive force duration for the plurality of actuator devices, and/or
a sequential compression function duration; and
based on one or more or all of the compression intensity input, the compressive force duration, and/or the sequential compression function duration, initiating a compression function (e.g., sequential compression function, or the like) to be performed by a textile structure affixed to a location on a user.

Statement 26. A method according to Statement 25, the compression function comprising each actuator device of the plurality of actuator devices initiating a contracting motion or the like.

Statement 27. A wearable device, comprising:
a donnable material comprising:
a plurality of actuators configured to, upon actuation, impart compression to a body part on which the donnable material is worn, and
one or more conductors operatively connected to the each of the plurality of actuators; and
at least one of a circuit or an electrical connector coupled to the one or more conductors to send signals to, and optionally receive signals from, each of the plurality of actuators.

Statement 28. A wearable device according to Statement 27, further comprising a controller coupled to the circuit or the electrical connector.

Statement 29. A wearable device according to Statement 28, wherein the controller is configured to output instructions to each of the plurality of actuators via the one or more conductor(s) to selectively actuate a selected actuator or selected actuators.

Statement 30. A wearable device according to any one of Statements 27-29, wherein the plurality of actuators are integrated into the donnable material.

Statement 31. A wearable device according to any one of Statements 27-30, wherein the one or more conductor(s) are integrated into the donnable material.

Statement 32. A wearable device according to any one of Statements 27-31, wherein the plurality of actuators are spaced apart along a longitudinal direction of the donnable material.

Statement 33. A wearable device according to any one of Statements 27-32, wherein the donnable material comprises a fabric.

Statement 34. A wearable device according to any one of Statements 27-33, wherein the donnable material comprises a textile.

Statement 35. A wearable device according to any one of Statements 27-34, wherein the plurality of actuators are disposed within circumferential channels in the donnable material to circumscribe a body part on which the material is worn.

Statement 36. A wearable device according to any one of Statements 27-35, wherein the plurality of actuators comprise a shape memory alloy.

Statement 37. A wearable device according to Statement 36, wherein the plurality of actuators comprise a shape memory alloy spring.

Statement 38. A wearable device according to any one of Statements 27-37, the wearable device further comprising one or more feature(s) of any one of Statements 2-10, 15-16, 19-22, and 24.

The following Statements describe various examples of wearable compression systems and methods of making and using same that are not intended to be limiting in any manner.

Statement 1. A wearable compression system, comprising:
a textile structure configured to be affixed to a therapy target of an individual, the textile structure comprising a plurality of actuators embedded within the textile structure and configured to provide a compression function, and
a circuit in electronic communication with the plurality of actuators, configured to receive an input from a computing device and to output signals to the plurality of actuators to initiate the compression function.

Statement 2. A wearable compression system according to Statement 1, wherein each actuator has a first length at a first state and a second length shorter than the first length at a second state, and wherein each actuator is configured to apply a contracting motion having a compressive force when moving from the first state to the second state.

Statement 3. A wearable compression system according to Statement 2, the compressive force applied by each actuator being applied for a programmed duration of time and/or at a programmed compression intensity and/or according to a programmed compression sequence.

Statement 4. A wearable compression system according to any one of the preceding Statements, wherein a first actuator of the plurality of actuators is configured to be positioned at a distal position of the therapy target and/or an nth actuator of the plurality of actuators is configured to be positioned at a proximal position of the therapy target.

Statement 5. A wearable compression system according to Statement 4, the compression function generating movement of a fluid.

Statement 6. A wearable compression system according to Statement 2, wherein at least a portion of the plurality of actuators is arranged in a sequence from the first actuator to the nth actuator, and wherein the compression function comprises a series of sequential contracting motions in an order corresponding to the sequence of the portion of the plurality of actuators, for a duration of time and/or at an intensity.

Statement 7. A wearable compression system according to any one of the preceding Statements, the computing device configured to perform one or more or all of the following:
receive one or more input(s) to define the compression function;
provide power to the wearable system;
connect to one or more external device(s) by a wired and/or wireless connection;
or any combination thereof.

Statement 8. A wearable compression system according to any one of the preceding Statements, the computing device configured to perform one or more or all of the following:
receive one or more or all of:
a compression intensity input for the plurality of actuators,
a compressive force duration input for the plurality of actuators, and/or
a sequential compression function duration input; and
based on one or more or all of the compression intensity input, the compressive force duration input, and/or the sequential compression function duration input, initiate the compression function.

Statement 9. A wearable compression system according to Statement 8, the computing device controlling the compression intensity input and the compressive force duration input by adjusting one or more or all of a pulse width modulation (“PWM”) duration or a PWM duty cycle.

Statement 10. A wearable compression system according to any one of the preceding Statements, the computing device comprising one or more or all of a printed circuit board (“PCB”), a microcontroller, a microprocessor, a memory, or a power supply.

Statement 11. A wearable compression system according to any one of the preceding Statements, wherein one or more portion(s) of the textile structure comprises a configuration with the plurality of actuators spaced along one or more ax(es) and/or spaced about one or more plane(s) of the configuration.

Statement 12. A wearable compression system according to Statement 11, the one or more portion(s) of the textile structure comprising the configuration affixed to the location on the user with the plurality of actuators positioned about a circumference of the location and configured to provide the compression function by exerting forces in one or more or all of radial, tangential, or normal directions relative to the therapy target of the individual.

Statement 13. A wearable compression system according to any one of the preceding Statements, the plurality of actuators comprising one or more or all of springs, wires, or rods.

Statement 14. A wearable compression system according to any one of the preceding Statements, the plurality of actuators comprising one or more shape memory alloy(s) (“SMA”).

Statement 15. A wearable compression system according to Statement 14, the one or more shape memory alloy(s) comprising one or more or all of SMA spring(s), SMA wire(s), or SMA rod(s).

Statement 16. A wearable compression system according to any one of the preceding Statements, the plurality of actuators comprising one or more or all of nickel-titanium (“NiTi”) yarn(s), Kevlar yarn(s) coupled to a direct current (“DC”) motor, fluidic fiber actuator(s), inverse pneumatic artificial muscle(s) (“IPAM”), hydro-muscle actuator(s), or the like), liquid crystal elastomer(s), aligned amorphous polymer(s), conductive polymer(s), dielectric elastomer(s), or carbon nanotube fiber(s).

Statement 17. A wearable compression system according to any one of the preceding Statements, the textile structure comprising a knitted structure, a woven structure, an embroidered structure, a sewn structure, a silicone casted structure, or a polymer casted structure.

Statement 18. A wearable compression system according to Statement 17, the knitted structure comprising one or more tubular channels or the like.

Statement 19. A wearable compression system according to any one of the preceding Statements, the textile structure configured to exert a passive compressive force to the therapy target of the individual.

Statement 20. A wearable compression system according to any one of the preceding Statements, the therapy target comprising one or more or all portion(s) of a hand and/or wrist of the individual.

Statement 21. A wearable compression system according to Statement 20, the textile structure comprising a full-hand structure, configured to cover the hand of a user.

Statement 22. A wearable compression system according to any one of the preceding Statements, the therapy target comprising one or more or all of one or more foot/feet, one or more toe(s), one or more ankle(s), one or more leg(s), a neck, a nose, one or more ear(s), a head, a face, one or more hip(s), a torso, one or more breast(s), a pelvis, one or more forearm(s), or one or more arm(s) of the individual, or any portion thereof, or any combination thereof.

Statement 23. A wearable compression system according to any one of the preceding Statements, the textile structure conformable to the therapy target of the individual.

Statement 24. A wearable compression system according to any one of the preceding Statements, wherein n is 1-10000 actuator(s), including all integer values and ranges therebetween.

Statement 25. A method, comprising:
receiving one or more or all of:
a compression intensity input for a plurality of actuators,
a compressive force duration for the plurality of actuators, and/or
a sequential compression function duration; and
based on one or more or all of the compression intensity input, the compressive force duration, and/or the sequential compression function duration, initiating a compression function to be performed by a textile structure affixed to a therapy target of an individual.

Statement 26. A method according to Statement 25, the compression function comprising each actuator of the plurality of actuators initiating a contracting motion or the like.

Statement 27. A method for automatically designing a wearable compression system, the method comprising:
receiving a set of measurements of a therapy target of an individual;
displaying a design interface on a display, the design interface comprising a graphical representation of a wearable compression system for the therapy target having an overlay of a default number of one or more actuator(s), each actuator having a default location, wherein the wearable compression system and/or the graphical representation of the wearable compression system have/has default dimensions, and wherein the default dimensions of the wearable compression system and/or the default dimensions of the graphical representation of the wearable compression system, the default number of one or more actuator(s), and the default location of each actuator are based on the set of measurements;
optionally, receiving one or more modified dimension(s) of the wearable compression system, a modified number of actuator(s), one or more modified location(s) of the one or more actuator(s), or any combination thereof;
updating the graphical representation according to, if present, one or more or all of the modified dimension(s) of the wearable compression system, the modified number of actuator(s), and the modified location(s) of the actuator(s); and
generating an instruction file for automated fabrication of the wearable compression system based on the graphical representation or the updated graphical representation.

Statement 28. A method according to Statement 27, wherein the set of measurements is a standardized set of measurements based on the therapy target.

Statement 29. A method according to Statement 27 or 28, wherein the set of measurements is a 3D model or a 3D model in Virtual Reality (VR), Augmented Reality (AR), Mixed Reality (XR), or any combination thereof of the therapy target.

Statement 30. A method according to any one of Statements 27-29, wherein the instruction file for automated fabrication of the wearable compression system comprises instructions for knitting a structure of the wearable compression device.

Statement 31. A method according to Statement 30, wherein the instruction file for automated fabrication of the wearable compression device further comprises instructions for fabricating one or more tubular channel(s) in the knitted structure of the wearable compression device.

Statement 32. A method according to any one of Statements 27-31, wherein the therapy target comprises one or more or all of one or more foot/feet, one or more toe(s), one or more ankle(s), one or more leg(s), a neck, a nose, one or more ear(s), a head, a face, one or more hip(s), a torso, one or more breast(s), a pelvis, one or more forearm(s), one or more wrist(s), or one or more arm(s) of the individual, or any portion thereof, or any combination thereof.

Statement 33. A method of treating a therapy target of an individual diagnosed with, having or suspected of having, or having symptoms of edema in at least a portion of the therapy target, comprising:
receiving a set of measurements of the therapy target;
designing, and optionally, fabricating, a wearable compression system based on the set of measurements, wherein the use of the wearable compression system temporarily, partially, or fully ameliorates the edema or the symptoms of edema.

Statement 34. A method according to Statement 33, wherein the designing further comprises:
displaying a design interface on a display, the design interface comprising a graphical representation of a wearable compression system for the therapy target having an overlay of a default number of one or more actuator(s), each actuator having a default location, wherein the wearable compression system and/or the graphical representation of the wearable compression system have/has default dimensions, and wherein the default dimensions of the wearable compression system and/or the default dimensions of the graphical representation of the wearable compression system, the default number of one or more actuator(s), and the default location of each actuator are based on the set of measurements;
optionally, receiving one or more modified dimension(s) of the wearable compression system, a modified number of actuator(s), one or more modified location(s) of the one or more actuator(s), or any combination thereof;
updating the graphical representation according to, if present, one or more or all of the modified dimension(s) of the wearable compression system, the modified number of actuator(s), and the modified location(s) of the actuator(s); and
generating an instruction file for automated fabrication of the wearable compression system based on the graphical representation or the updated graphical representation.

Statement 35. A method according to Statement 33 or 34, wherein the therapy target comprises a hand or a portion of a hand.

The steps of the method described in the various embodiments and examples disclosed herein are sufficient to carry out the methods of the present invention. Thus, in an embodiment, the method consists essentially of a combination of the steps of the methods disclosed herein. In another embodiment, the method consists of such steps.

The following examples are presented to illustrate the present disclosure. They are not intended to limiting in any manner.

### EXAMPLE 1

This example provides a description of various examples of a wearable compression system of the present disclosure.

This example presents examples of Knit-Dema, a robotic textile device that allows sequential compression from distal to proximal finger phalanges for mobilizing edema. The device is machine-knit and integrates small-scale actuators to envelop granular body locations such as fingers, catering to the shape of the hand. In addition, the device affords customizable compression levels through the enclosed fiber-like actuators. In this example, compression parameters are characterized and simulate the shunting of edema through a mock fluid system. Finally, this example provides a case study to evaluate the feasibility of the device, in which five hand edema patients assess KnitDema. Studies performed in this example provide insights into the opportunities for robotic textiles to support personalized rehabilitation.

To close this gap, this example provides KnitDema, a robotic textile system that provides sequential compression across finger phalanges for mobilizing hand edema. Robotic textile is an emerging form of fabric-based soft robots that enable “sensing, actuation, and stiffness control” in “a single conformable fabric substrate,” creating a new platform of robots to offer compliant structures compatible with wearables.

Robotic textiles can be especially suitable to the needs of hand edema treatment in terms of (1) individual customization, (2) accessibility, and (3) comfort. Diverse etiologies and presentations of edema in individuals are among the main challenges that make hand edema difficult to treat; individuals must comply with different treatment timelines and regimes. The diverse hand shapes and swelling presentations are compounding this problem, making standardized treatment difficult. KnitDema caters to individual medical needs and anthropometry of the hand by offering programmable compression parameters and leveraging machine knitting which can fabricate made-to-measure devices. Highlighting accessibility, KnitDema can be programmed to deliver a sequence of automated actuation from the comfort of the patient's home, alleviating the need for costly and frequent therapy visits to clinics.

Further, unlike IPC, robotic textiles are comparably inexpensive and easy to fabricate with standard textile machinery. Finally, KnitDema affords superior comfort because it is breathable and comfortable to wear. Compliant fabric and small-scale actuators allow the device to reach granular parts of the hand without fatiguing the hand in long-term use. The textile-based device does not encumber patients with bulky bladders, compressors, or oversized form factors.

The example provides a description of the following: (1) KnitDema, a robotic textile system that can provide sequential compression from distal to proximal finger phalanges for mobilizing hand edema. Fabricated with customized machine-knitted substrates, the device can envelop granular body locations such as fingers, catering to individual hand shapes and edema presentations. In addition, the device affords adjustable compression levels through pulse width modulation (PWM) of enclosed shape memory alloy (SMA) actuators; (2) a simulation of the fluid displacement of the device through a mock system emulating the shunting of interstitial fluid to characterize the impact of (1) the number of SMA bands, (2) the duration of compression, and (3) the intervals between SMA bands and sequence on the fluid drainage; and (3) a case study with 5 persons with hand edema to understand the system's feasibility, using the developed system and identified parameters.

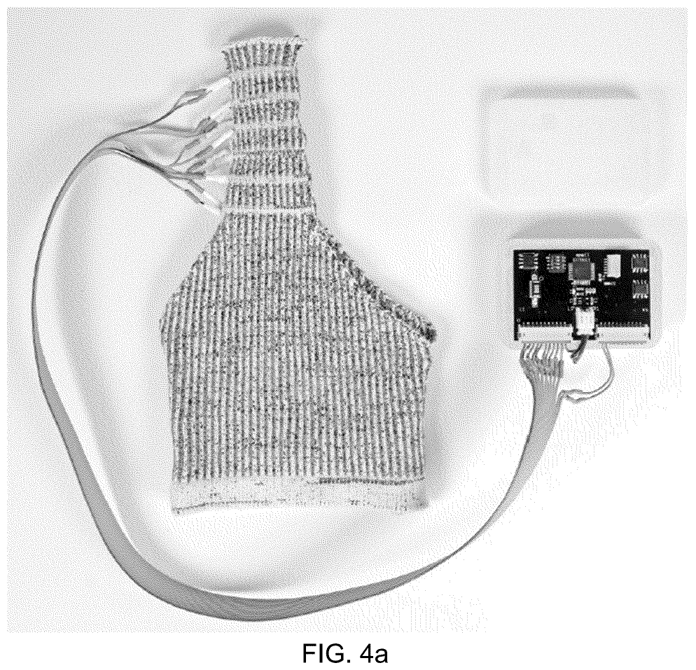

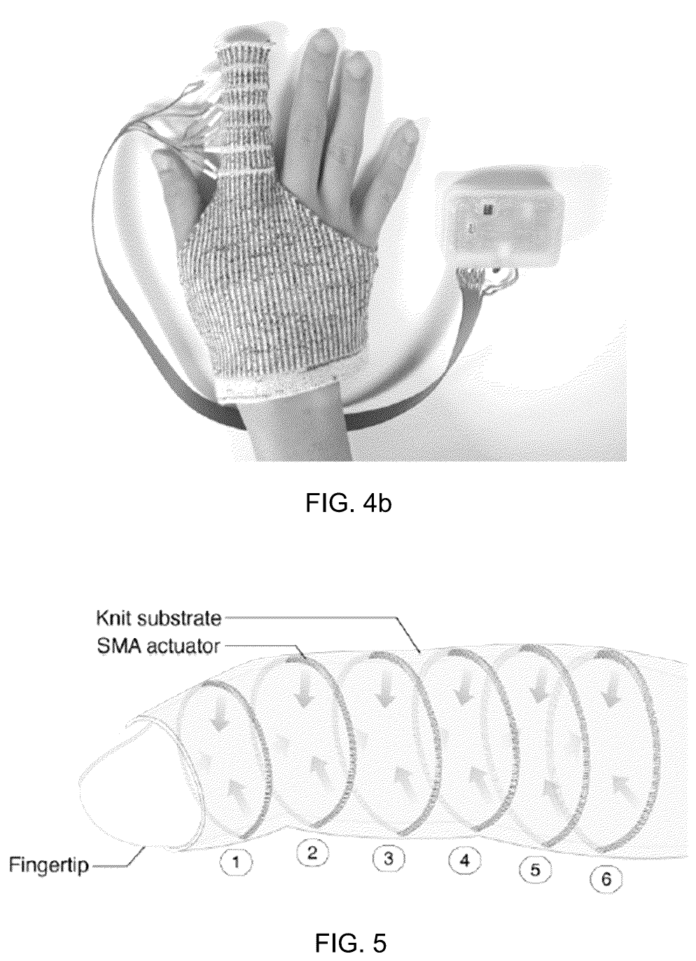

An example of KnitDema is shown in FIGS. 4a-c. As shown, KnitDema consists of a machine-knit semi-glove and hardware (a) to compress edematous hands sequentially. The device covers the index finger (b) and uses embedded shape memory alloy (SMA) bands to mobilize edema fluid from the fingertip to the base (from 1 to 6 in c). A human-subject case study demonstrates the feasibility and potential efficacy of the device.

KnitDema contributes the first step towards a portable and compliant active treatment device. While the device retains the wearability of passive compression garments, it adds active compression, which can also be prescribed to individual patient needs. Further, KnitDema allows for accessible treatment for patients with impaired physical mobility or who have difficulty accessing clinics to receive therapy ultimately wherever convenient.

### Design Considerations: Towards a Personalized Rehabilitation Device

Consideration of Compression Tolerance and Sensation. Because of varying causes of edema, it is essential to consider the tolerance to compression from different patients. Thus, the device should provide tunable compression gradients. Throughout the device development process, rehabilitation physicians on the team understood the mechanics of actuation and the mechanical properties of the materials used in the device, to pro-vide the HCl researchers with targeted feedback for compression adjustment during the prototype iterations. Rehabilitation physicians also highlight the importance of other sensations conveyed concurrently with compression (such as heat generated from the shape memory alloy (SMA) or the sensation of tingling as SMA unloads) and make sure these stimuli are in the range of tolerable sensations. Also noted are different pain receptors with different acuity and sensitivities; the same compression magnitude could be felt more intense on the joint but mild on the glabrous finger.

Portability. Both rehabilitation physicians and therapists highlight the lack of portable treatments for edema, despite the need for an extended period of management. Portability is a crucial factor in developing the device so that the device can be implemented in settings outside clinics without the attendance of therapists beyond the initial prescription. Small-scale actuators that can be integrated into the fabric and powered by a small-footprint battery while having sufficient force to compress the hand were used in various examples.

Comfort and Wearability. Another goal is to make sure the device is comfortable and wearable. Rehabilitation physicians share how donning and doffing of pneumatic compression devices could encumber patients despite their effectiveness; compression garments boast effortless donning and doffing while being less effective in mobilizing edema. In various examples, devices aim to achieve both aspects by making donning and doffing the device undemanding but achieving active and sequential compression.

### Designing KnitDema

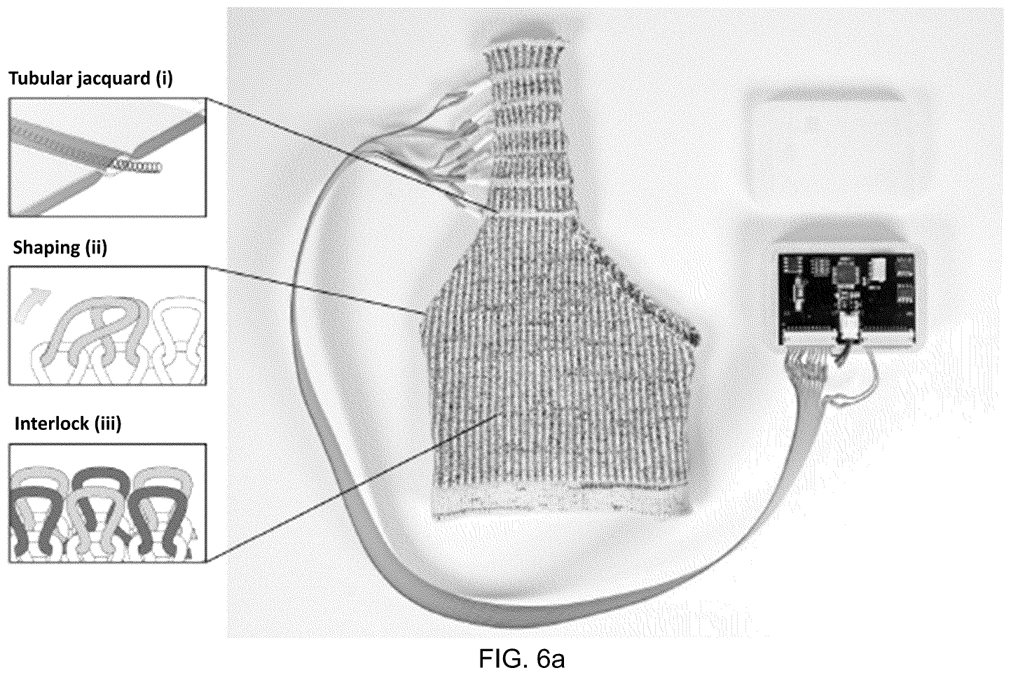

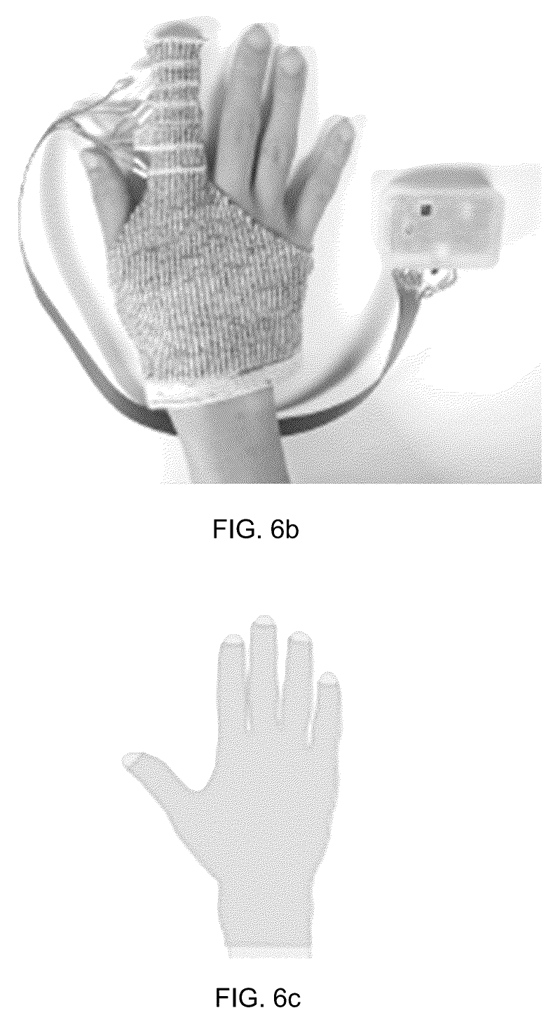

The KnitDema system consists of the (1) knit fabric substrate, (2) fiber-like actuators, and (3) hardware system (FIG. 6a-c). The envisioned patient-device experience is also illustrated. In this early prototype and the first step towards a personalized rehabilitation device, we center on designing an effective edema mobilization system for a single-finger-based device, which is the focus through-out the paper. KnitDema may be a full-hand device where the proposed compression mechanism can be applied to other fingers, the palm, and the wrist, with varying pressure outputs (FIG. 6c).

### Knit Fabric Substrate

The knit fabric serves two purposes: (1) to wrap around the hand and enclose the fiber-like actuators, and (2) to provide passive compression to the hand. The knit substrates are fabricated on a digital v-bed knitting machine, SRY 123 SHIMA SEIKI, through the Apex 3 machine knitting software.

Knit Structure Design. The knit substrate is where the shape memory alloy (SMA) springs are integrated to compress the hand. Various examples build upon a tubular jacquard structure to integrate micro-SMA springs. The tubular structure (FIG. 6a(i)) creates hollow pockets which can run in all directions to create free-form patterns that can intersect with each other. The width of the pockets can also run as small as one stitch, or less than a millimeter, to as wide as a few inches, accommodating a wide range of actuator scales. While the active compression is provided through the integrated actuators, as described in this section, the knit substrate affords passive compression. For the substrate outside the active area where the SMA springs are enclosed, yarns with extensive elasticity were used in an interlock structure (FIG. 6a(ii)), which exhibits constrained longitudinal strain but higher circumferential strain to help the substrate withstand enlargement of the hand. In addition, through machine knitting software, Apex 3, minuscule details of the design can be adjusted, helping size the device to varying shapes of the hand and specific body landmarks. Rehabilitation physicians pointed out that swelling could be disproportionate across the finger, making the finger base thicker than the fingertip. A shaping technique was used via the Apex 3 to taper the finger sleeve and fit the tapered fingertips. This shaping technique (FIG. 6a(iii)) was also used to cover the palm and wrist while carving out an opening for the rest of the fingers.

Passive Compression. When the device is not actuating, a moderate amount of constant pressure is still applied to the hand. This passive compression is attributed to the knit fabric. Passive compression is a commonly administered treatment strategy in treating hand edema. Popular edema management tools that use passive compression include string wrapping, taping, ISOTONER® glove, or Coban wrapping. Passive compression of KnitDema depends on factors including (1) yarn properties, (2) knit fabric structure, (3) knit loop length, and (4) the fit of the device to the hand. One could up the passive compression by adding yarns to the substrate. Adding additional elastic yarns leads to denser knit loops, which draw in tightly after being released from the knitting bed. Alternatively, the substrate could be knit with structures that have less ability to expand. Decreasing the loop length is another way to alter how tight the substrate is. As the lengths of the interconnected loops are shortened, the knit structure forms tighter loops, resulting in a denser structure. Finally, one could improve passive compression by sizing the device tightly to the hand. In the final implementation, Puma, Sting, and Jaguar yarns, sourced from Silk City were used. The loop length of the devices was set as 30 on the knitting machine for the desired passive compression effect.

### Fiber-Like Actuators for Active Compression

For the device to serve as a compliant robotic textile and an active compression system, miniaturized and small-footprint actuators that exhibit low stiffness were considered because of the way they can easily wrap around the finger and fit into the knit fabric. Prior works have used soft bladder actuators to be fitted around the limb to apply pressure. However, these applications require inextensible layers to limit radial expansion or an external air reservoir that has limited portability. These bulky devices pose tremendous difficulties when applied to granular areas of the body.

SMA Spring as Actuator. Materials that contract when electrically driven, such as shape memory alloys, have been used to generate compression stimuli in haptics. While shape memory alloy wire demonstrates favorable flexibility and minimal footprint, the limit in its strain restricts the material's load capacity. Twisted-coiled artificial muscles (TCA) exhibit comparable linear strain. However, the required temperature range for glass transition exists far outside this application. Meanwhile, shape memory alloy springs demonstrate higher load capacity for compression, affording a wide range of applications. SMA springs meet the needs for a low profile, lightweight, and high energy density actuator (Kellogg Research Labs, inner diameter: 0.5 mm, wire diameter: 0.25 mm, transition temperature: 45 C).

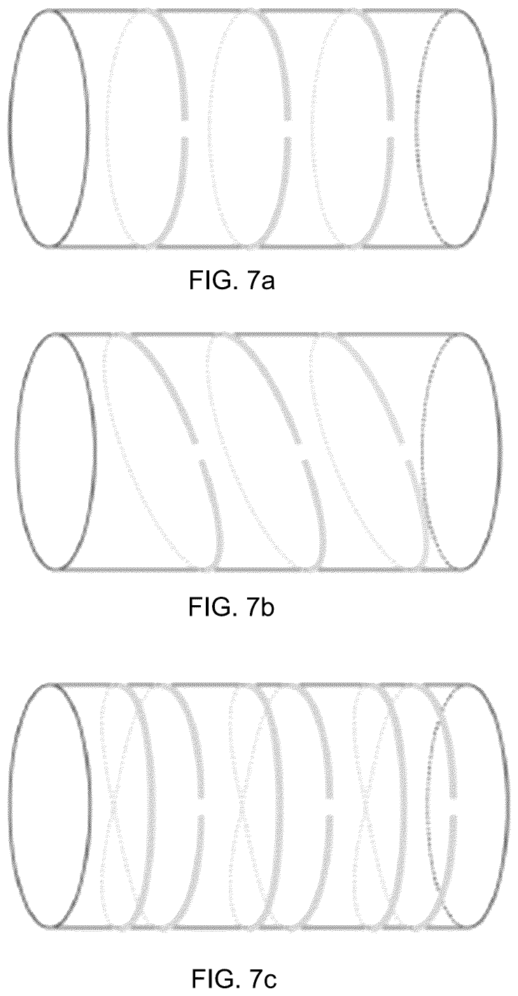

Configuring SMA in Knit Substrate. Owing to free-form channels, a tubular jacquard structure can have SMA springs run through various shapes on the knit substrate. The approach of various examples disclosed herein lays bands of SMA along the circumferences of the finger exerting tangential and normal forces. Vertical, cross, and slanted SMA configurations were explored, and the amount of water displaced from the pressure was compared. The vertical configuration mobilized the most fluid with minimal energy. While one could configure SMA in complex curves to go around joints or bypass regions with dense pain receptors, the main goal is to maintain efficient load throughput. While emphasizing the maximum load SMA can provide in a second, the aim was to keep the energy to a minimum. Also, from a clinical standpoint, rehabilitation physicians emphasize “compression density” and more “granular compression points” to serve the device's purpose, given the tight-spaced finger geometry. All things considered, the primary focus in configuring SMA is to optimize compression density while keeping the load efficiency of each SMA maximal, which leads to the linear configuration of SMA (FIGS. 7a-c). Specifically, FIGS. 7a-c displays that each band in all configurations uses continuous SMA. As load throughput depends on the resistance of SMA, (a) is deemed the most efficient, followed by (b) and (c).

Sequential Compression. The primary goal of active compression is to drain the edematous fluid captured within tissues through the lymphatic system. One of the most common treatments today involves manual edema mobilization (MEM), whereby the drainage is carried out by therapists manually massaging the swollen site. The key principle is to massage the edematous fluid from distal (situated away from the center of the body) to proximal (situated nearer to the center of the body), in which therapists clear the pathways above the affected body areas first. It remains a time-consuming, labor-intensive, and expensive treatment to access. Another effective therapy, sequential intermittent pneumatic compression (IPC), follows the same principle: discrete chambers in a device compress the site of the problem from distal to proximal to shunt edema into veins upstream. Building on this principle, Knit-Dema configures several SMA spring bands dispersed evenly across the finger sleeve and applies pressure sequentially from distal (the tip of the finger) to proximal (the base of the finger).

### Hardware

The goal for the hardware design is to fulfill portability and provide a range of programmable compression intensities. Various examples provide a rigid 51.6×33.8 mm printed circuit board (PCB) with the AT-mega328P microcontroller. The board provides varying duty cycles through pulse width modulation (PWM), which controls 4 N-channel MOSFETs (DMN3015LSD-13) and then leads to SMA compression bands. The duration and intensity of each SMA compression band can be tuned by adjusting the PWM duration and duty cycle; different duty cycles were later used to group participants into mild, moderate, and high compression levels. Side-entry multiple-position connectors were used, which were then connected to crimp connectors attached at the ends of SMA springs. A 3.7V 1200 mAh Lipo battery powered the PCB. The PCB and battery were embedded in separate compartments of a custom-designed 3D-printed snap-fit case.

### Envisioned Device-Patient Experience of KnitDema

It is envisioned that various examples of KnitDema resemble a day-to-day glove in a patient's wardrobe without bulky controllers attached. Donning and doffing KnitDema should also be straightforward, and hence finding adequately elastic materials and knit structures was paramount. The overarching modus operandi of KnitDema was that parameters concerning compression would be programmed and set up by therapists and researchers before implementing the device for each patient. The envisioned device-patient experience is illustrated in the figures, such as FIGS. 6a-b.

Preparation of KnitDema. Before patients use KnitDema, therapists and rehabilitation physicians discuss and determine an adequate level of compression based on the patient's condition. Accordingly, the researchers would program an appropriate compression intensity (i.e., compression levels) into the device. The treatment session duration will also be determined here based on clinical acumen.

Usage of KnitDema. Because KnitDema sets out to be a compliant robotic textile and takes the form of a day-to-day garment, it is expected for patients to wear the device as they would wear their clothes. As KnitDema is customized for each patient with a structure allowing a higher elongation across the lateral direction, patients would don the device as they would put on a knit glove. Once patients don the device, they check if the distal SMA band of the sleeve was aligned close to the fingertip. After patients wear the device, they place their hands flat on a surface slightly below the heart level. Patients were encouraged to remain still during the use of the device. This is for the consistency of the blood flow to the hand (often emphasized in elevation therapy), which is known to be correlated with swelling in the extremities. Finally, patients activate the device by pressing the button on the enclosure. KnitDema then runs its course as a robotic textile providing sequential compression for the duration of time set by clinicians. Once KnitDema completes its course, patients remove the device. As with the donning process, the doffing of the device does not involve demanding steps like pneumatic devices.

Long Term Usage of KnitDema. For patients with chronic edema, therapists would prescribe a desirable period of use per day and program a set level of compression. Once prescribed, patients would carry the device to wear in their spare time whenever swelling exacerbates, whether in the middle of the workday or before they go to bed. Prolonged use of KnitDema would especially be beneficial for patients who experience seasonal symptoms—exacerbated swelling in the hand when temperature and humidity are high—without burdening them with frequent therapies. Edema patients who have impaired mobility would also benefit from long-term prescriptions as they could manage the symptom remotely from home.

### Edema Mobilization Parameters of Fluid Displacement

Providing effective yet safe compression levels is critical for mobilizing edematous fluid. To achieve optimal fluid mobilization, a series of experiments were conducted to determine suitable compression parameter values. The impact of parameters in a generalized setting were simulated. Since there are few established systems in the literature to simulate filtration and mobilization of interstitial fluid, the usage of mock circulatory loop (MCL) systems was looked at, which have been utilized to test cardiac assist devices in-vitro. These loops typically include a water reservoir, piston pump, clamp, and air-trapped water reservoir where each component mimics the left atrium, left ventricle, blood flow resistance, and vessel compliance, respectively. In contrast to the native cardiovascular system, however, this inquiry was not on blood circulation but instead on the return of interstitial fluid through the lymphatic system, which is outside of and distinct from the vascular system.

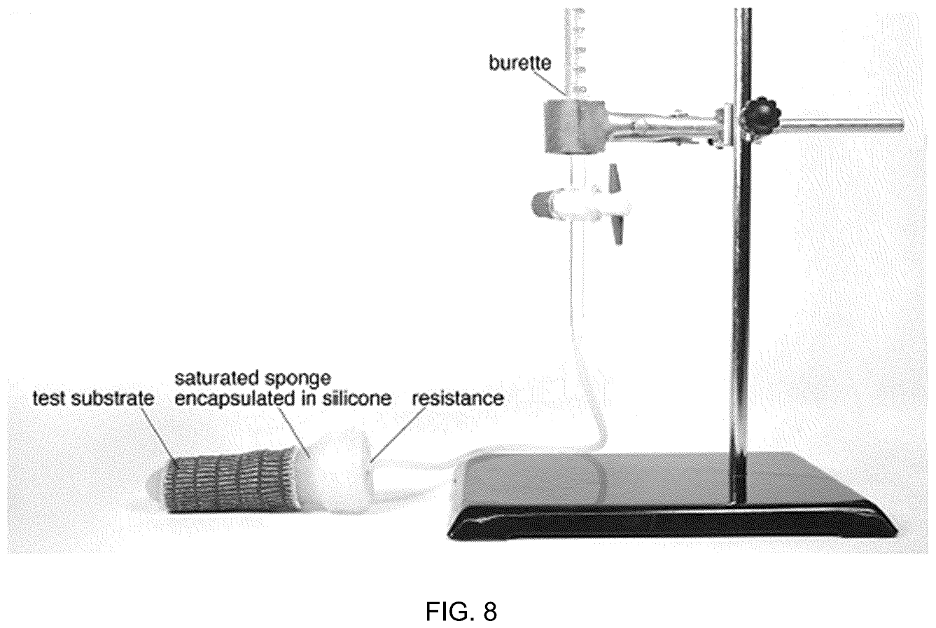

There have been approaches to simulate shunting of edema through the movement of air bubbles in water-filled tubes lying flat. However, the systems proposed do not account for the displacement in the finger. After consulting with two rehabilitation physicians and building on relevant literature, various examples discussed in this example focused on a mock hydraulic system where the external pressure applied to a compressible silicone finger saturated with water would drain the fluid out through a certain resistance (i.e., the tube outlet) and affect the reading of meniscus in the burette. This mock system also allowed for the observation of the backflow of fluid, where the unloading of an SMA band led to immediate retraction of the fluid back to the distal of the finger. The goal was to observe not only a single incident of compression but overall flare-ups and decreases in fluid displacement. This mock system helped to understand the trend of displacement caused by backflow. The setup comprises a mock system with a water-saturated sponge and 3d printed bone encapsulated in the sponge, which totals the mass of an actual swollen finger. The mock finger is connected to a narrower tube, which is then connected to a burette such that the meniscus fluctuates as the pressure begins and diminishes (FIG. 8).

Parameters for active compression, which influence fluid mobilization, include PR1: Band Interval, representing the time interval between single instances of SMA band compression, PR2: Sequence Interval, the time interval between completed sequences of SMA compression, PR3: Compression Duration, the duration of each SMA band compression, and PR4: SMA Band Number the number of SMA bands. These parameters are tested in a non-factorial method and in the above order. Starting with 3 SMA bands, tested first were the Band Interval (PR1) and Sequence Interval (PR2). Subsequently tested was the Compression Duration parameter (PR3). Finally, we tested the SMA Band Number (PR4) with identified aforementioned parameters. For clarification of the terms, SMA band represents a single SMA spring around the circumference of the finger; a sequence denotes the completion of one full compression cycle of all SMA bands in the fabric substrate; interval represents the unloading period between preceding and subsequent actuation of SMA; compression instance is in which an SMA band compresses for a given period of time. A summary of the finalized set of parameters can be found in Table 1.

TABLE 1
Finalized parameters for active compression.

| Number of SMA | Compression | SMA band | Sequence |
|---|---|---|---|
| band | Duration | interval | interval |
| 6 SMA bands | 105 seconds | X | X |

### Compression Interval Parameters (PR1, PR2)

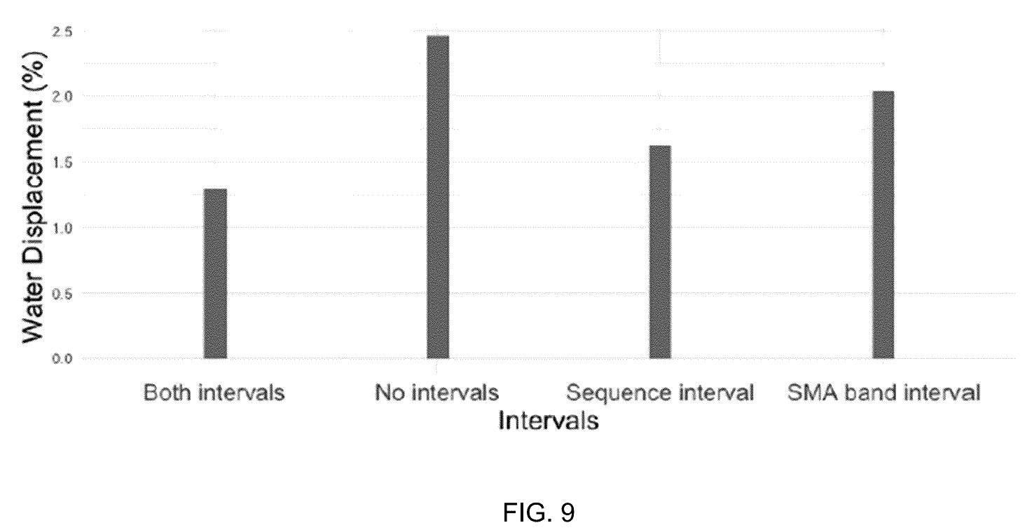

In edema compression treatment, fluid backflow can occur between compression instances. Backflow is a phenomenon where the fluid displaced from the distal location refluxes back to the distal when the pressure unloads. Various examples disclosed herein aim to minimize backflow as much as possible. To examine the backflow between individual SMA bands compression and between complete sequences, a band interval was defined as an unloading period between each SMA band compression; and sequence interval as an unloading period between a complete activation sequence of all SMAs. A factorial test was run, in which each of 3 SMA bands for 30 seconds were activated, repeating 12 sequences, with/without 30-second band interval and 30-second sequence interval. The result reports that the most effective compression is when neither band interval nor sequence interval is present (FIG. 9).

### Compression Duration Parameter (PR3)

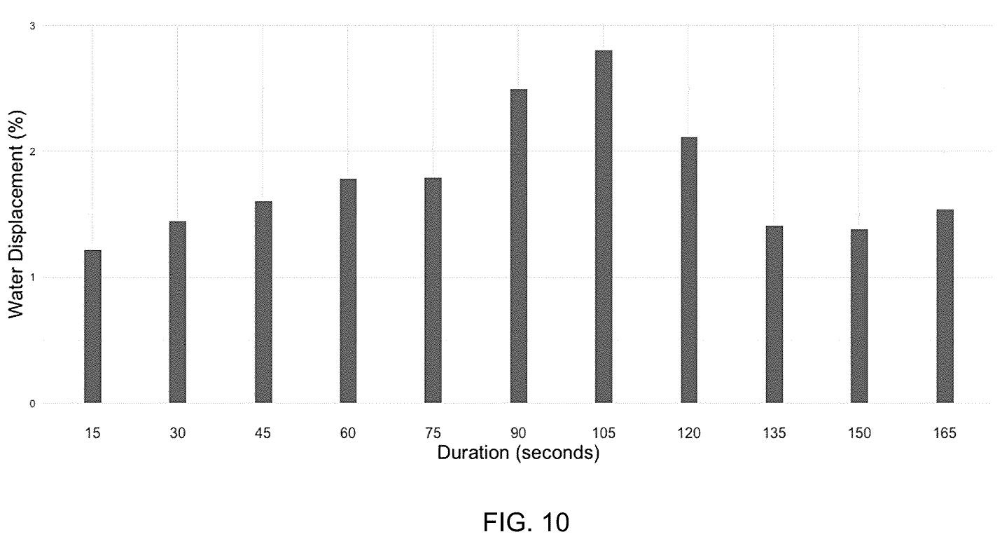

After eliminating band interval and sequence interval, meaning SMA bands contract continuously one after another, it was examined how the duration of SMA loading affects fluid displacement. In the setup, each of the 3 SMA bands were powered from 15 to 165 seconds in increments of 15 seconds (total elapsed time for 3 SMAs between 45-495 seconds). The result shows that powering 3 SMA bands for 105 seconds drains fluid the most (FIG. 10). While 105 seconds distinctively outperformed others, this result is specific to the setup under 3 SMA bands due to the non-factorial setup.

### SMA Band Number Parameter (PR4)

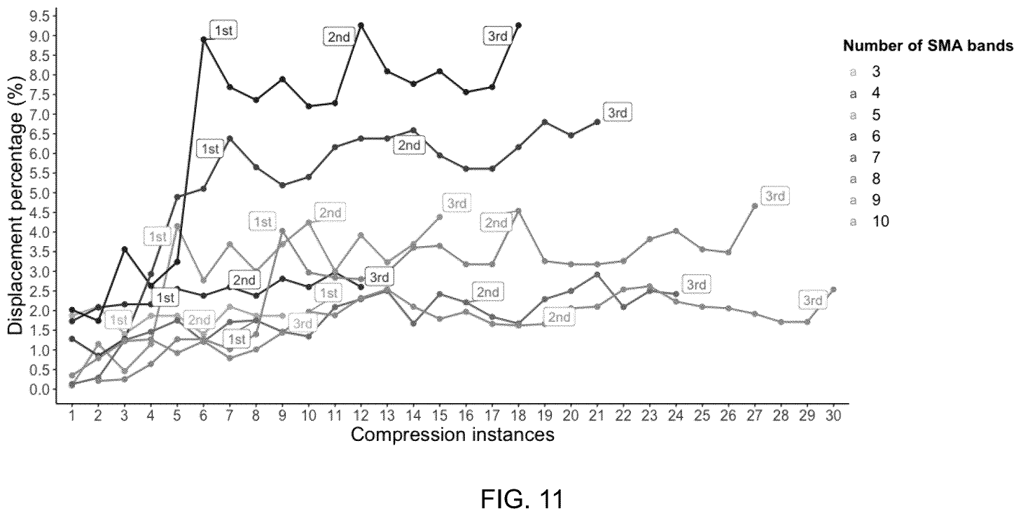

The next parameter in question is whether a certain number of SMA bands transfers water more effectively than others. Building on the previous results, the analysis started by powering 3 SMA bands for 105 seconds each without intervals between compression instances and sequences. The number of SMA increments from 3 to 10. It was noticed that the amount of water transferred peaks at 6 SMA bands, with the result of more than 9% of displacement (FIG. 11).

Specifically, FIG. 11 displays a simulation of the impact of SMA number on water displacement. The number of SMA bands in one substrate varied from 3 to 10, as labeled in the legend. All SMA bands ran their course three times, thus resulting in different numbers of compression instances in total. For instance, 7 SMA bands would result in 21 instances in total by the end of the operation; 5 SMA bands, 15 instances. The labels denote the end of each sequence (e.g., 1st denotes the end of 1st sequence). When six SMA bands ran the full three sequences, they displaced the most fluid, more than 9% (see label 3rd of line 6).

### Resulting Edema Mobilization Parameters

In summary, parameters that dominated fluid dis-placement were simulated and finalized the parameters in Table 1. The finalized parameters formed the basis of the KnitDema design and the study protocol. After the parameters were characterized, HCl researchers and rehabilitation physicians discussed the implications of the compression parameters in practice. Before developing the device in the user study, clinicians visited CU and tested a device programmed with the resulting compression parameters to provide assurance from a clinical perspective that the device would deliver a perceivable amount of compression without causing potential discomfort to an end user.

### Case Study

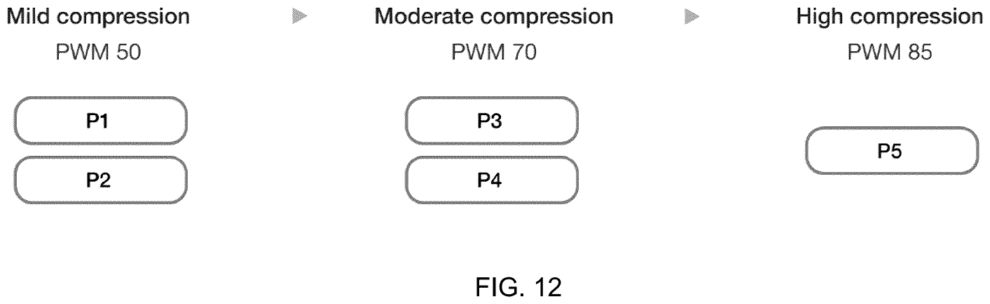

The goal of the human subject case study is to (1) understand the feasibility and safety of the device on patients with hand edema, (2) observe how participants interact with and perceive the device during the treatment, and (3) generate directions toward achieving the potential efficacy of the device. Human subject case studies are formatted to obtain quantitative and qualitative data. To study the feasibility and potential efficacy, three phases are introduced to the study, in which the compression levels are modified from mild to moderate to high (FIG. 12).

### Participants

Five hand edema patients were recruited through CMC and WCM. CMC is a regional rehabilitation clinic that offers hand therapy and lymphedema management programs. WCM is a medical institution with a rehabilitation outpatient clinic that provides physical and occupational therapy, where therapists see patients with various diagnoses, including stroke and brain and spinal cord injury. The ages of the participants range between 39 to 69, and their primary method of therapy included MEM by therapists. While some receive care more frequently than others, the maximum frequency is usually capped at twice a week. Patients with various diagnoses were recruited after the screening process; all patients present with one or more swollen fingers, excluding the thumb (Table 3). The participants are not randomly assigned or stratified to the compression levels. Instead, participants first test the lowest level of compression, after which physicians determine the level of compression increments based on the patient's edema condition for safety considerations.

### Apparatus

While retaining the finalized compression parameters (Table 1), each device was sized to the measurements of the patient's hand. The devices' compression were set into three levels-mild, moderate, and high to identify the relationship between these compression levels and the reduction of swelling. These compression levels are determined by pulse width modulation (PWM), which is the duty cycle of the voltage that dominates the load throughput of SMA springs. Higher PWM leads to higher load throughput. The varying specs of each device follow Table 2. All devices have a single sleeve for the index finger and identical SMA springs (wire size 0.25 mm, mandrel: 0.5 mm, transition temperature: 45° C. (113° F.)). The devices were fabricated using Puma, Sting, and/or Jaguar yarns, all sourced from Silk City. To fit a device to hands with various degrees of swelling, six anthropometric measurements of the hand were collected in the pre-study survey: (1) length of the index finger, (2) circumference of 31 distal to the base of the finger, (3) circumference of 23 distal to the base of the finger, (4) circumference of the base of the finger, (5) circumference running from the thumb MCP to the pinky MCP, and (6) circumference of the wrist.

TABLE 2
Specs of devices customized for patients.

| Patient Code | Substrate Materials | Loop Length | Compression Level |
|---|---|---|---|
| P1 | Puma, Jaguar, and | 30 | Mild |
| | Sting | | |
| P2 | Puma, Jaguar, and | 30 | Mild |
| | Sting | | |
| P3 | Puma and Sting 2 | 30 | Moderate |
| | ends, and Jaguar | | |
| P4 | Puma and Sting 2 | 30 | Moderate |
| | ends, and Jaguar | | |
| P5 | Puma and Sting 2 | 30 | High |
| | ends, and Jaguar | | |

TABLE 3
Participant information gathered through a pre-study survey.

| | | | | Care | Main | Home |
|---|---|---|---|---|---|---|
| Code | Age | Gender | Standard of Care | Frequency | Care Site | Maintenance |
| P1 | 69 | F | MEM, IPC, | 2 times a month | CMC | IPC and |
| | | | compression glove | | | self-massage |
| P2 | 39 | F | MEM | 2 times a month | CMC | N/A |
| P3 | 53 | F | MEM, hand | 2 times a week | CMC | Self- |
| | | | therapy | | | massage |
| P4 | 68 | M | Compression | 2 times a week | WCM | Compression |
| | | | glove, taping, OT | | | glove |
| P5 | 69 | M | MEM | Once a week | CMC | Exercise, self- |
| | | | | | | massage, ice |

MEM: manual edema mobilization by therapists;
IPC: intermittent pneumatic compression device;
OT: occupational therapy.

### User Study Protocol

The user study protocol consists of the following steps: (1) a pre-study survey, (2) pre-intervention measurements (baseline), (3) intervention, and (4) post-intervention measurements.

Pre-Study Survey (10 minutes). A remote pre-study survey was conducted 1-2 weeks prior to the intervention. The survey asked the patient's demographic information, the standard of care, and the measurements of the affected hand. KnitDema devices were customized based on anthropometric measurements.

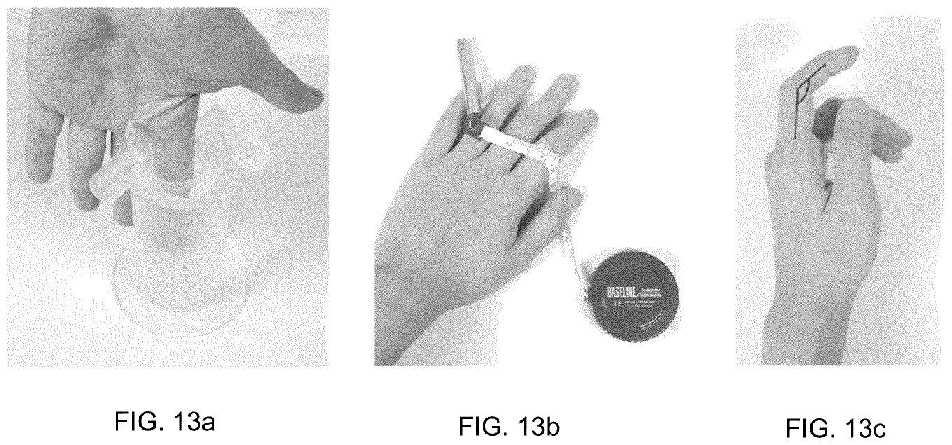

Pre/Post Intervention Measurements (30 minutes each). To assess the influence of the intervention, three measurements were conducted on the affected hand before and after the intervention. The pre-intervention measurements represent the baseline, for which finger volume, finger circumference, and range of motion were measured (FIGS. 13a-c). To maintain consistency, all measurements are repeated 5 times by an observer while the order of measurements is randomized.

Volume Measurement: This method quantifies the volume of the affected finger by submerging it into a tank filled with water and measuring the weight of water displaced from the tank. The base of the finger was marked, and the water surface was aligned to the mark for consistency. To carry out the accurate volumetric measurement, a 3D printed volumeter was custom designed that can accommodate the web space between the index and middle finger and has a fixture inside to guide the position of the finger as it submerges (FIG. 13a).

Circumference Measurement: The circumferences of the distal interphalangeal joint (DIP), proximal interphalangeal joint (PIP), and the base were measured. Marks were also left on the joints for consistent measurements. This measurement was repeated 5 times for each joint (FIG. 13b).

Range of Motion (ROM): The flexion of PIP was measured. Participants were asked to perform two motions: (1) straighten the finger, and (2) flex the finger as much as possible. The motions were repeated 5 times while recording them. A computer goniometer was used to obtain angles from the videos. The internal angle of the DIP-PIP-MCP (metacarpophalangeal) joint was measured (FIG. 13c).

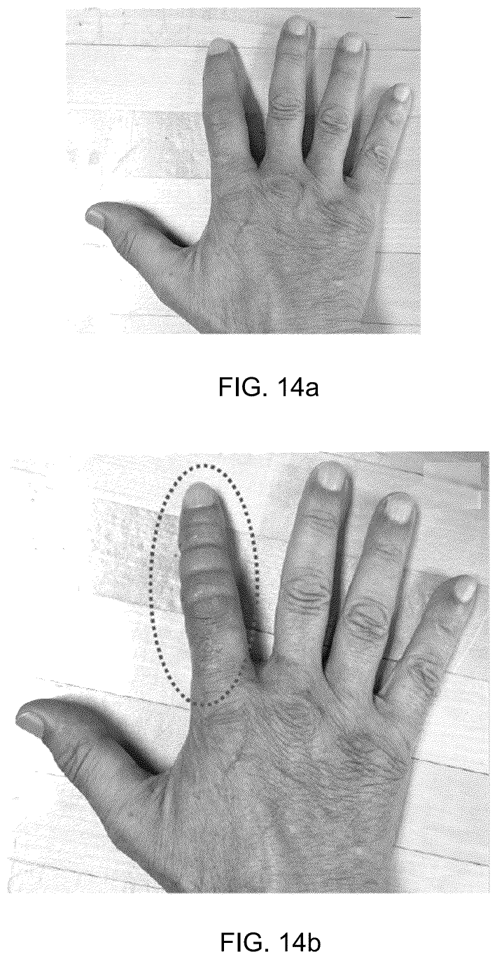

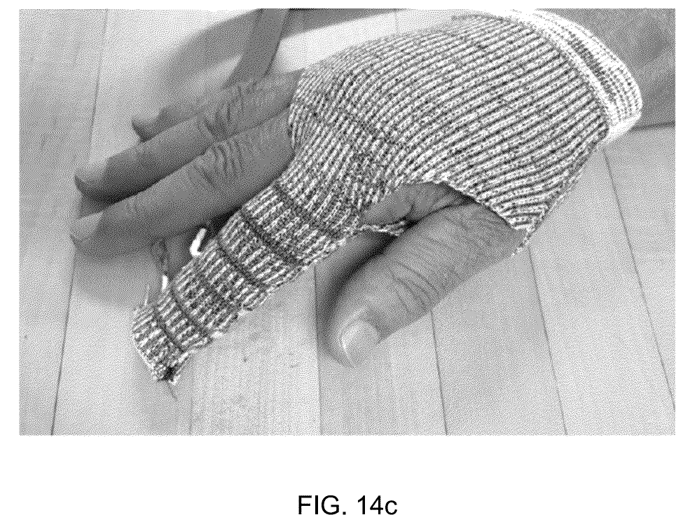

Intervention (60 minutes). The duration of the intervention was modeled after one-hour regular therapy sessions participants receive. As the intervention begins, pictures of the hand were taken as a comparison point (FIGS. 14a-c). Participants wear the device on their own. Participants were asked to position their hands on the desk slightly below the heart level. Once they don the device, the device exerts 105-second pressure on each of the 6 SMA bands for 5 sequences, totaling 52 minutes and 30 seconds (105*6*5). This duration of the intervention was determined by therapists and rehabilitation physicians on the team in consideration of MEM therapy duration in clinics, which is typically under an hour, without breaking up the compression sequence. Upon the completion of the intervention, participants take off the device, and pictures were taken of the hand to compare the hand visually.

### Analysis

Intra-rater reliability was analyzed to take into account the multiple measurements (5 times each for the three measurements) carried out by a single observer (Table. 4). For the intra-rater reliability, the intra-class correlation coefficient (ICC) in R was used. The non-independency of data across participants through known linear mixed effects models and Ime4 were taken into account. Through visual inspection, normal distribution and constant variance of residuals for all three datasets were confirmed: volume, circumference, and ROM (range of motion). In analyzing circumference, three random effects were anticipated: (1) participants, (2) the interaction between participants and measurement times, and (3) the interaction among participants, measurement times, and finger joints. Random effects of two factors for the rest of the measurements were anticipated: (1) participants, and (2) the interaction between participants and measurement times.

TABLE 4
Intra-rater reliability of measurements and Cis. ICC score
close to 1 indicates high similarity between measurements.

| | ICC of | ICC of | 95% CI of | 95% CI of |
|---|---|---|---|---|
| Measurement | baseline | post | baseline | post |
| Volume | 0.985 | 0.99 | [0.948, 0.998] | [0.965, 0.999] |
| Circumference | 0.969 | 0.949 | [0.898, 0.996] | [0.839, 0.994] |
| of DIP | | | | |
| Circumference | 0.983 | 0.986 | [0.943, 0.998] | [0.952, 0.998] |
| of PIP | | | | |
| Circumference | 0.967 | 0.987 | [0.892, 0.996] | [0.957, 0.999] |
| of base | | | | |
| ROM | 0.99 | 0.992 | [0.973, 0.999] | [0.973, 0.999] |

### Results

This section of the example presents results from the case study. The case study reports ICC scores, 95% confidence intervals for pre-measurements (baseline), and post-measurements (Table 4), significant outcomes, and descriptive graphs.

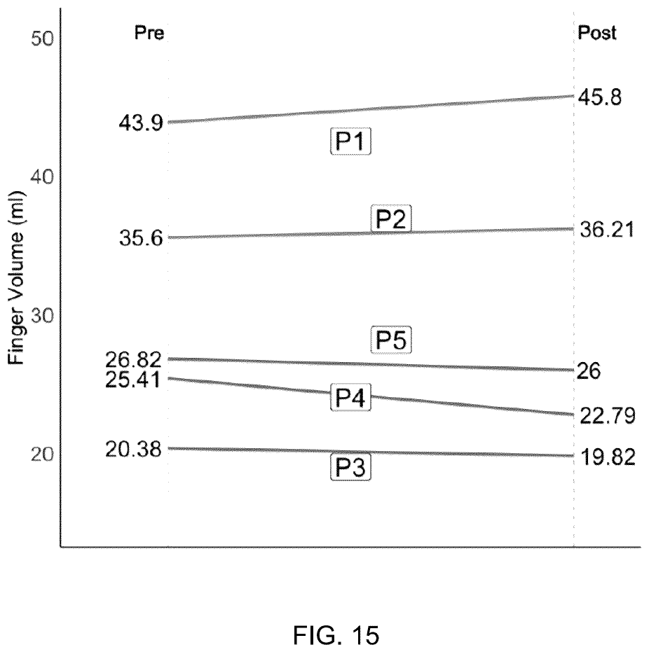

Volume Measurement. Linear mixed effects model reveals no significant changes before and after the intervention. In the descriptive data, a decrease in the volume is deemed favorable as it indicates edema drained. The red lines are indicative of an increase in the finger volume; the green lines represent a decrease in the finger volume. In percentage, the finger volume changes before and after intervention by +4.3%, +1.7%, −2.7%, −10.3%, and −3% for the respective participants. P4 demonstrates the largest decrease in the volume. What is notable in the volume measurement is that the participants in moderate and strong compression levels show a favorable amount of reduction in swelling (FIG. 15).

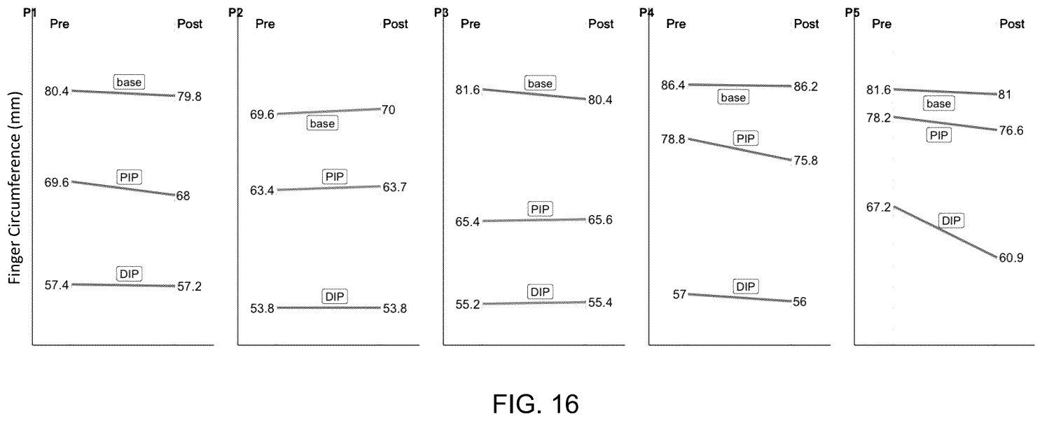

Circumference. The model analyzes that the differences in the circumference across DIP, PIP, and the base joints are significant (p-value <0.001). However, significant changes in the measurement before and after the intervention were not observed. As for descriptive data, the decrease in the circumference was considered a sign of favorable results. As before, the green lines indicate a decrease in the measurement while the red represents an increase in circumference. P5 shows noticeable decrease of 4.1% in circumference on average, followed by P4 (−1.9%), P1 (−1.1%), P3 (−0.3%), and P1 (1.1%). As for the circumferences of the joints, DIP changes by −2.2%, PIP −1.5%, and base −0.5%, showing a diminishing tendency in general from distal to proximal (FIG. 16).

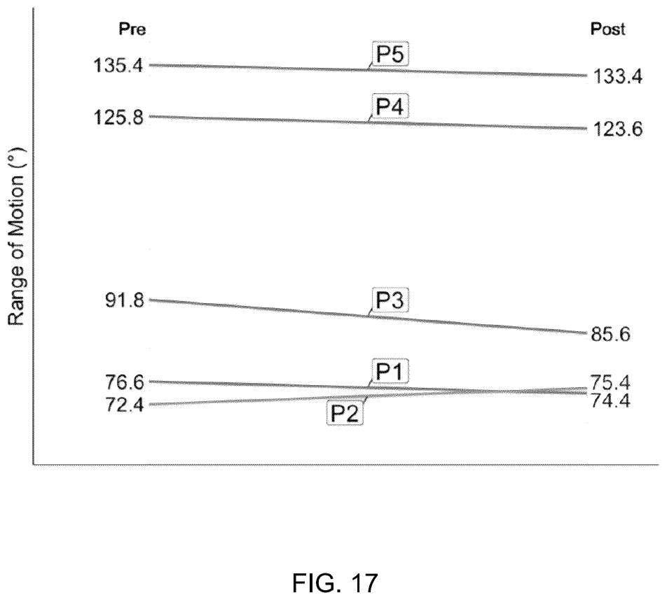

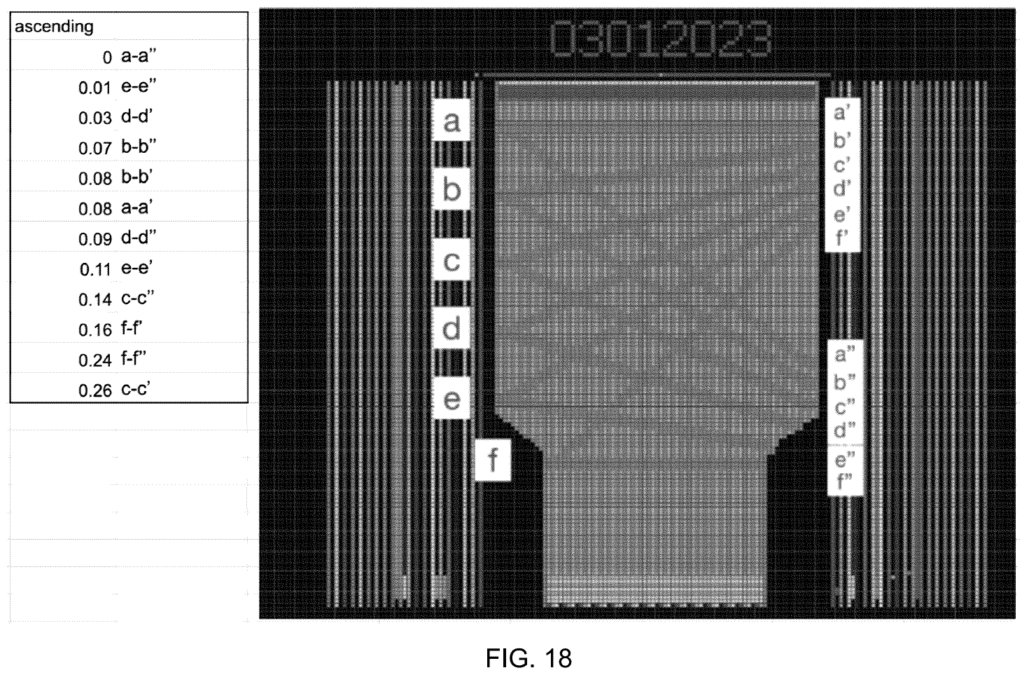

Range of Motion. Literature suggests that the success of manual edema mobilization is correlated with an increase in the range of motion. The analysis of this example shows no significant changes in ROM before and after the intervention. Descriptive data informs that the green lines indicate a decrease in the flexion angle, which is deemed favorable, while the red lines indicate an increase in the range of motion. ROM is where a high level of variance was observed among the patients due to underlying medical conditions, as some participants who have their mobility compromised have difficulty flexing their fingers. Participants, on average, show a decrease of 1.7% flexion angle after the intervention, which is deemed favorable (FIG. 17)

### Discussion

This research discusses the mechanism of sequential compression for swollen hands evolving into a working system and being deployed in human-subject user tests. The device has proved its feasibility and comfort, alongside the possibility of a take-home tele-health device, thanks to its portability. However, the device leaves room to improve its potential efficacy and explore possible compliance issues over mid or long-term use. Moreover, current device fabrication encourages lowering the barrier of fabrication through a comprehensive pipeline. This is detailed in the following sections.

The achievements from the feasibility study of KnitDema lay an important ground for this work. It is considered that other examples of the device can have (1) extended coverage of the hand, (2) robust measurements, and (3) mid or long-term deployment of the device.

This example centered on designing and testing SMA-driven edema mobilization fora single finger. During the study, participants ex-pressed how the compliant nature of KnitDema was desirable as the device fits the hand and fingers snugly. The reflux of fluid back to the fingers as the palm is being compressed could be alleviated by adjusting compression parameters.

Long-Term and In-The-Wild Deployment. Participants were enthusiastic about using the device in residential settings. They highlighted the device's portability and that KnitDema could become a readily available treatment not tethered to clinics. Participants mentioned experiencing the “ebb and flow” of symptoms throughout the day, again emphasizing the need for more readily available treatment options. Another aspect that made participants passionate about the device in residential settings was the programmability of compression; participants appreciated the ability to modify the compression parameters to their needs.

This example discussed the design and development of KnitDema, a digitally knit robotic textile that is individually programmable for sequential compression across finger phalanges for mobilizing hand edema. A device was designed with parameters that effectively shunted fluid. A case study of KnitDema was performed with 5 persons with edematous hands to obtain a qualitative and quantitative understanding of device feasibility. Measurements of volume, circumference, and range of motion demonstrate the feasibility and potential efficacy of KnitDema. The study demonstrated the wearability of the device, participants' perceptions of compression, how the device compares to other standards of care, and KnitDema's prospects as a personalized device for treating hand edema. This project sheds light on the potential of using the under-explored advantages of robotic textiles as a personalized rehabilitation tool that is inexpensive to manufacture and comfortable to wear.

### EXAMPLE 2

This example provides a description of examples of wearable compression systems of the present disclosure.

KnitDema (“a wearable device”) utilizes small-scale actuators to make active compression possible to treat edematous hands in a portable manner. Active compression therapies in the current clinic have been contained to pneumatic devices that cover upper extremities or massage therapy administered by trained therapists, both of which necessitate frequent visits to clinics and unaffordable costs. Lack of room to scale down the form factors and integration of bulky actuators compound the problem to treat edematous hand, in which exerting pressure to small spaces and venous/lymphatic systems of the hand are paramount. In addition, the wearable device is tailored to individual hands and can be programmed with desired pressure levels, thus offering hyper-customized edema treatment which can ultimately lend itself as a remote rehabilitation device.

### Certain Features of the Wearable Device

Programmable compression: The wearable device can be programmed to deliver a sequence of automated actuation from the comfort of the patient's home, alleviating the need for costly and frequent therapy visits to clinics.

Favorable Conformation: The wearable device affords superior comfort during kinematic movement of the hand. This is achieved by compliant fabric and small-scale actuators which allow the device to reach granular parts of the hand without fatiguing the hand by obstructing hand movements. The textile-based device does not encumber patients with bulky bladders, compressors, or oversized form factors, easily manifested in clinics (e.g., IPC).

Affordability: Unlike intermittent pneumatic compression (IPC), the fabrication of the wearable device is comparably inexpensive and can be compatible with standard textile machinery.

Before patients use the wearable device, therapists and rehabilitation physicians may discuss and determine an adequate level of compression based on the patient's condition and medical history. Accordingly, the researchers could program an appropriate compression intensity (i.e., compression levels) into the wearable device. The treatment session duration could also be determined here based on clinical acumen.

An example of the wearable device comprises the (1) knit fabric substrate, (2) shape memory alloy (SMA) spring actuators, and (3) hardware system.

In order to fabricate the knit substrate, the wearable device needs to utilize a digital v-bed knitting machine, SRY 123 SHIMA SEIKI, through the Apex 3 machine knitting software. The knit substrate is where the shape memory alloy (SMA) springs are integrated to compress the hand. The wearable device utilizes tubular jacquard structure to integrate micro SMA springs, in which the structure creates hollow pockets which can run in all directions to create free-form patterns. For the substrate outside the active area where the SMA springs are enclosed, one would use yarns with extensive elasticity in an interlock structure, which exhibits constrained longitudinal strain but higher circumferential strain to help the substrate withstand enlargement of the hand.

While SMA springs can be sourced elsewhere, the wearable device utilizes a low profile, lightweight, and high energy density actuator from Kellogg Research Labs with following specs: inner diameter: 0.5 mm, wire diameter: 0.25 mm, transition temperature: 45 C.

The hardware to program and control active compression comprises a rigid 51.6×33.8 mm printed circuit board (PCB) with the ATmega328P microcontroller. The board provides varying duty cycles through pulse width modulation (PWM), which controls 4 N-channel MOSFETs (DMN3015LSD-13) and then leads to SMA compression bands. The hardware utilizes side-entry multiple-position connectors, which are then connected to crimp connectors attached at the ends of SMA springs. A 3.7V 1200 mAh Lipo battery powered the PCB. Incorporated in separate compartments in a custom-designed 3D-printed snap-fit case are the PCB and battery.

FIG. 18 displays an example of the patten design. The rationale for the patten design is dividing the areas above and under the thumb muscle with different orientations given the uniform voltage. KnitDema contains the materials within its substrate thus keeping compression conformal to the body, and also improving the comfortable when worn on the body.

Alternative versions and variations of the Wearable Device

An alternative version of the wearable device would have active compression elements extended to the palm area.

### Examples of Uses of the Wearable Device

Short-term use of the wearable device: Because the wearable device sets out to be a compliant robotic textile and takes the form of a day-to-day garment, it is expected that patients will wear the device as they would wear their clothes. As the wearable device is customized for each patient with a structure allowing a higher elongation across the lateral direction, patients would don the device as they would put on a knit glove. After patients wear the device, they would place their hands flat on a surface slightly below the heart level. It is encouraged that patients remain still during the use of the device. This is for the consistency of the blood flow to the hand, which is known to be correlated with swelling in the extremities. Finally, the patients activate the device by pressing the button on the enclosure. The wearable device then runs its course providing sequential compression for the duration of time set by clinicians. Once the wearable device completes its course, patients may remove the device. As with the donning process, the doffing of the device does not involve demanding steps like pneumatic devices.

Long-term use of the wearable device: For patients with chronic edema, therapists could prescribe a desirable period of use per day and program a set level of compression. Once prescribed, patients would carry the device to wear in their spare time whenever swelling exacerbates, whether in the middle of the workday or before they go to bed. Prolonged use of the wearable device would especially be beneficial for patients who experience seasonal symptoms-exacerbated swelling in the hand when temperature and humidity are high-without burdening them with frequent therapies. Edema patients who have impaired mobility would also benefit from long-term prescriptions as they could manage the symptom remotely from home.

### EXAMPLE 3

This example provides a description of examples of wearable compression systems of the present disclosure and methods of automatically designing same.

This example provides a description of MediKnit, an approach for the fabrication of soft medical devices, addressing critical limitations in existing design processes for medical devices. Current rapid prototyping in medical domains relies on rigid 3D-printed materials, lacking flexibility, customization, and clinician-led input. MediKnit provides a design tool empowering clinicians to personalize fabric-based devices for hand edema. This tool gives clinicians the freedom to adapt the design to individual patients' demands, thereby enhancing the overall effectiveness of therapy. The MediKnit device created by this tool consists of a machine-knit glove with active compression, which is programmable through a custom printed circuit board (PCB). This device facilitates the mobilization of edema.

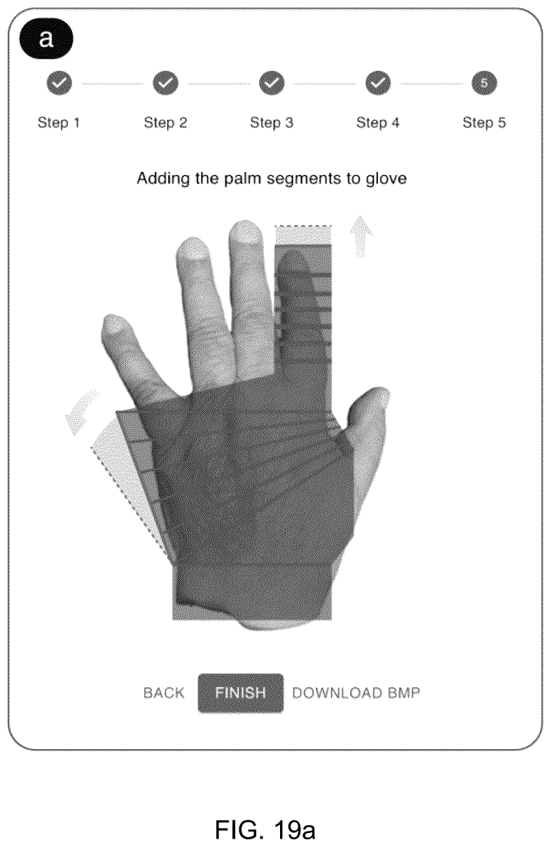

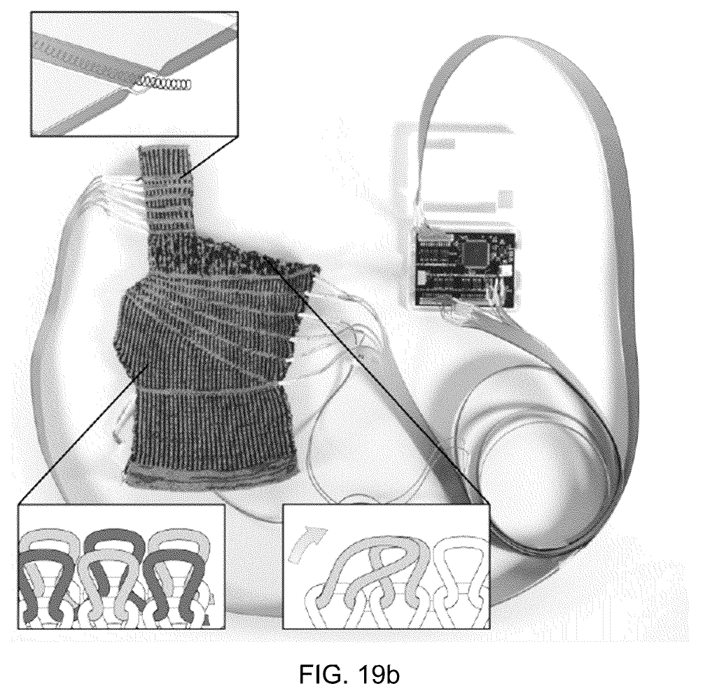

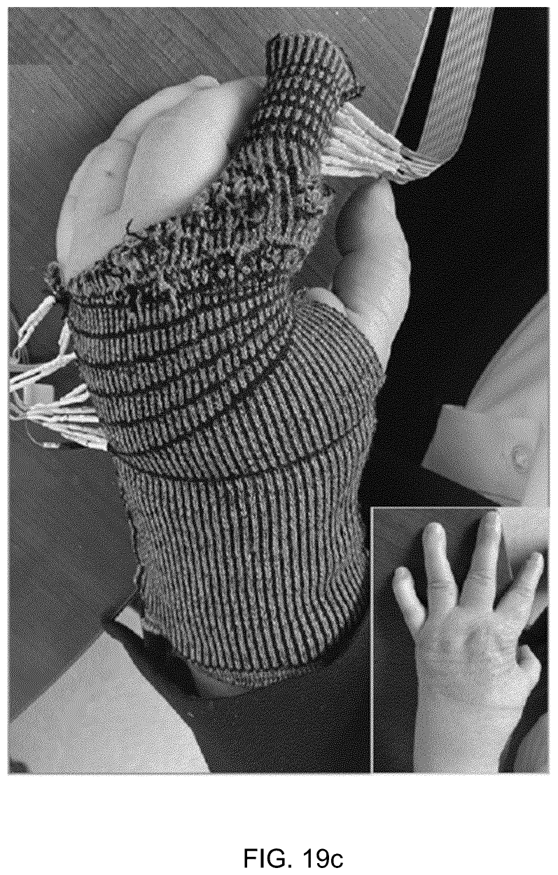

An example of the MediKnit is shown in FIGS. 19a-c. Specifically, MediKnit comprises (a) a design tool for creating active compression gloves and (b) a designed device with actuators that can be programmed to meet individual needs and address hand edema. A MediKnit device being used by a patient is shown in (c).

To illustrate the practical implementation of this approach, this example presents case studies involving six patients experiencing hand edema. The results demonstrate the adaptability and feasibility of the process for developing soft medical devices, highlighting its potential to broaden accessibility, facilitate personalized solutions, and empower clinicians as active medical makers.

In response to challenges posed by the current medical making and edema treatment, this example introduces the concept of soft medical making. This approach utilizes textiles as the primary material, streamlining customization and allowing for design adaptations. By bridging the textile manufacturing process, which, due to machinery complexity is typically reserved for experienced textile technicians, with clinical domains, various examples aim to offer a new medium for healthcare providers. This concept of soft medical making through MediKnit is exemplified by addressing the needs of patients with hand edema. MediKnit consists of an accessible design tool for the personalization of devices, providing visual representations and allowing real-time adaptation. Through this process, clinicians fine-tune designs to meet individual clinical requirements. The fabrication process was characterized by rapid turnaround and fewer iterations. MediKnit devices include a machine-knit glove with active compression, produced with the assistance of a design tool, and a hardware system enabling compression control through a custom printed circuit board (PCB). Finally, these personalized devices were deployed, and a user study with six participants presenting hand edema was conducted. The case studies demonstrate the potential of soft medical making to broaden accessibility and enable personalized, adaptable, and clinician-led fabrication of medical devices, benefiting both patients and healthcare providers.

By introducing the MediKnit design tool and devices, various examples, as explained in this example, present textile-based medical devices that are: (1) personalized to each patient, addressing the variability of symptoms and hand shapes, (2) portable to eliminate patients' commutes to clinics, and (3) cost-effective, with a manufacturing cost of 85 USD. Various examples extend to the design process by empowering clinicians as active medical decision-makers, encouraging them to integrate their domain knowledge and tailor devices to meet the distinct requirements of each patient. This clinician-led design approach streamlines iteration time and enhances the overall design process for such devices, offering benefits for both patients and healthcare providers. In summary, the main contributions of this paper are:

The development of an accessible design tool for personalized therapy: MediKnit, an accessible soft medical making design tool and the resulting personalized edema device. MediKnit design tool minimizes technical requirements for the fabrication of textile-based devices. The tool emphasizes personalization, allowing customized solutions tailored to individual needs and anatomical characteristics. The resulting MediKnit device is delivered timely without the need for iterative adjustments.

The development of adaptive design workflows with clinicians as medical decision makers: The MediKnit design tool allows an adaptive workflow by actively involving healthcare professionals as contributors. Clinician-led design ensures that devices are precisely tuned to clinical requirements, enhancing their effectiveness.

Description of case studies and a user study: To demonstrate the practical application of the approach, case studies focused on hand edema are used. These real-world scenarios serve as tangible examples, highlighting the practical implementation and advantages of the proposed “soft medical making” process. The evaluation of the resulting devices is conducted through a user study, where insights directly from patients are gathered. By combining both case and user studies, valuable insights into the adaptability and effectiveness of the soft medical making approach were obtained.

While design and software tools contribute to reducing the burden of technical knowledge required for general knitting applications, the design process specific to the clinical domain necessitates a specialized tool capable of integrating the clinical knowledge of healthcare providers. Furthermore, in the design of clinical applications, the emphasis should be on the timely delivery of devices, minimizing iterations—a goal that MediKnit contributes to.

### MediKnit System

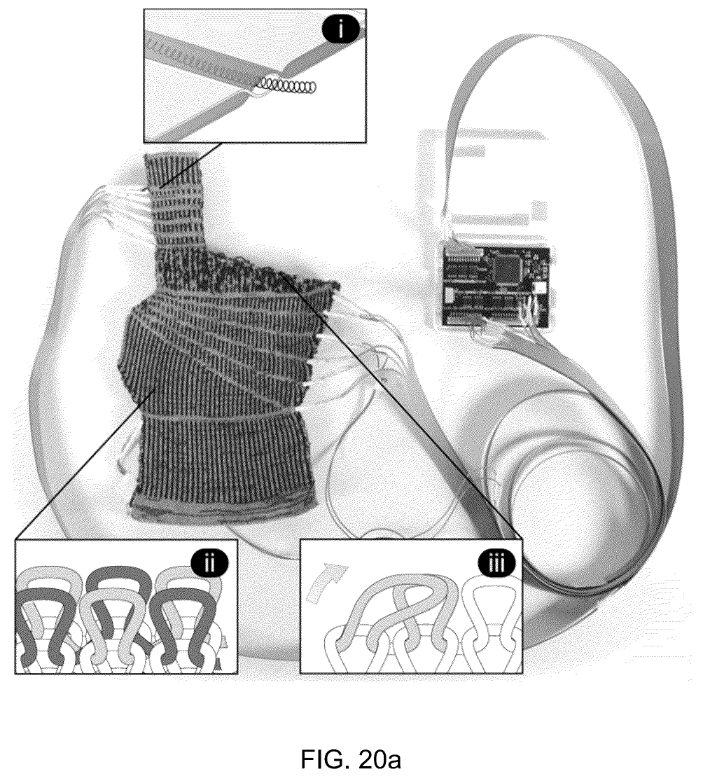

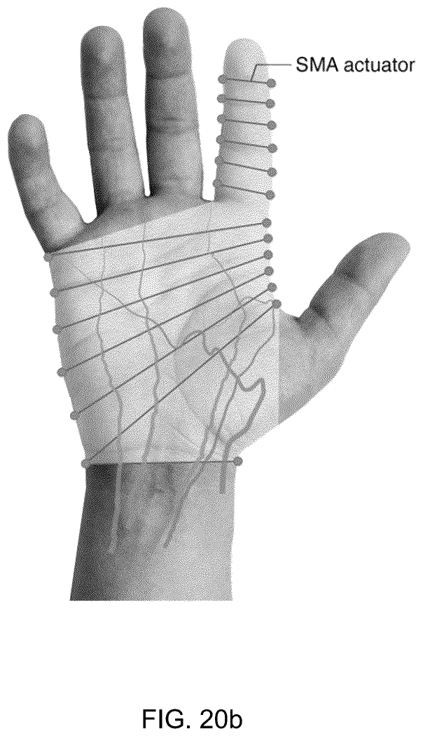

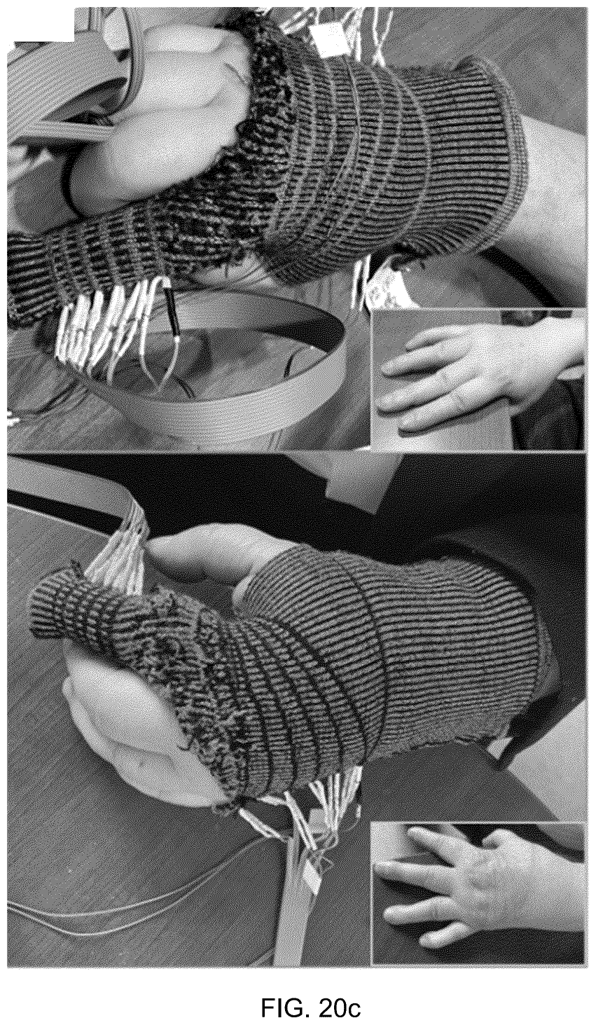

The MediKnit system includes four core components: (1) the knit fabric substrate infusing passive compression, (2) active compression through shape memory alloy actuators, and (3) the hardware system that enables programmable compression parameters through a printed circuit board (PCB) (FIGS. 20a-c), and (4) a design tool that integrates all components for the fabrication of the resultant device.

### Knit Substrate

The knit fabric fulfills three functions: (1) applying passive compression through differential elasticity of the substrate, (2) covering the area of interest, and (3) forming “channels” to integrate actuators. The knit substrates are fabricated using a digital v-bed knitting machine, the 12 gauge SRY 123 Shima Seiki, through the Apex 3 Knit Paint machine knitting software.

Passive Compression. Passive compression is a common strategy for managing hand edema and is utilized in methods like ISOTONER® gloves, string wrapping, taping, or Coban wrapping. Prominent passive compression in the MediKnit device can be achieved by (1) adding elastic yarns to deliver higher compression, (2) creating denser knit structures, (3) shortening loop length, and (4) sizing the device tighter.

In a final implementation of examples disclosed herein, Puma and Sting (elastic) yarns from Silk City were utilized, which imparted high elasticity to the substrate. Additionally, the loop length was set to 30 on the knitting machine, which creates a relatively tight structure as a shorter length of a yarn path condenses a structure. To address the swelling, an interlock structure was adopted, offering increased stretchability across the hand's width. Consequently, the device compresses the hand even without the help of actuators.

Seamless Fit and Free Form Channels. Various examples employ a shaping knit technique to achieve partial coverage of the device. This involves incorporating non-rectilinear shapes into the fabric panels. To incorporate actuators, various examples adopt tubular jacquard structure. This tubular structure generates hollow pockets that have the flexibility to expand in free forms, allowing for the creation of free-form patterns that can intersect with one another (FIGS. 20a-c). Furthermore, the width of these pockets can range from the size of a single stitch (less than a millimeter) to several inches, accommodating a diverse range of actuator sizes. Active Compression

To address the requirements of hand edema, the compression parameters for two main areas of the MediKnit device were optimized: (1) the index finger, and (2) the palm.

Design Considerations. The MediKnit device covers the index finger, and the palmar and dorsal sides of the hand (i.e., the palm and back side of the hand) up to the wrist, excluding the other fingers. Literature shows that lymph vessels in fingers originate from the proximity of the fingertip's pulp reaching the web space and that numerous veins converge on the dorsum side of the hand. Despite the variation in palm lymphatic veins among individuals, all veins ran from the palm and turned their courses to the dorsal side of the hand, then toward the wrist. Given these anatomical characteristics of the hand, three imperatives in designing the device were considered: (1) the prevention of the reverse flow of the fluid in the distal direction, and (2) compressing the webspace between the index and thumb where the veins reverse their courses from the ventral to the dorsal side of the hand.

Shape Memory Alloy Springs Actuators. To fulfill the low-profile characteristics of the device, nitinol shape memory alloy (SMA) springs were used (Kellogg Research Labs, inner diameter: 0.5 mm, wire diameter: 0.25 mm, transition temperature: 45° C.). As we Joule heat SMA springs while anchoring the tips, it generates strain up to 20%. As the contraction is accompanied by heat, the perceived heat through a thermal camera is measured, which reported 40° C. The design principle is to activate springs proximally (i.e., from the fingertip to the wrist direction) to displace the fluid upstream of the nodal pathway.

The Index Finger. For the index finger, the compression test was reconstructed from literature, because of the shared identical specs of shape memory alloy springs and knit substrate structure. It was verified that the results were replicable. The reported number of compression bands of six and the duration of compression of thirty seconds were followed in the study.

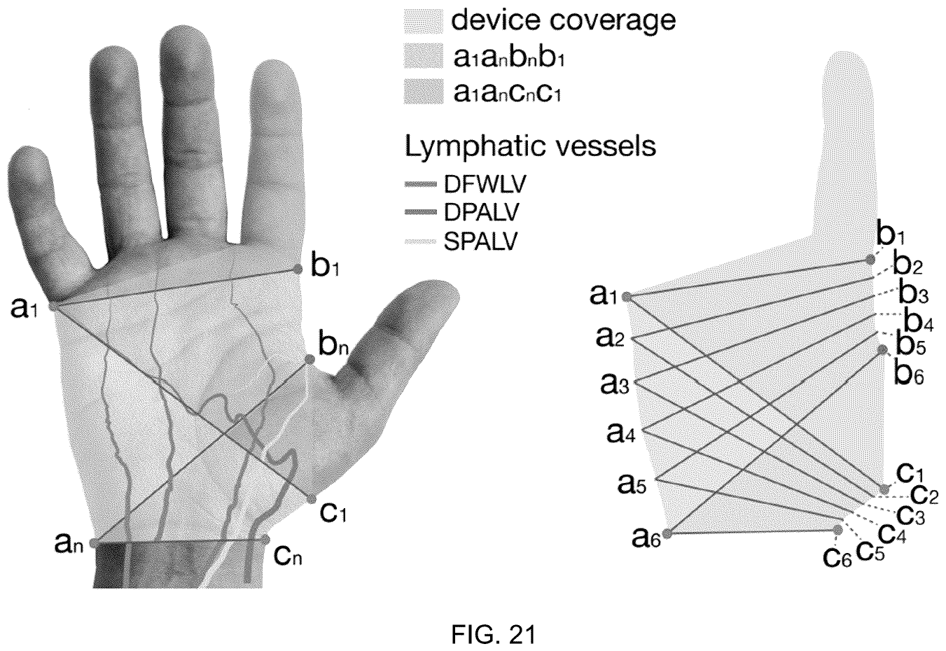

The Palm. Determining the compression parameters for the palm was particularly important, as it presents a distinct set of challenges compared to the fingers as laid out in previous portions of this Example. The complex network of lymphatic veins in the palm area shows that the veins reverse their courses through the thumb's web space toward the dorsal side of the palm. The goal was to (1) distinguish the site of interest that the device covers, (2) optimize the division of the palm site accounting for the mapping of lymphatic vessels, and (3) ensure minimal reverse flow of fluid back to the distal direction. Before parametrizing the palm area, it was established that the area of interest was from the metacarpophalangeal (MCP) pads (knuckles) down to the wrist crease (device coverage as indicated in FIG. 21). Given the device design, which excludes coverage of the thumb and the rest of the fingers, possible coverage of the palm was deviced into an area that covers the circumference of the thenar muscle (a̅₁̅c̅₁̅a̅ₙ̅c̅ₙ̅ in FIG. 21), and the other that covers the circumference of trapezoidal space between the thumb web space and the outer edge of the palm (a̅₁̅b̅₁̅a̅ₙ̅b̅ₙ̅ in FIG. 21). This design considers the natural distribution of lymphatic vessels in the palm and aims to provide targeted support. To determine the number of compression bands (band), the width of each channel and the minimum distance between the channels are calculated. Considering that (a̅₁̅a̅ₙ̅≥max(b̅₁̅b̅ₙ̅, c̅₁̅c̅ₙ̅), the following condition was used:

$$( {n}_{band} - 1 ) \times {d}_{gap} + ( {n}_{band} \times {d}_{channel} ) \leq min ( \overline{{b}_{1} {b}_{n}} , \overline{{c}_{1} {c}_{n}} )$$

where d_{gap} represents the distance between compression bands, and d_{channel} is the width of each channel. Using average measurements from individuals (4 without edema and 5 with edema), it was calculated that b̅₁̅b̅ₙ̅≈28 mm and c̅₁̅c̅ₙ̅ ≈38 mm. d_{gap} was set to 3 mm and it was empirically determined that d_{channel} of 2 mm provided optimal SMA enclosure. Using these values, it was deduced that the maximum integer that satisfies n_{band}=6.

Palm Compression Characterization. With six compression bands dividing the two areas, a mock five-finger hand consisting of a silicone encapsulating sponge saturated with water, attached with an outlet on the writs (see FIG. 21(b)) was created. The objective was to empirically identify the amount of fluid displaced by each band when under the same voltage, measured by the amount of water coming from the outlet. The order of the 12 compression bands was randomized, and the water displacement while applying current to each band for 30 seconds was measured. A randomized order was repeated three times to account for the degradation of SMA and four different order sets were tested. The results reported the descending order of pairs as in Table 1. Considering shorting issues, crossing bands were eliminated to avoid shorting and the six most effective bands were selected. For instance, as a̅₃̅b̅₃̅ was selected, the bands that cross it, namely a̅ᵢ̅c̅ⱼ̅ (i<3, j<3) were eliminated. Following this method, 7 bands were finalized: a̅₁̅b̅₁̅, a̅₂̅b̅₂̅, a̅₃̅b̅₃̅, a̅₄̅b̅₄̅, a̅₅̅b̅₅̅, and a̅₆̅c̅₆̅. Table 1. Averaged displacement of water of 12 SMA bands. The most effective band was ranked as 1.

| Band | Displacement | Rank | Band | Displacement | Rank | Band | Displacement | Rank |
|---|---|---|---|---|---|---|---|---|
| a̅₃̅b̅₃̅ | 0.06% | 1 | a̅₅̅b̅₅̅ | 0.02% | 5 | a̅₂̅c̅₂̅ | 0.01% | 9 |
| a̅₆̅c̅₆̅ | 0.05% | 2 | a̅₄̅c̅₄̅ | 0.02% | 6 | a̅₄̅b̅₄̅ | 0.01% | 10 |
| a̅₆̅b̅₆̅ | 0.04% | 3 | a̅₂̅b̅₂̅ | 0.01% | 7 | a̅₅̅c̅₅̅ | 0.00% | 11 |
| a̅₃̅c̅₃̅ | 0.03% | 4 | a̅₁̅b̅₁̅ | 0.01% | 8 | a̅₁̅c̅₁̅ | 0.00% | 12 |

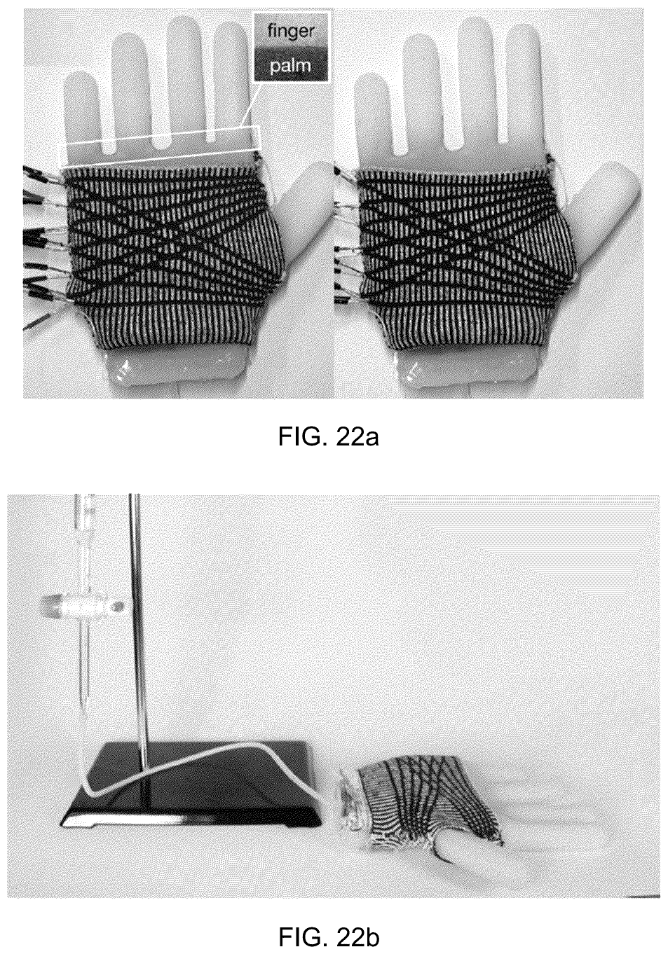

Additionally, it was qualitatively tested whether there was any reverse flow of water back to the distal sites of the hand through the translation of pigment. Similar to the prior experimental setup, a silicone hand was prepared and the fingers were filled with sponges saturated with plain colorless water, while filling the palm area with a sponge saturated with pigmented water (FIG. 22a). The selected 6 compression bands were actuated under the same voltage for 30 seconds each for 8 sequences, and they were compared with the onset using video and photographs. Water migrating back to the finger was not observed.

### MediKnit Hardware

A rigid 44 by 61 mm printed circuit board embedded with an Atmega 2560 microcontroller was developed. The board is powered by 3.7 LiPo battery and provides varying duty cycles programmed for each spring, allowing freedom for individual intensity of compression (FIG. 20). Through pulse width modulation (PWM) the board controls 8 two-channel MOSFETs (IRF8313 TRPBF), and subsequently 13 compression bands (i.e., 6 for the index finger and 7 for the palm, as explained in other parts of this Example). The duration and intensity for every compression band can be programmed by changing the duty cycle and PWM duration. Top-entry connectors were used to attach ribbon cables from the SMA springs to the board.

### MediKnit Design Tool

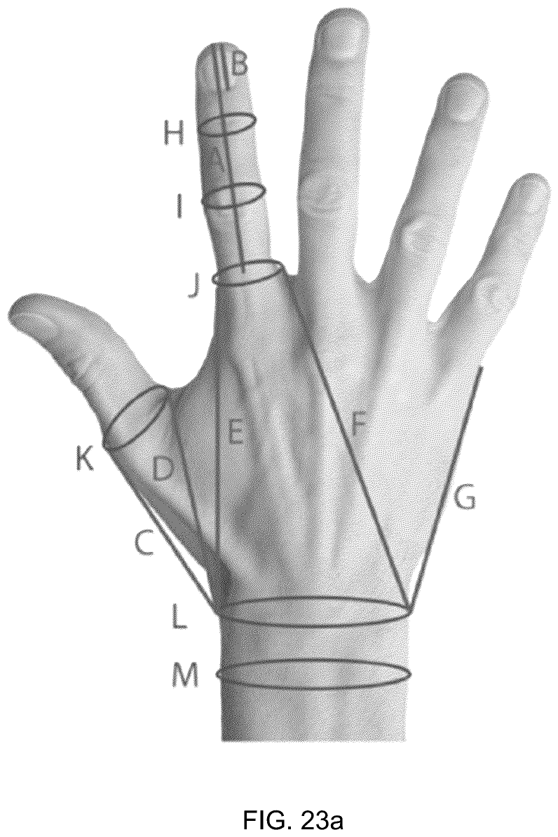

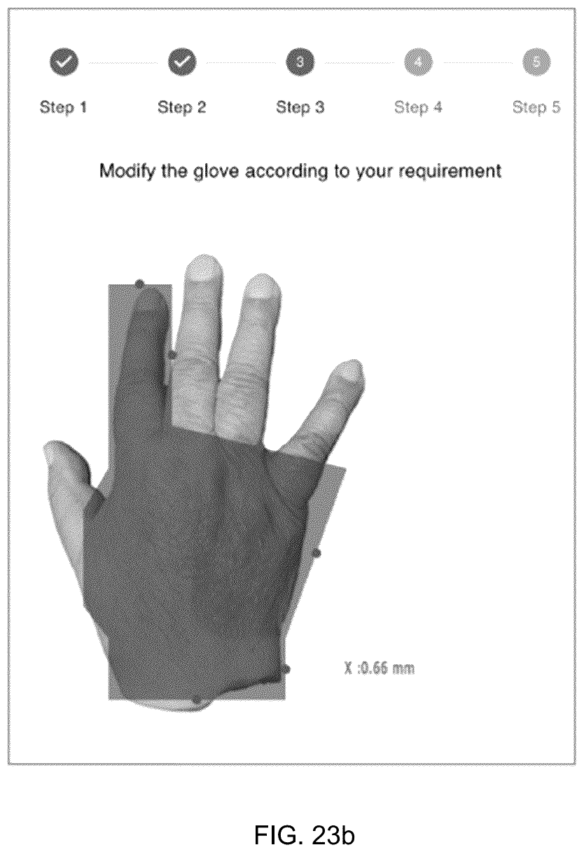

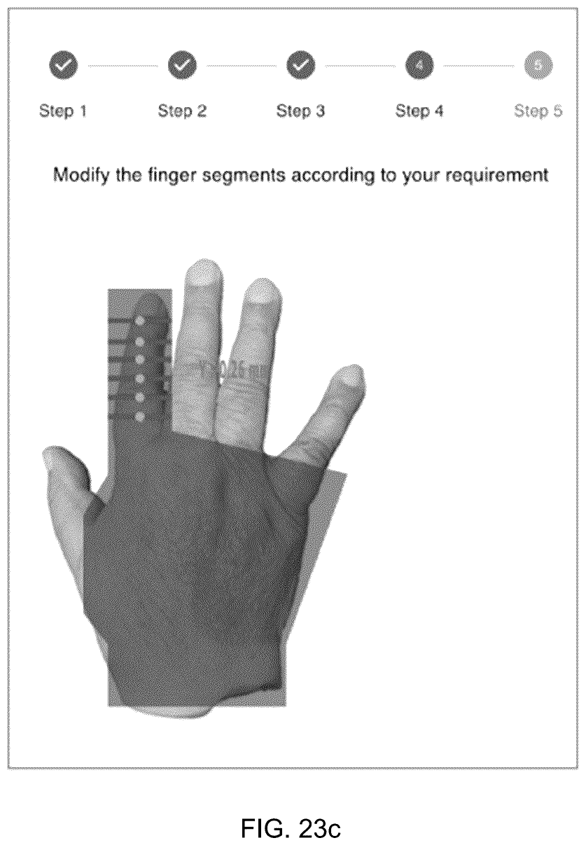

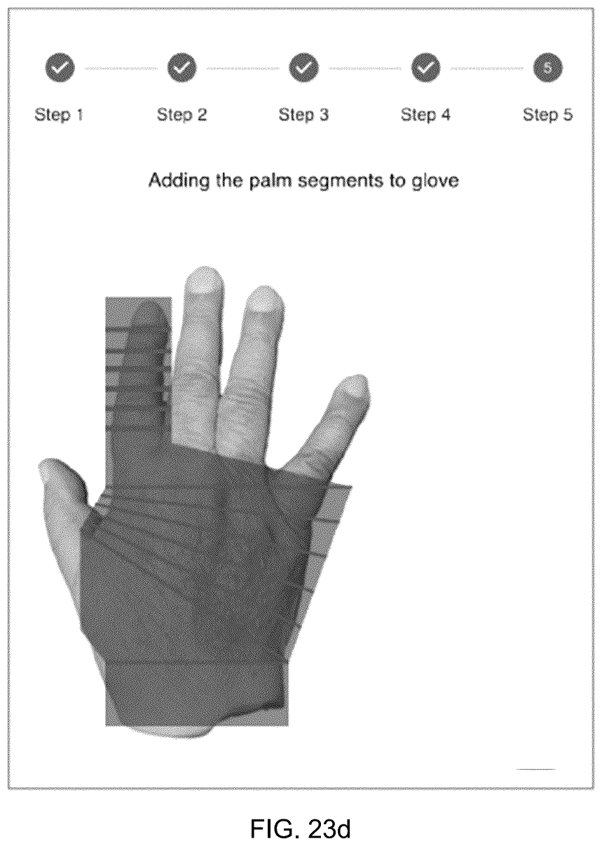

The objective of the design tool is to facilitate and support clinicians in the creation of personalized hand gloves for individuals dealing with edema. The design tool enables adjustment of (1) the template of the knit glove and (2) the placement of the shape-memory alloy channels. The key features of the tool are measurement parametrization, template creation and adjustment, and channel generation and adjustment. To implement these functionalities, various examples employed JavaScript, Canvas API (inbuilt in JavaScript) and utilized the React library, creating a web-based application (FIGS. 23a-d).

The design process starts with a parameterized 2D glove template, serving as the base for clinicians to tailor the wearable to individual needs. Subsequently, users, including clinicians, fine-tune the glove template overlay while it's superimposed on the image of the patient's hand, incorporating feedback from the patient, especially if specific considerations are required. Following this, the finger and palm channels are automatically generated, and the design tool provides users with the flexibility to make individual adjustments to each channel. Finally, users can save the generated glove template for further processing and fabrication.

Hand Parameterization. In the absence of standard measurements for optimal customization of the site of interest, 13 specific measurements that are essential for the creation of a reliable 2D hand model were defined (FIG. 23a). To facilitate this process, the design tool provides visual guidance for these measurements in the initial step, as illustrated in FIG. 23a. The user is required to measure an edematous hand's dimensions using a ruler or a caliper and subsequently input these measurements into the interface. This simplified approach reduces the necessity for specialized equipment, such as a 3D scanner, simplifying the design process. In addition to the measurement values, the user is also asked to upload a photo of the patient's hand on a flat surface, which further assists in the adjustment process.

Adaptive Template. Next, the design tool utilizes a set of formulas to approximate the hand from the collected 13 measurements, generating a geometric 2D contour. This involves simplifying the actual hand contour into rectilinear shapes, ensuring compatibility with the knitting machine and the knit structure. The design tool provides 6 controller points (see FIG. 23c), enabling the user to fine-tune the length and width of the index finger, palm, and wrist within the generated glove template. To facilitate this adjustment, the user can utilize the superimposed image, make observations, and consider feedback from the patient as guides for resizing the glove. Upon achieving the desired adjustment, the user can save the design and proceed to the next step.

Adaptive Channels. As outlined in this Example, the design tool generates 6 channels on the index finger and 7 channels on the palm. With those channels, the design tool provides the user the option to fine-tune the channels on the finger and palm. The user can move channels in case the patient presents specific needs or unique requirements or to avoid sensitive parts around the bony area of the hand. This adaptability ensures that the final position of channels aligns precisely with the patient's individual specifications, ensuring optimal comfort and functionality.

Creating Knitting Machine-Readable File. Upon completion, the user has the option to either review previous steps or, if satisfied with the template, save the design (FIG. 23e). If the user opts to save the design, the system will convert it into a machine-readable bitmap file, which then can be read on Knit Paint. Additionally, users have the option of saving the modified measurement values for future reference.

### MediKnit Device User Study

A goal of the research performed in this Example lay in (1) evaluating MediKnit's functional performance, (2) subjectively understanding the sensory perception and safety of the device on patients who may present various levels of sensory deficits, and (3) envisioning the potential of incorporation of MediKnit into daily lives. Quantitative data was obtained through several measurements.

### Participants

Six participants retained from the earlier case study discussed in this Example were recruited. The participants presented edematous hands, three were enrolled from local clinic A and the other three from medical institution B. The study excluded participants with pitting-type edema, open wounds, and burn injuries, but accepted various causes including stroke, post-op, and infection. All selected participants presented swelling in one of their hands and met the eligibility criteria, with some presenting muscle spasticity and insensate fingers (Table 2).

### Apparatus

As illustrated in previous sections of this Example, clinicians, and a knitting technician each served as the primary maker for three MediKnit devices. All six devices were customized according to the patient's measurements, utilized the same selection of yarns, and had a single sleeve for the index finger. All devices embedded identical SMA springs sourced from Kellogg Laboratory, as described herein.

### Study Protocol

The user study was structured with pre-intervention measurement, intervention, and post-intervention measurement. To maintain consistency, all measurements were repeated 2 times by an observer. Patients were asked to put on the device for 90 minutes during the intervention. The measurements included four methods: (1) measuring hand volume using a volumeter, performing a figure-of-eight test, assessing range of motion, and conducting the 9-hole peg test (9HPT); (2) using a 90-minute intervention involving patients wearing MediKnit device; and (3) taking post-intervention measurements. One researcher with previous experience with volumetry and ROM measurements performed the measurements in randomized order, repeating each twice.

Volume Measurement: As one of the common measurements, volumetry quantifies the volume of the affected site by submerging it into a tank filled with water and measuring the weight of water displaced from the tank. The assessment measured the volume of the whole hand, thumb, and three fingers (i.e., middle, ring, and pinky fingers). By subtracting the volumes of the last two from the hand volume, the volume specific to the palm and index finger was obtained. Custom-designed volumeters were employed to suit the unique areas of interest being measured.

Figure-of-Eight: The figure-of-eight method, recommended with a tension-controlled measuring tape, involves wrapping the tape around specific points on the hand. Wrapping started at the distal ulnar styloid, extended over the anterior wrist to the distal radial styloid, and then moved diagonally across the dorsum of the hand, covering the fifth metacarpophalangeal joint line. Wrapping then proceeded from the volar aspect to the fourth metacarpophalangeal joints and, finally, moved diagonally across the dorsum back to the starting point (distal to the ulnar styloid).

Range of Motion (ROM): The flexion of the proximal interphalangeal (PIP) joint in the index finger was assessed by instructing participants to perform three movements: (1) extending the index finger, (2) flexing it to a comfortable degree, and (3) flexing it to its maximum extent. These motions were repeated two times, with each instance recorded. A computer goniometer was employed to obtain angles from the recorded videos. Specifically, the internal angle of the joint formed by the distal interphalangeal (DIP), PIP, and metacarpophalangeal (MCP) joints was measured.

Nine-Hole Peg Test (9HPT): The nine-hole peg test (9HPT) is a standardized, quantitative assessment widely recognized as the gold standard for measuring finger dexterity. The nine-hole peg test assessed (1) putting nine pegs in nine holes and (2) retrieving the pegs back to the container while using the thumb and the index finger. Participants are scored based on the time taken to complete the activities, recorded in seconds, with the stopwatch initiated from the moment the first peg is touched until the last peg hits the container.

### Data Analysis

To measure the intra-rater reliability of these measurements, intra-class correlation coefficients (ICC) were conducted. ICC estimates and their 95% confident intervals were calculated using R package irr, version 0.84.1 based on consistency and a 2-way mixed-effects model.

In analyzing each measurement, the non-independence of data across participants using the linear mixed effects model using Ime4 was addressed. The normal distribution and constant variance of residuals for the measurements were confirmed. Two random effects were anticipated: participant and the interaction effect between pre\post and participant. For range of motion (ROM), a third random effect, the interaction among participant, pre\post, and motions to account for three movements were included.

TABLE 5
Intra-rater reliability of measurements and CI's lower and upper bounds.
ICC score close to 1 indicates high similarity between measurements.
Values less than 0.5 are indicative of poor reliability, values between 0.5 and 0.75
indicate moderate reliability, values between 0.75 and 0.9 indicate good reliability,
and values greater than 0.90 indicate excellent reliability.

| | ICC and | ICC and | | ICC and | ICC and |
|---|---|---|---|---|---|
| | [95% CI] of | [95% CI] of | | [95% CI] of | [95% CI] of |
| Measurement | baseline | post | Measurement | baseline | post |
| Volume | 0.999 [0.851, | 1.000 [0.949, | FIG. of | 0.999 [0.938, | 0.998 [0.890, |
| | 0.999] | 1.000] | eight | 0.999] | 0.998] |
| ROM | 0.999 [0.996, | 1.000 [0.998, | 9HPT | 0.997 [0.927, | 0.993 [0.834, |
| | 0.999] | 1.000] | | 0.997] | 0.993] |

(ROM: range of motion, 9HPT: nine-hole peg test)

### Results

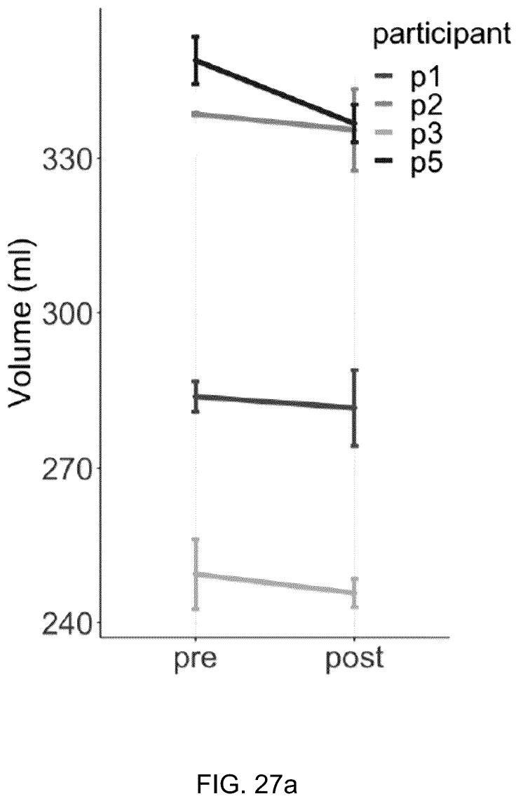

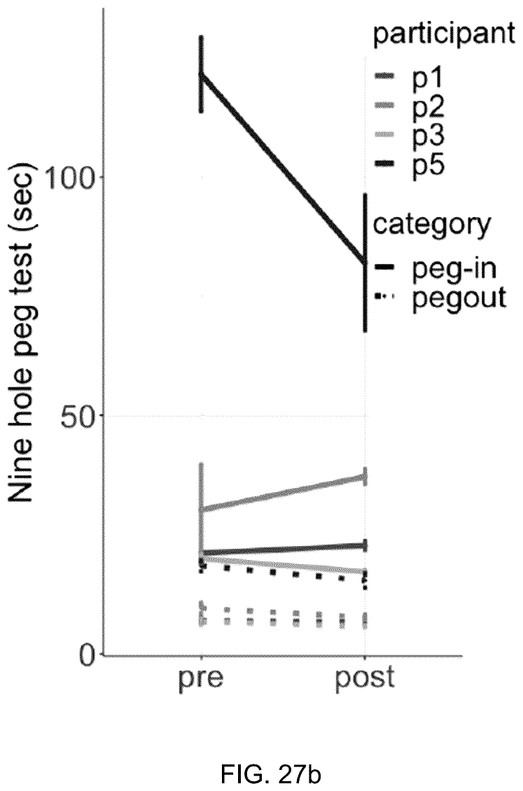

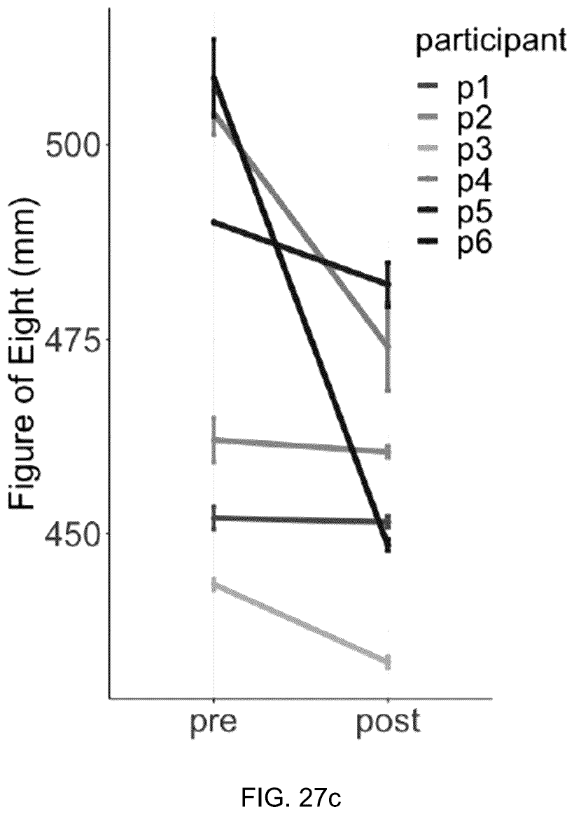

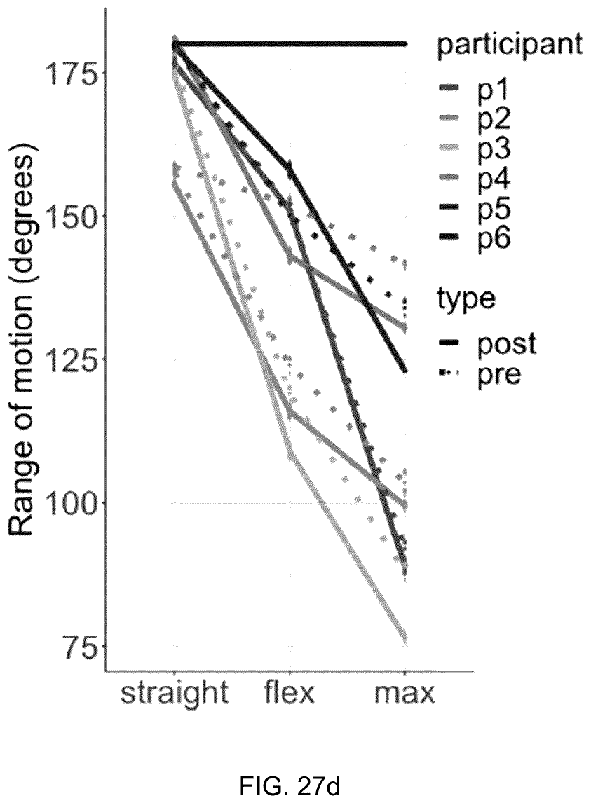

This section reports four measurements of each participant's affected hand before and after the intervention. Two patients, P4 and P6, had to withdraw from volumetry and 9HPT due to severe muscle spasticity. In this section, ICC scores, 95% confidence intervals for pre-measurements (baseline) and post-measurements are reported (Table 5) for measurement reliability. Descriptive data (FIGS. 27a-d) and report statistical analyses are then plotted.

As described below, FIG. 27a-d displays the measurement results. As shown in (a) the volumetry indicated a decrease in volume after the intervention in the descriptive data. (b) 9HPT showed a notable difference in the two activities: putting 9 pegs into the holes (trial: in) and taking them out (trial: out). (c) In the figure of eight, all participants showed a descriptive decrease after the intervention. (d) In ROM, the downward shift of lines from pre to post was deemed favorable, indicating a greater range of motion.

### Measurement Results

Volumetry. A decrease in the volume is deemed favorable as it indicates edema drained. There was a discrepancy in the sample size as muscle spasticity prevented two participants (P4 and P6) from manipulating their fingers to fit in the volumeter. In the descriptive data, all participants except the two withdrawn showed a decrease in the volume; P5, P2, P3, and P1 from the greatest to smallest difference. Statistical analysis reveals no significant changes between pre- and post.

9HPT. There was, again, a discrepancy in the sample size as two participants (P4 and P6) could not perform 9HPT due to spasticity in the fingers. There was relatively high variability for P5, due to the slippage of pegs caused by compromised fine motor skills. Linear mixed effects model revealed a significant disparity in the time taken when participants were inserting and removing the pegs. However, there was no statistically significant difference between pre and post-measurements.

Figure of Eight. As with the volumeter, a decrease in the figure of eight measurements indicates a reduction in swelling. This measurement showed the least variability, as suggested by the literature. In the descriptive data, all participants showed a decrease in the measurements, with P6 showing the greatest change, followed by P4, P3, P5, P2, and P1. However, the model did not indicate significant differences between the pre- and post-test.

ROM. In range of motion, the greater the difference from the pre (i.e., downward shift), the more it was deemed favorable. P6 could straighten his finger but could not bend it due to muscle spasticity. The mean changes in the angles for straightening, flexing, and reaching maximum flexion were 2.5°, −3.2°, and −6.8° respectively, indicating that participants were able to bend their fingers more after the intervention. The positive value for straightening indicates that patients could hyperextend their fingers after the intervention. The results from the linear mixed effects model indicated a significant difference across the three motions (p-value <0.001). Maximum flexion, in particular, informed statistically significant difference between pre and post (p-value <0.05). However, there were no significant changes between the pre and post-measurements in overall motions.

### Discussion

This Example focused on hand edema as an opportunity for these tailored treatments. This Example details how MediKnit, a design tool for personalized hand edema devices, draws upon clinical expertise and allows a more functional workflow. The user study indicates the effectiveness of MediKnit device and motivates us to further explore its use in a wide range of medical therapies. The blending of clinical insight with soft material fabrication enhances the personalization of devices, broadening the set of patients who could benefit from affordable and portable solutions.

### EXAMPLE 4

This example provides a description of examples of wearable compression systems of the present disclosure, and methods for designing same.

This example provides specifically (A) an approach for a knit full-hand substrate and (B) a software platform for designing KnitDema.

### (A) for Knitting the Full-Hand (Glove-Like) Knit Substrate

Cut-and-sew (non-whole garment knit machine) approach:

Concept: The cut-and-sew approach in machine knitting is a manufacturing technique that builds upon traditional garment tailoring methods with machine knitting technology to create garments and textile products. This method involves the production of large panels of knitted fabric, which are then cut or “bound off” into specific shapes and sewn together, much like traditional fabric garments. This approach allows for greater flexibility in garment design and can accommodate more complex shapes and styles than those typically produced directly on the knitting machine.

### Applicable Machine Type: All Non-WG Shima Seiki Machines.

KnitDema-specific process: The knitting machine will have a gauge of 12. Each panel has to use a tubular jacquard structure and a double system for efficient knitting. A double system denotes two feeders knitting together. Each panel will be imported as a bitmap file, generated by KnitDema's design tool. Once imported to Apex 3, option lines and (optionally) binding off are needed. Binding off is optional to achieve clean seams. The panels will consist of 5 panels; including 4 sheaths for the thumb, index, middle, and pinky fingers, and 1 sheath for the palm. Each panel is recommended to be separately knitted on a consistent stitch length. Once the panels are knitted, then overlock stitch can be used to seam the panels together.

SMA integration: Manually inserted through the channels.

### Whole Garment (WG) Machine Approach:

Concept: WG is Shima Seiki's proprietary knitting technique that allows for the production of complete seamless clothing directly from the knitting machine. WG also allows for jersey (single-layer) structured knitting of gloves. However, the current WG structure cannot create channels, thus restricting the potential for creating truly integrated smart textiles that can deliver mechanical compression.

Measurements: Accurate measurements of the user's hand, including the circumference of the palm, the length from the base of the palm to the tip of the middle finger, the length of the thumb, and the length of individual fingers are needed.

Design Tool: Using Shima's design software (APEX) to create the glove pattern.

Input Measurements: Input the measurements obtained in step 1 into the software. The software allows adjusting the pattern according to these measurements, ensuring customization.

Customization Options: Integrate channels for SMA and any additional customization.

Knitting and Iteration: The whole garment knitting machine must be set up according to the customized pattern. To perform tubular jacquard, the machine has to leverage half gauge. Therefore, a gauge above 18 is recommended. Channels will require needle transfer.

SMA integration: Manually inserted through the channels.

### (B) Software Platform for Designing Full-Hand KnitDema Device

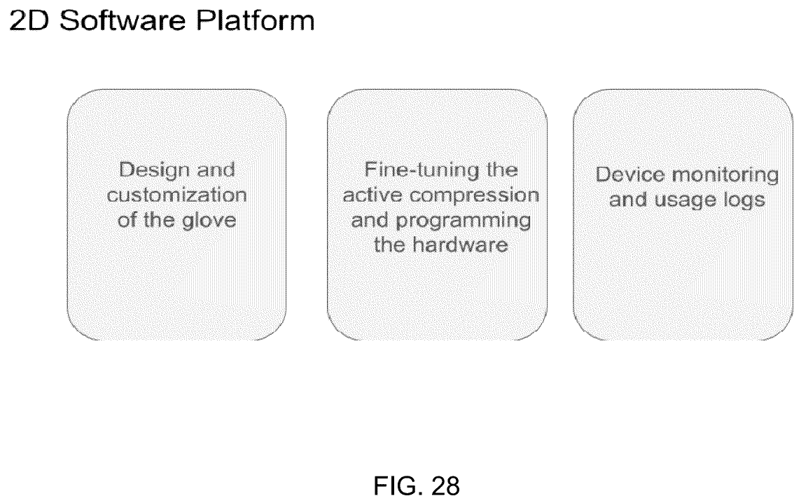

2D Software Platform: An example of the 2D Software Platform is shown in FIG. 28. The KnitDema software tool includes three primary functionalities:

Design and Customization: Create and personalize glove designs according to individual preferences and measurements.

Hand Parameterization: In the absence of standard measurements for optimal customization of the site of interest, 13 specific measurements were defined that are essential for the creation of a reliable 2D hand model. To facilitate this process, the design tool provides visual guidance for these measurements. The user is required to measure the hand's dimensions using a ruler or a caliper and subsequently input these measurements into the interface. In addition to the measurement values, the user is also asked to upload a photo of the patient's hand on a flat surface, which further assists in the adjustment process.

Adaptive Template: Next, the design tool utilizes a set of formulas to approximate the hand from the collected 13 measurements, generating a geometric 2D contour. This involves simplifying the actual hand contour into rectilinear shapes, ensuring compatibility with the knitting machine and the knit structure. The design tool provides 6 controller points, enabling the user to fine-tune the length and width of the index finger, palm, and wrist within the generated glove template. To facilitate this adjustment, the user can utilize the superimposed image, make observations, and consider feedback from the patient as guides for resizing the glove. Upon achieving the desired adjustment, the user can save the design and proceed to the next step.

Adaptive Channels: The design tool generates 6 channels on the index finger and 7 channels on the palm. The design tool provides the user with the option to fine-tune the channels on the finger and palm. The user can move channels in case the patient presents specific needs or unique requirements or to avoid sensitive parts around the bony area of the hand. This adaptability ensures that the final position of channels aligns precisely with the patient's individual specifications, ensuring optimal comfort and functionality.

Creating Knitting Machine-Readable File: Upon completion, the user has the option to either review previous steps or, if satisfied with the template, save the design. If the user opts to save the design, the system will convert it into a machine-readable bitmap file, which then can be read on Knit Paint. Additionally, users have the option of saving the modified measurement values for future reference.

Active Compression Adjustment: This allows for the adjusting of both the intensity and duration of active compression and program the hardware for optimal performance. The user selects the patient's glove template from the design tool, saved in the system in the previous step. The design tool automatically optimizes the timing and duration of the active compression components. Users have the flexibility to adjust the suggested intensity level and duration according to their preferences. The design tool generates the final code necessary for upload to the device. Users connect the hardware to the system and upload the programmed settings to the device.

Device Monitoring and Usage Logs: Monitor the functionality of the device in real time and record usage logs for performance tracking and analysis. Patients log in to the system, and their profiles are displayed in the design tool. Patients connect the device to the computer for monitoring. The design tool provides visualizations of the active channels and the remaining time for each cycle. The design tool records the date, time, and duration of device usage for future analysis purposes.

3D platform

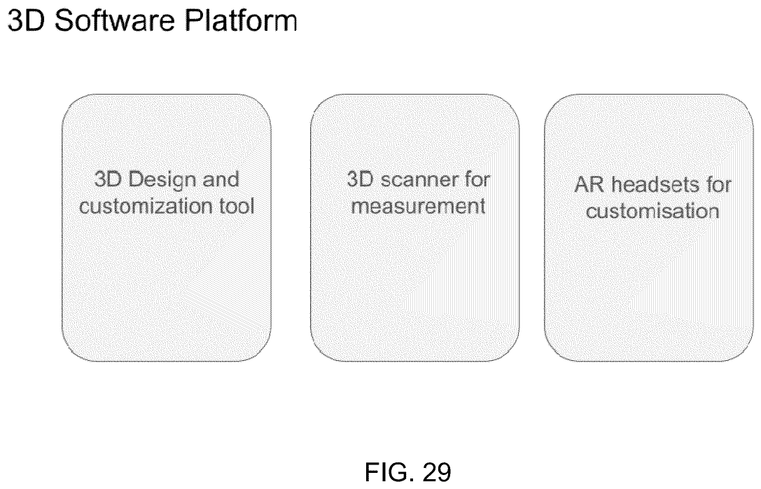

Various examples include an advanced 3D software portal specifically tailored for designing and customizing KnitDema gloves, leveraging cutting-edge technology such as 3D scanners, AR/VR headsets, or hand reconstruction through computer vision. An example of the 3D software platform is shown in FIG. 29.

3D Design and Customization Tool: The purpose of this tool is to develop a user-friendly 3D interface for designing and customizing knitted gloves by therapists and clinicians, and to integrate features for adjusting glove dimensions and the number and position of channels for active compression based on the patient's needs.

Integration of 3D) Scanner or CV Model for Hand Measurements: A high-quality 3D scanner capable of capturing accurate hand measurements can be used. Software algorithms may be used to process scanned data and extract relevant measurements, including volume and circumference of the hand and fingers. Further, regarding the CV model, the process may start by taking pictures of the patient's hand, and then inputting it into the CV model to get a 3D model of the hand. This is possible because hand reconstruction is a solved problem in CV.

Utilization of 3D) Modeling for Glove Design: The data points that are captured in the 3D model may be used to display a 3D structure on a web application, using libraries like three.js. Implementing 3D modeling techniques may generate virtual representations of custom glove designs. Real-time visualization and modification of glove designs may be enabled based on patient preferences and therapeutic requirements.

Customization: VR headsets may be incorporated with the design tool, allowing therapists to customize gloves directly on patients' hands during home or clinic visits. This may enable immersive experiences for patients to participate in the customization process, providing feedback and making adjustments in real-time.

Web App: The clinicians will be able to analyze the joints and various attributes of the hand by inferring the 3D model of the hand and then modify the 3D hand glove. They will be able to adjust the glove structure and channel configurations better because of the level of detail that the clinician is able to access.

Volumetric Measurement Pre-Post: Algorithms may be developed to compare volumetric measurements of patients' hands before and after wearing custom gloves. A feature may be implemented to analyze the effectiveness of active compression therapy in reducing edema.

Glove Fabrication: For WG machines, the required measurements are obtained for their automated design process from the final 3D glove model that the clinicians developed. For non-WG machines, measurements are entered from the final 3D glove into the 2D design tool to generate machine-readable files.

Although the present disclosure has been described with respect to one or more particular embodiments and/or examples, it will be understood that other embodiments and/or examples of the present disclosure may be made without departing from the scope of the present disclosure.

1. A wearable compression system, comprising:
a textile structure configured to be affixed to a therapy target of an individual, the textile structure comprising a plurality of actuators embedded within the textile structure and configured to provide a compression function, and
a circuit in electronic communication with the plurality of actuators, configured to receive an input from a computing device and to output signals to the plurality of actuators to initiate the compression function.

2. The wearable compression system of claim 1, wherein each actuator has a first length at a first state and a second length shorter than the first length at a second state, and wherein each actuator is configured to apply a contracting motion having a compressive force when moving from the first state to the second state.

3. The wearable compression system of claim 2, the compressive force applied by each actuator being applied for a programmed duration of time and/or at a programmed compression intensity and/or according to a programmed compression sequence.

4. The wearable compression system of claim 1, wherein a first actuator of the plurality of actuators is configured to be positioned at a distal position of the therapy target and/or an nth actuator of the plurality of actuators is configured to be positioned at a proximal position of the therapy target.

5. The wearable compression system of claim 4, the compression function generating movement of a fluid.

6. The wearable compression system of claim 2, wherein at least a portion of the plurality of actuators is arranged in a sequence from the first actuator to the nth actuator, and wherein the compression function comprises a series of sequential contracting motions in an order corresponding to the sequence of the portion of the plurality of actuators, for a duration of time and/or at an intensity.

7. The wearable compression system of claim 1, the computing device configured to perform one or more or all of the following:
receive one or more input(s) to define the compression function;
provide power to the wearable system;
connect to one or more external device(s) by a wired and/or wireless connection;
or any combination thereof.

8. The wearable compression system of claim 1, the computing device configured to perform one or more or all of the following:
receive one or more or all of:
a compression intensity input for the plurality of actuators,
a compressive force duration input for the plurality of actuators, and/or
a sequential compression function duration input; and
based on one or more or all of the compression intensity input, the compressive force duration input, and/or the sequential compression function duration input, initiate the compression function.

9. The wearable compression system of claim 8, the computing device controlling the compression intensity input and the compressive force duration input by adjusting one or more or all of a pulse width modulation (“PWM”) duration or a PWM duty cycle.

10. The wearable compression system of claim 1, the computing device comprising one or more or all of a printed circuit board (“PCB”), a microcontroller, a microprocessor, a memory, or a power supply.

11. The wearable compression system of claim 1, wherein one or more portion(s) of the textile structure comprises a configuration with the plurality of actuators spaced along one or more ax(es) and/or spaced about one or more plane(s) of the configuration.

12. The wearable compression system of claim 11, the one or more portion(s) of the textile structure comprising the configuration affixed to the location on the user with the plurality of actuators positioned about a circumference of the location and configured to provide the compression function by exerting forces in one or more or all of radial, tangential, or normal directions relative to the therapy target of the individual.

13. The wearable compression system of claim 1, the plurality of actuators comprising one or more or all of springs, wires, or rods.

14. The wearable compression system of claim 1, the plurality of actuators comprising one or more shape memory alloy(s) (“SMA”).

15. The wearable compression system of claim 14, the one or more shape memory alloy(s) comprising one or more or all of SMA spring(s), SMA wire(s), or SMA rod(s).

16. The wearable compression system of claim 1, the plurality of actuators comprising one or more or all of nickel-titanium (“NiTi”) yarn(s), Kevlar yarn(s) coupled to a direct current (“DC”) motor, fluidic fiber actuator(s), inverse pneumatic artificial muscle(s) (“IPAM”), hydro-muscle actuator(s), or the like), liquid crystal elastomer(s), aligned amorphous polymer(s), conductive polymer(s), dielectric elastomer(s), or carbon nanotube fiber(s).

17. The wearable compression system of claim 1, the textile structure comprising a knitted structure, a woven structure, an embroidered structure, a sewn structure, a silicone casted structure, or a polymer casted structure.

18. The wearable compression system of claim 17, the knitted structure comprising one or more tubular channels or the like.

19. The wearable compression system of claim 1, the textile structure configured to exert a passive compressive force to the therapy target of the individual.

20. The wearable compression system of claim 1, the therapy target comprising one or more or all portion(s) of a hand and/or wrist of the individual.

21. The wearable compression system of claim 20, the textile structure comprising a full-hand structure, configured to cover the hand of a user.

22. The wearable compression system of claim 1, the therapy target comprising one or more or all of one or more foot/feet, one or more toe(s), one or more ankle(s), one or more leg(s), a neck, a nose, one or more ear(s), a head, a face, one or more hip(s), a torso, one or more breast(s), a pelvis, one or more forearm(s), or one or more arm(s) of the individual, or any portion thereof, or any combination thereof.

23. The wearable compression system of claim 1, the textile structure conformable to the therapy target of the individual.

24. The wearable compression system of claim 1, wherein n is 1-10000 actuator(s), including all integer values and ranges therebetween.

25. A method, comprising:
receiving one or more or all of:
a compression intensity input for a plurality of actuators,
a compressive force duration for the plurality of actuators, and/or
a sequential compression function duration; and
based on one or more or all of the compression intensity input, the compressive force duration, and/or the sequential compression function duration, initiating a compression function to be performed by a textile structure affixed to a therapy target of an individual.

26. The method of claim 25, the compression function comprising each actuator of the plurality of actuators initiating a contracting motion or the like.

27. A method for automatically designing a wearable compression system, the method comprising:
receiving a set of measurements of a therapy target of an individual;
displaying a design interface on a display, the design interface comprising a graphical representation of a wearable compression system for the therapy target having an overlay of a default number of one or more actuator(s), each actuator having a default location, wherein the wearable compression system and/or the graphical representation of the wearable compression system have/has default dimensions, and wherein the default dimensions of the wearable compression system and/or the default dimensions of the graphical representation of the wearable compression system, the default number of one or more actuator(s), and the default location of each actuator are based on the set of measurements;
optionally, receiving one or more modified dimension(s) of the wearable compression system, a modified number of actuator(s), one or more modified location(s) of the one or more actuator(s), or any combination thereof;
updating the graphical representation according to, if present, one or more or all of the modified dimension(s) of the wearable compression system, the modified number of actuator(s), and the modified location(s) of the actuator(s); and
generating an instruction file for automated fabrication of the wearable compression system based on the graphical representation or the updated graphical representation.

28. The method of claim 27, wherein the set of measurements is a standardized set of measurements based on the therapy target.

29. The method of claim 27, wherein the set of measurements is a 3D model or a 3D model in Virtual Reality (VR), Augmented Reality (AR), Mixed Reality (XR), or any combination thereof of the therapy target.

30. The method of claim 27, wherein the instruction file for automated fabrication of the wearable compression system comprises instructions for knitting a structure of the wearable compression device.

31. The method of claim 30, wherein the instruction file for automated fabrication of the wearable compression device further comprises instructions for fabricating one or more tubular channel(s) in the knitted structure of the wearable compression device.

32. The method of claim 27, wherein the therapy target comprises one or more or all of one or more foot/feet, one or more toe(s), one or more ankle(s), one or more leg(s), a neck, a nose, one or more ear(s), a head, a face, one or more hip(s), a torso, one or more breast(s), a pelvis, one or more forearm(s), one or more wrist(s), or one or more arm(s) of the individual, or any portion thereof, or any combination thereof.

33. A method of treating a therapy target of an individual diagnosed with, having or suspected of having, or having symptoms of edema in at least a portion of the therapy target, comprising:
receiving a set of measurements of the therapy target;
designing, and optionally, fabricating, a wearable compression system based on the set of measurements, wherein the use of the wearable compression system temporarily, partially, or fully ameliorates the edema or the symptoms of edema.

34. The method of claim 33, wherein the designing further comprises:
displaying a design interface on a display, the design interface comprising a graphical representation of a wearable compression system for the therapy target having an overlay of a default number of one or more actuator(s), each actuator having a default location, wherein the wearable compression system and/or the graphical representation of the wearable compression system have/has default dimensions, and wherein the default dimensions of the wearable compression system and/or the default dimensions of the graphical representation of the wearable compression system, the default number of one or more actuator(s), and the default location of each actuator are based on the set of measurements;
optionally, receiving one or more modified dimension(s) of the wearable compression system, a modified number of actuator(s), one or more modified location(s) of the one or more actuator(s), or any combination thereof;
updating the graphical representation according to, if present, one or more or all of the modified dimension(s) of the wearable compression system, the modified number of actuator(s), and the modified location(s) of the actuator(s); and
generating an instruction file for automated fabrication of the wearable compression system based on the graphical representation or the updated graphical representation.

35. The method of claim 33, wherein the therapy target comprises a hand or a portion of a hand.
